(19) United States
(12) Patent Application Publication
(10) Pub. No.: US 2008/0036573 A1
(43) Pub. Date: Feb. 14, 2008

(54) Cdma-Rfid

(76) Inventors: Nobuo Tsukamoto, Akishima-shi (JP); Hideyuki Nebiya, Taito-ku (JP); Yukihisa Inoue, Yokohama-shi (JP)

Correspondence Address: DAY PITNEY LLP, 7 TIMES SQUARE, NEW YORK, NY, 10036-7311, US

(21) Appl. No.: 10/589,933

(22) PCT Filed: Feb. 19, 2004
(86) PCT No.: PCT/JP04/01887

§ 371 Date: Apr. 30, 2007

(51) Int. Cl. H04Q 5/22

(52) U.S. Cl. 340/10.2

(57) ABSTRACT

If a total number of specific RF tags is too large, many RF tags respond at a time. Therefore a problem occurs that an interrogator cannot receive information from the RF tags. A first invention relates to an RF tag. The RF tag includes an interrogator signal receiving section for receiving an interrogator signal from an interrogator, a synchronizing signal generating section for generating a synchronizing signal from the received interrogator signal, a response information obtaining section for obtaining response information according to the interrogator signal, a spread-code modulating section for modulating the response information with a spreading code and obtaining the spread-code modulated response information, and a transmitting section for transmitting the response signal that contains the spread-code modulated response information in a data area at a random transmission interval in synchronism with the synchronizing signal.

### BACKGROUND OF THE INVENTION

1. Field of the Invention

The present invention relates to CDMA (Code Division Multiple Access)—RFID (Radio Frequency Identification) system using spread-code modulation in a system comprising an interrogator and a plurality of RF (Radio Frequency) tags (responders).

2. Description of the Related Art

Recently, RF tags have become widely used in various fields such as distribution, merchandise management, historical management, security, detection of fakes and copies, access keys, tickets, prepaid cards, coupon tickets, cash cards, and so on. A system using RF tags is generally comprised of an interrogator and a plurality of RF tags (responders). Subsequently, a method for effectively performing communications between the interrogator and the plurality of RF tags has been invented. For example, in the method disclosed in Japan Patent Publication No. 2000-131423, the RF tags are classified into some groups, and the interrogator specifies a group, puts it into an interrogator signal, and contact with RF tags, and the RF tags respond only when they belong to the specified group.

However, in the method of Japan Patent Publication No. 2000-131423, when the total number of the RF tags in the specified group is too large, many RF tags respond individually, so that the interrogator becomes unable to receive information from the RF tags. In addition, when the total number of the RF tags in the specified group is too small, non-existence of RF tag occurs in many cases, resulting in a delay between the sending of the interrogator signal and the receipt of the response signal.

### SUMMARY OF THE INVENTION

It is an objective of the present invention to solve the above deficiencies.

The first aspect of the present invention is an RF tag, comprising a receiver for interrogator signal, which receives a signal from an interrogator, a generator for synchronization signal, which generates a synchronization signal based on the interrogator signal received by the receiver for interrogator signal, an acquirer for response information, which acquires response information based on the interrogator signal received by the receiver for interrogator signal, a spread-code modulator, which acquires spread-code modulated response information by spread-code modulating the response information acquired by the acquirer for response information, and a transmitter, which transmits a response signal, which includes the spread-code modulated response information as data area acquired by the spread-code modulator, based on the synchronization signal generated by the generator for synchronization signal at random transmission interval.

The second aspect of the present invention is the RF tag according to the first aspect of the present invention, wherein the transmitter comprises, a repeated transmission means, which repeatedly transmits the response signal at random transmission interval.

The third aspect of the present invention is the RF tag according to the second aspect of the present invention, comprising a stopper, which stops transmission by the repeated transmission means.

The fourth aspect of the present invention is the RF tag according to the third aspect of the present invention, comprising a receiver for stop instruction, which receives a stop instruction, wherein the stop instruction is transmitted from the interrogator based on the response signal transmitted from the transmitter, and is for stopping transmission by the repeated transmission means, and the stopper comprises a stopping means according to instruction, which stops transmission by repeated transmission means based on the stop instruction received by the receiver for stop instruction.

The fifth aspect of the present invention is the RF tag according to the third or fourth aspect of the present invention, wherein the stopper comprises a releasing means for stop instruction, which releases the stopped state.

The sixth aspect of the present invention is the RF tag according to any one of the third to fifth aspects of the present invention, wherein the stopper comprises an acquisition means for proof information, which acquires proof information corresponding to the response signal transmitted from the transmitter, and a proof-dependent stopping means, which stops transmission only when the proof information acquired by the acquisition means for proof information fulfils a predetermined condition.

The seventh aspect of the present invention is the RF tag according to any one of the first to sixth aspects of the present invention, wherein the random transmission interval is a random transmission interval based on a predetermined rule.

The eighth aspect of the present invention is the RF tag according to the seventh aspect of the present invention, wherein, in the predetermined rule, an average value of transmission interval is a certain period of time.

The ninth aspect of the present invention is the RF tag according to any one of the first to eighth aspects of the present invention, comprising a storage for RFID information, which stores RFID information, which is information for unique identification of itself, wherein the response signal acquired by the acquirer for response information includes the RFID information acquired from the Storage for RFID information.

The tenth aspect of the present invention is the RF tag according to any one of the first to ninth aspects of the present invention, comprising a storage for identification code, which stores an identification code, and a generator for header, which generates a header including the identification code stored in the storage for identification code.

The eleventh aspect of the present invention is the RF tag according to the tenth aspect of the present invention, wherein a signal configuring the head is a non-interferential signal even if it is overlapped with a signal configuring a data area of other RF tag having the same configuration as that of itself upon decoding of the spread-code by the interrogator.

The twelfth aspect of the present invention is he RF tag according to the tenth aspect of the present invention, wherein a signal configuring the data area is a non-interferential signal even if it is overlapped with a signal configuring a header of other RF tag having the same configuration as that of itself upon decoding of the spread-code by the interrogator.

The thirteenth aspect of the present invention is a RF tag set, comprising an aggregation of a plurality of the RF tag according to any one of any one of the first to ninth aspects of the present invention.

The fourteenth aspect of the present invention is the RF tag set, comprising an aggregation of a plurality of the RF tags according to any one of the tenth to twelfth aspects of the present invention.

The fifteenth aspect of the present invention is the RF tag set according to the fourteenth aspect of the present invention, wherein an identification code of the header is common among the aggregation of a plurality of RF tags.

The sixteenth aspect of the present invention is the RF tag set according to any one of the thirteenth to fifteenth aspects of the present invention, wherein the spread-code used in the different tags is different from each other, in which the spread-code is used in the spread-code modulator of respective RF tags in the aggregation of a plurality of RF tags.

The seventeenth aspect of the present invention is the RF tag set according to any one of the thirteenth to fifteenth aspects of the present invention, wherein a plurality of spread-codes are used, in which the spread-code is used in the spread-code modulator of respective RF tags in the aggregation of a plurality of RF tags.

The eighteenth aspect of the present invention is an interrogator, comprising an acquirer for interrogator signal, which acquires a interrogator signal, a transmitter for interrogator signal, which transmits the interrogator signal acquired by the acquirer for interrogator signal, an acquirer for synchronization signal, which acquires a synchronization signal correlated with the interrogator signal, and a receiver for response signal, which receives a response signal from RF tag to the interrogator signal transmitted from the transmitter for interrogator signal on the basis of the synchronization signal acquired by said acquirer for synchronization signal.

The nineteenth aspect of the present invention is the interrogator according to the eighteenth aspect of the present invention, comprising a measurer for response signal intensity, which measures intensity of the response signal received by the receiver for response signal, a selector, which selects the response signal having a predetermined response signal intensity measured by the measurer for response signal intensity; and a first decoder, which decodes the response signal selected by the selector.

The twentieth aspect of the present invention is the interrogator according to the nineteenth aspect of the present invention, wherein the first decoder comprises, an acquisition means for RFID information, which acquires RFID information for unique identification of the RF tag according to the ninth aspect by decoding spread-code modulated response information, comprising a transmitter for stop instruction, which transmits a stop instruction for stopping transmission of a signal to the RF tag according to the ninth aspect, which is identified by the RFID information acquired by the acquisition means for RFID information.

The twenty-first aspect of the present invention is the interrogator according to the eighteenth aspect of the present invention, comprising a measurer for response signal intensity, which measures intensity of the response signal received by the receiver for response signal, and a second decoder, which decodes a response signal, of which intensity fulfils a predetermined condition, if the response signal intensity measured by the measurer for response signal intensity fulfils a predetermined condition.

The twenty-second aspect of the present invention is the interrogator according to the twenty-first aspect of the present invention, wherein the second decoder comprises, an acquisition means for RFID information, which acquires the RFID information, which is information for unique identification of the RF tag according to the ninth aspect of the present invention, by decoding the spread-code modulated response information, comprising a transmitter for stop instruction, which transmits a stop instruction for stopping transmission of a signal to the RF tag according to the ninth aspect, which is identified by the RFID information acquired by the acquisition means for RFID information.

The twenty-third aspect of the present invention is the interrogator according to any one of the nineteenth to twenty-second aspect of the present invention, wherein the response signal comprises a header including an identification code for measuring the response signal intensity, and the measurer for response signal intensity comprises a correlator, which measures the response signal intensity based on a correlation between an identification code included in the header and a predetermined reference code.

The twenty-fourth aspect of the present invention is the interrogator according to any one of the nineteenth to twenty-third aspects of the present invention, wherein the measurer for response signal intensity comprises a storage means for measurement time constant, which stores the measurement time constant for setting a measurement time for measuring the response signal intensity.

The twenty-fifth aspect of the present invention is the interrogator according to the twenty-fourth aspect of the present invention, wherein the measurement time constant stored by the storage means for measurement time constant is a maximum value of response signal length.

The twenty-sixth aspect of the present invention is the interrogator according to the twenty-fourth or twenty-fifth aspect of the present invention, wherein the measurer for response signal intensity comprises a changing means for measurement time constant, which changes the measurement time constant.

The twenty-seventh aspect of the present invention is the interrogator according to the twenty-fourth aspect of the present invention, wherein the measurement time constant stored by the storage means for measurement time constant is a maximum value of header length.

According to the RF tag of the present invention, it becomes possible to perform simultaneous reading of response signals when an interrogator receives response signals, which are responses to interrogator signals transmitted to a plurality of RF tags. In addition, the response signals are spread by using spread- code, thereby increasing confidentiality of information and improving the tolerance for external noise.

### BRIEF DESCRIPTION OF THE DRAWINGS

FIG. 1 is a functional block diagram of RF tag of the first embodiment;

FIG. 2 is a diagram explaining a synchronization signal of the first embodiment;

FIG. 3 is a diagram explaining a spread-code modulator and transmitter of the first embodiment of the present invention;

FIG. 4 is a diagram explaining spread-code modulation of the first embodiment of the present invention;

FIG. 5 is a diagram explaining a response signal of the first embodiment of the present invention;

FIG. 6 is a diagram explaining a random transmission interval of the first embodiment of the present invention;

FIG. 7 is a concrete functional block diagram of an RF tag of the first embodiment of the present invention;

FIG. 8 is a flow chart of process of the first embodiment of the present invention;

FIG. 9 is a functional block diagram of an interrogator of the second embodiment of the present invention;

FIG. 10 is a diagram explaining a random transmission interval of the second embodiment of the present invention;

FIG. 11 is a concrete functional block diagram of an RF tag of the second embodiment of the present invention;

FIG. 12 is a flow chart of process of the second embodiment of the present invention;

FIG. 13 is a functional block diagram of an RF tag of the third embodiment of the present invention;

FIG. 14 is a concrete functional block diagram of an RF tag of the third embodiment of the present invention;

FIG. 15 is a flow chart of the process of the third embodiment of the present invention;

FIG. 16 is a functional block diagram of an RF tag of the fourth embodiment of the present invention;

FIG. 17 is a concrete functional block diagram of an RF tag of the fourth embodiment of the present invention;

FIG. 18 is a flow chart of process of the fourth embodiment of the present invention;

FIG. 19 is a functional block diagram of an RF tag of the fifth embodiment of the present invention;

FIG. 20 is a concrete functional block diagram of an RF tag of the fifth embodiment of the present invention;

FIG. 21 is a flow chart of process of the fifth embodiment of the present invention;

FIG. 22 is a functional block diagram of an RF tag of the sixth embodiment of the present invention;

FIG. 23 is a concrete functional block diagram of an RF tag of the sixth embodiment of the present invention;

FIG. 24 is a flow chart of process of the sixth embodiment of the present invention;

FIG. 25 is a diagram explaining correspondence between a transmission interval and a response signal of the seventh embodiment of the present invention;

FIG. 26 is a diagram explaining correspondence between a transmission interval and a response signal of the eighth embodiment of the present invention;

FIG. 27 is a functional block diagram of a RF tag of the ninth embodiment of the present invention;

FIG. 28 is a diagram explaining response information 1 of the ninth embodiment of the present invention;

FIG. 29 is a diagram explaining response information 2 of the ninth embodiment of the present invention;

FIG. 30 is a concrete functional block diagram of an RF tag of the ninth embodiment of the present invention;

FIG. 31 is a flow chart of process of the ninth embodiment of the present invention;

FIG. 32 is a functional block diagram of an RF tag of the tenth embodiment of the present invention;

FIG. 33 is a diagram explaining a header and an identification code of the tenth embodiment of the present invention;

FIG. 34 is a concrete functional block diagram of an RF tag of the tenth embodiment of the present invention;

FIG. 35 is a flow chart of process of the tenth embodiment of the present invention;

FIG. 36 is a diagram explaining non-interference 1 of the RF tag the tenth embodiment of the present invention;

FIG. 37 is a diagram explaining non-interference 2 of the RF tag the tenth embodiment of the present invention;

FIG. 38 is a diagram explaining a response signal of the thirteenth embodiment of the present invention;

FIG. 39 is a diagram explaining spread-code modulation of the thirteenth embodiment of the present invention;

FIG. 40 is a diagram explaining a computational expression for decoding a response signal of the thirteenth embodiment of the present invention;

FIG. 41 is a schematic diagram of an RF tag set of the fourteenth embodiment of the present invention;

FIG. 42 is a diagram explaining a response signal of the fourteenth embodiment of the present invention;

FIG. 43 is a diagram explaining spread-code modulation of the fourteenth embodiment of the present invention;

FIG. 44 is a schematic diagram of a plurality of RF tag sets of the fourteenth embodiment of the present invention;

FIG. 45 is a schematic diagram of an RF tag set of the fifteenth embodiment of the present invention;

FIG. 46 is a schematic diagram of a plurality of RF tag sets of the fifteenth embodiment of the present invention;

FIG. 47 is a schematic diagram of an RF tag set of the sixteenth embodiment of the present invention;

FIG. 48 is a diagram explaining a response signal of the sixteenth embodiment of the present invention;

FIG. 49 is a diagram explaining spread-code modulation of the sixteenth embodiment of the present invention;

FIG. 50 is a diagram explaining a computational expression for decoding a response signal of the sixteenth embodiment of the present invention;

FIG. 51 is a schematic diagram of a plurality of RF tag sets of the fifteenth embodiment of the present invention;

FIG. 52 is a schematic diagram of a RF tag set of the seventeenth embodiment of the present invention;

FIG. 53 is a schematic diagram of a plurality of RF tag sets of the seventeenth embodiment of the present invention;

FIG. 54 is a functional block diagram of an interrogator of the eighteenth embodiment of the present invention;

FIG. 55 is a diagram explaining a receipt of a response signal of the eighteenth embodiment of the present invention;

FIG. 56 is a concrete functional block diagram of an interrogator of the eighteenth embodiment of the present invention;

FIG. 57 is a flow chart of process of the eighteenth embodiment of the present invention;

FIG. 58 is a functional block diagram of an interrogator of the nineteenth embodiment of the present invention;

FIG. 59 is a diagram explaining a measurer for response signal intensity of the nineteenth embodiment of the present invention;

FIG. 60 is a diagram explaining response signal intensity 1 of the nineteenth embodiment of the present invention;

FIG. 61 is a diagram explaining response signal intensity 2 of the nineteenth embodiment of the present invention;

FIG. 62 is a diagram explaining a first decoder of the nineteenth embodiment of the present invention;

FIG. 63 is a diagram explaining decoding of a response signal of the nineteenth embodiment of the present invention;

FIG. 64 is a concrete functional block diagram of an interrogator of the nineteenth embodiment of the present invention;

FIG. 65 is a flow chart of process of the nineteenth embodiment of the present invention;

FIG. 66 is a functional block diagram of an interrogator of the twentieth embodiment of the present invention;

FIG. 67 is a concrete functional block diagram of an interrogator of the twentieth embodiment of the present invention;

FIG. 68 is a flow chart of process of the twentieth embodiment of the present invention;

FIG. 69 is a functional block diagram of an interrogator of the twenty-first embodiment of the present invention;

FIG. 70 is a diagram explaining response signal intensity of the twenty-first embodiment of the present invention;

FIG. 71 is a concrete functional block diagram of an interrogator of the twenty-first embodiment of the present invention;

FIG. 72 is a flow chart of the process of the twenty-first embodiment of the present invention;

FIG. 73 is a functional block diagram of an interrogator of the twenty-second embodiment of the present invention;

FIG. 74 is a concrete functional block diagram of an interrogator of the twenty-second embodiment of the present invention;

FIG. 75 is a flow chart of process of the twenty-second embodiment of the present invention;

FIG. 76 is a diagram explaining a measurer for response signal intensity of the twenty-third embodiment of the present invention;

FIG. 77 is a diagram explaining a correrator of the twenty-third embodiment of the present invention;

FIG. 78 is a diagram explaining the step 0 in a correrator of the twenty-third embodiment of the present invention;

FIG. 79 is a diagram explaining steps 1 and 2 in a correrator of the twenty-third embodiment of the present invention;

FIG. 80 is a diagram explaining steps 3 and 4 in a correrator of the twenty-third embodiment of the present invention;

FIG. 81 is a diagram explaining steps 5 and 6 in a correrator of the twenty-third embodiment of the present invention;

FIG. 82 is a diagram explaining steps 7 and 8 in a correrator of the twenty-third embodiment of the present invention;

FIG. 83 is a diagram explaining output of response signal intensity 1 of the twenty-third embodiment of the present invention;

FIG. 84 is a diagram explaining output of response signal intensity 2 of the twenty-third embodiment of the present invention;

FIG. 85 is a functional block diagram of an interrogator of the twenty-fourth embodiment of the present invention;

FIG. 86 is a diagram explaining measurement time of the twenty-fourth embodiment of the present invention;

FIG. 87 is a concrete functional block diagram of an interrogator of the twenty-fourth embodiment of the present invention;

FIG. 88 is a flow chart of the process of the twenty-fourth embodiment of the present invention;

FIG. 89 is a functional block diagram of an interrogator of the twenty-sixth embodiment of the present invention;

FIG. 90 is a concrete functional block diagram of an interrogator of the twenty-sixth embodiment of the present invention;

FIG. 91 is a flow chart of the process of the twenty-sixth embodiment of the present invention.

### DETAILED DESCRIPTION OF THE PREFERRED EMBODIMENTS

Embodiments of the present invention will be described hereinafter. The relationships between the embodiments and the claims are as follows:

The first embodiment will mainly describe claim 1.

The second embodiment will mainly describe claim 2.

The third embodiment will mainly describe claim 3.

The fourth embodiment will mainly describe claim 4.

The fifth embodiment will mainly describe claim 5.

The sixth embodiment will mainly describe claim 6.

The seventh embodiment will mainly describe claim 7.

The eighth embodiment will mainly describe claim 8.

The ninth embodiment will mainly describe claim 9.

The tenth embodiment will mainly describe claim 10.

The eleventh embodiment will mainly describe claim 11.

The twelfth embodiment will mainly describe claim 12.

The thirteenth embodiment will mainly describe claim 13.

The fourteenth embodiment will mainly describe claim 14.

The fifteenth embodiment will mainly describe claim 15.

The sixteenth embodiment will mainly describe claim 16.

The seventeenth embodiment will mainly describe claim 17.

The eighteenth embodiment will mainly describe claim 18.

The nineteenth embodiment will mainly describe claim 19.

The twentieth embodiment will mainly describe claim 20.

The twenty-first embodiment will mainly describe claim 21.

The twenty-second embodiment will mainly describe claim 22.

The twenty-third embodiment will mainly describe claim 23.

The twenty-fourth embodiment will mainly describe claim 24.

The twenty-fifth embodiment will mainly describe claim 25.

The twenty-sixth embodiment will mainly describe claim 26.

The twenty-seventh embodiment will mainly describe claim 27.

### First Embodiment

Hereinbelow, the first embodiment will be described.

The invention of the first embodiment relates to an RF tag, comprising a receiver for interrogator signal, which receives a signal from an interrogator, a generator for synchronization signal, which generates a synchronization signal based on the interrogator signal received by the receiver for interrogator signal, an acquirer for response information, which acquires response information based on the interrogator signal received by the receiver for interrogator signal, a spread-code modulator, which acquires spread-code modulated response information by spread-code modulating the response information acquired by the acquirer for response information, and a transmitter, which transmits a response signal, which includes the spread-code modulated response information as data area acquired by the spread-code modulator, based on the synchronization signal generated by the generator for synchronization signal at random transmission interval.

Hereinbelow, the constituent features of the first embodiment will be indicated.

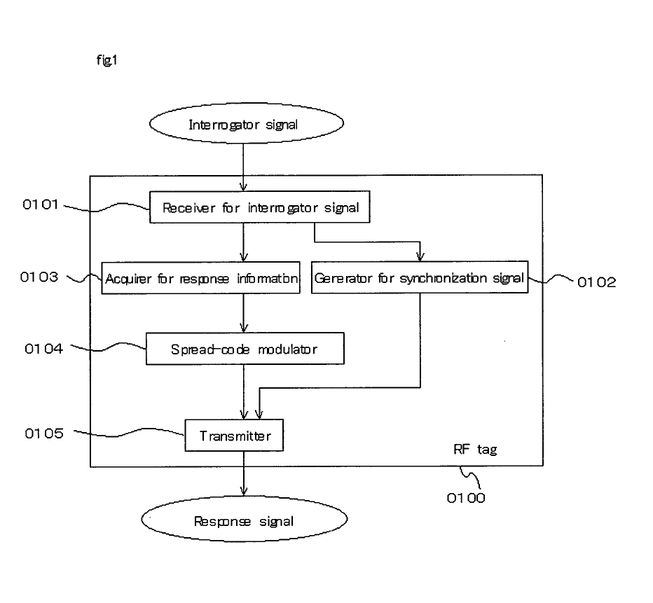

As shown in FIG. 1, the RF tag 0100 of the first embodiment comprises the receiver for interrogator signal 0101, the generator for synchronization signal 0102, the acquirer for response information 0103, the spread-code modulator 0104, and the transmitter 0105.

Hereinbelow, the constituent features of the first embodiment will be described.

The receiver for interrogator signal receives a signal from an interrogator. Here, examples of the ‘interrogator signal’ include a signal for power supply for supplying power to a responder, therefore, to an RF tag, a synchronization signal for synchronizing the RF tag with the interrogator, and a query signal for indicating a query to the RF tag. Here, the ‘signal for power supply’ corresponds to a signal for supplying power for operation of an RF tag, and the power is supplied by converting electromagnetic energy such as a carrier wave of an interrogator signal to electromotive force. Further, the ‘query signal’ is a signal transmitted from an interrogator to an RF tag. Examples of the query signal include a transmission command for RF tag identification information, an information writing command, and information reading command. The ‘synchronization signal’ will be described in the description of the generator for synchronization signal. Note that, as to the ‘interrogator signal’, in cases where the spread-code modulation, which will be described in the description of the spread-code modulator, is carried out by the interrogator, the spread-code modulated interrogator signal can be decoded by inverse spread-code modulation.

The generator for synchronization signal generates a synchronization signal based on the interrogator signal received by the receiver for interrogator signal. Here, the ‘synchronization signal’ is a signal for synchronization between clock frequency of the interrogator and that of the RF tag. Further, the ‘synchronization’ means that frequencies of the clock frequency signals are the same, are integral multiplied, or are integral divided. It is not necessary that phases of the clock frequencies are identical.

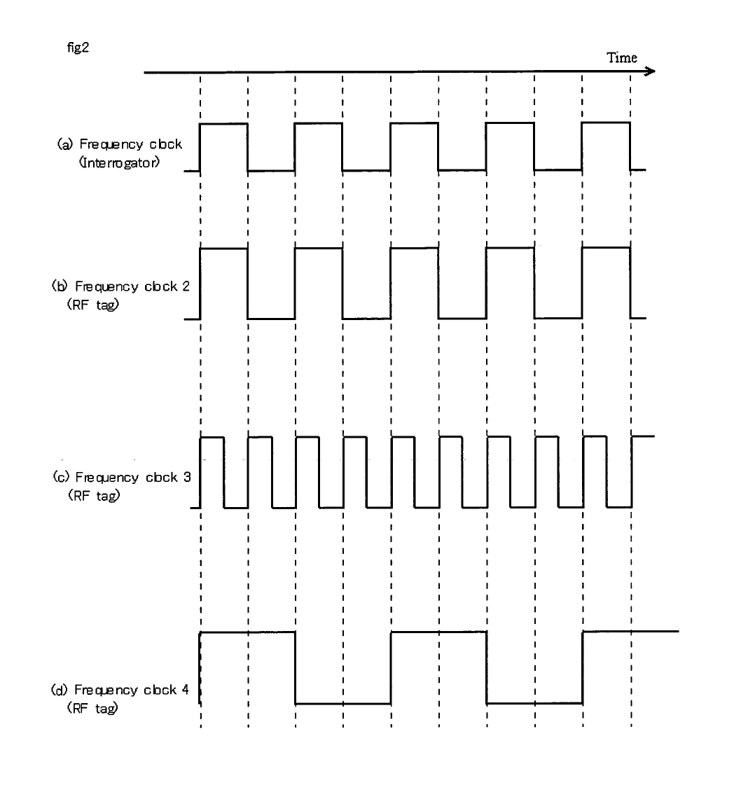

FIG. 2 is a schematic diagram showing a relationship between the clock frequency of the interrogator and the clock frequency of the RF tag in disregard of transmission delay. FIG. 2(a) shows the clock frequency 1 of the interrogator, and FIG. 2(b) shows the clock frequency 2 of the RF tag to the clock frequency 1 of the interrogator. In this case, phase and frequency of the clock frequency 2 of the RF tag and those of the clock frequency 1 of the interrogator are identical. Further, FIG. 2(c) shows the clock frequency 3 of the RF tag. In this case, although the clock frequency 1 of the interrogator is ½ of the clock frequency 3 of the RF tag, the rising edges of the clock frequencies are identical. Furthermore, FIG. 2(d) shows the clock frequency 4 of the RF tag. In this case, although the clock frequency 1 of the interrogator is 2 times the clock frequency 4 of the RF tag, the rising edges of the clock frequencies are identical. Note that, the clock frequency of the interrogator may be ¼, 4, and so on of the clock frequency of the RF tag without limitation such as 1 time, ½, and 2 times.

The acquirer for response information acquires response information based on the interrogator signal received by the receiver for interrogator signal. Here, the ‘response signal’ is information to be transmitted to the interrogator based on the interrogator signal, and examples thereof include identification information for identifying itself, and information for indicating a response to a query to the interrogator. Further, the term ‘acquire’ means that the response signal is generated based on the interrogator signal and the generated response signal is acquired.

The spread-code modulator acquires spread-code modulated response information by spread-code modulating the response information acquired by the acquirer for response information. Here, the ‘spread-code modulation’ corresponds to modulating a response signal by using a spread-code. The ‘spread-code’ is binary digital code sequence irrelevant to response signal and is code-multiplied by response signal and spread over frequency axis. The spread-code is multiplied by response signal and spread over frequency axis, thereby increasing confidentiality of information, and enhancing interference resistance. Examples of the spread-code include PN (Pseudo Noise) code and Barker code. In the cases of spread spectrum communication or CDMA, since it is required that modulation is carried out by code having a higher rate than that of the response signal, and spread-code has uniform spectrum in a band and periodicity, PN code is used. PN code is generated, for example, by a circuit-using shift resister and feedback based on a particular rule.

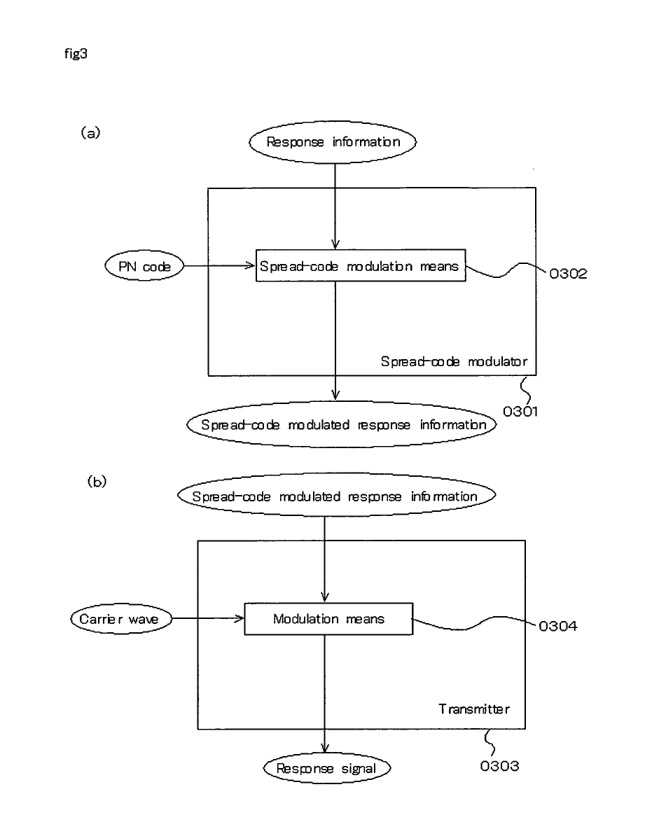

FIG. 3(a) is a diagram exemplifying a configuration of the spread-code modulator 0301. The spread-code modulator comprises the spread-code means 0302. Here, the ‘spread-code modulation means’ performs operation on the response signal and the PN code, which is a spread-code. Here, the ‘operation’ corresponds to exclusive disjunction etc.

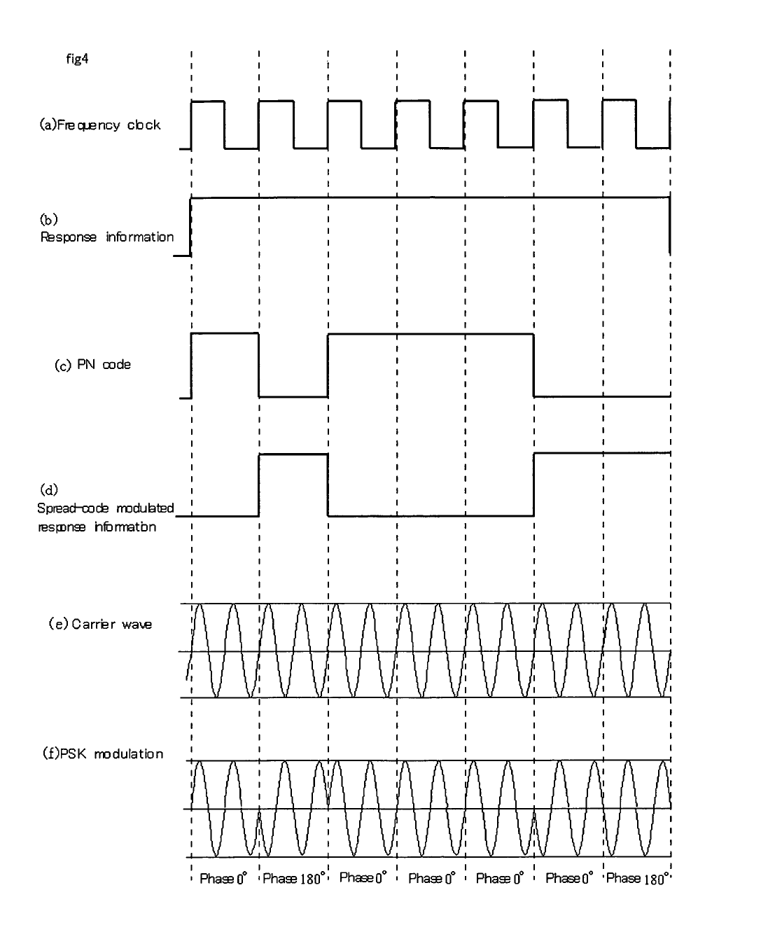

FIG. 4(a),(b),(c), and (d) are diagrams explaining the case where 1-bit binary data ‘1’, which is response information, is spread-code modulated by 7 bet binary data ‘1011100’, which is PN code, and the spread-code modulated response information is generated. In this case, exclusive disjunction is used for operation by the spread-code modulation means. FIG. 4(a) shows clock pulse of RF tag. FIG. 4(b) shows the digital pulse signal indicating 1-bit response information, which indicates ‘1’ during the clock 1 to 7. FIG. 4(c) shows digital pulse signal indicating 7 bit PN code, which changes to ‘1’, ‘0’, ‘1’, ‘1’, ‘1’, and ‘0’ corresponding to the clock ‘1’ to ‘7’, respectively. FIG. 4(d) shows digital pulse signal indicating the exclusive disjunction of the response signal of FIG. 4(b) and the PN code of FIG. 4(c), which is spread-code modulated response information.

Hereinabove, although the 1-bit response information has been described as a simple example, the case of multiple bit response information can be considered similarly. In addition, the PN code is not limited to 7-bit, and may be 2, 3, . . . , 16, . . . , 128, . . . , and so on for 1-bit response information.

The transmitter transmits a response signal, which includes the spread-code modulated response information as data area acquired by the spread-code modulator, based on the synchronization signal generated by the generator for synchronization signal at random transmission interval. Here, the ‘response signal’ consists of data area including the spread-code modulated response information, and the other signal. The ‘other signal’ includes header information indicating a group, to which a RF tag of itself belongs, or error-correction code such as CRC (Cyclic Redundancy Check Code).

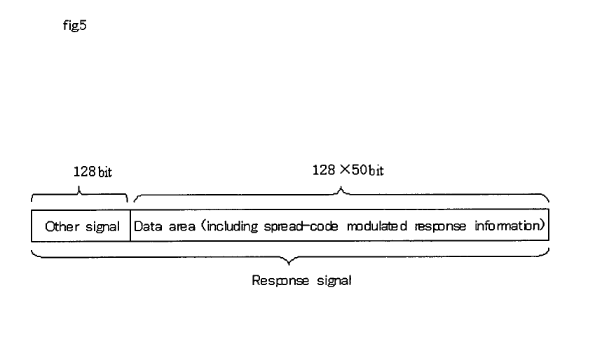

FIG. 5 is a diagram exemplifying a configuration of the response signal. The response signal is configured of 128-bit other signal and 128×50-bit data area including the spread-code modulated response information. Generally, it is configured, but is not limited to, that the signal amount of a header is small enough in comparison to that of data area. The amount of the data area is 5 to 1,000 times of the header.

Here, the ‘random transmission interval’ is, for example, an interval between the end of the last transmission of response signal and the start of the next transmission of response signal after the random cycle of clock frequency of RF tag. Moreover, it may be absolute time between the start point of the first transmission of the response signal and the start point of any transmission of response signal. The random frequency clock of an RF tag is generated, for example, by a random number generator.

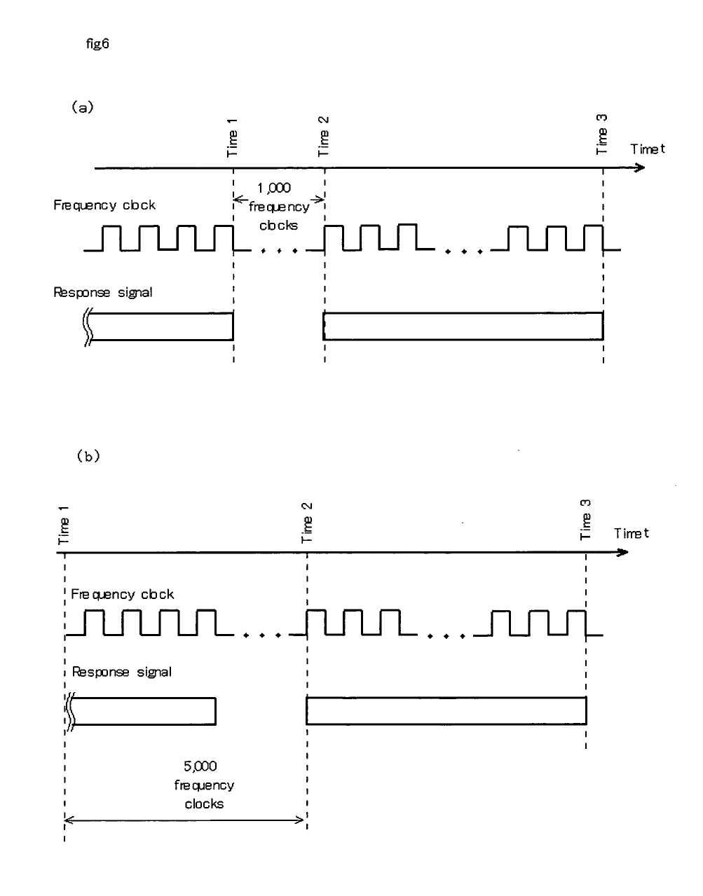

FIG. 6 is a diagram explaining a random transmission interval. In FIG. 6(a), the last transmission of response signal is completed at the time 1. Further, for example, after 1,000 clocks, the next transmission of response signal is started (the time 2). In FIG. 6(b), the first transmission of response signal is started at the time 1. The next transmission of response signal is started at the time 1, for example, after 5,000 clocks (the time 2). These numbers, 1000 and 5000, are random numbers determined by a random number generator etc.

FIG. 3(b) is a diagram exemplifying a configuration of the transmitter 0303. The transmitter comprises the modulation means 0304. The spread-code modulated response information, which has been spread-code modulated by the spread-code modulation means, is modulated by carrier wave by the modulation means of the transmitter, and is outputted as a response signal. Here, the ‘modulation’ corresponds to PSK (Phase Shift Keying) etc. The response signal modulated by the modulation means is transmitted from the transmitter as a response signal. Moreover, the carrier wave used for the modulation may be generated by the RF tag autonomously, or may be generated by reflecting the carrier wave of the interrogator signal from the interrogator using an element such as a high-speed diode switch etc. For example, 2 MHz carrier wave for response signal can be generated from 2.45 GHz carrier wave of the interrogator signal by using a high-speed diode switch. Moreover, modulation by the modulation means may be carried out by the spread-code modulator, but not limited to by the transmitter.

FIG. 4(e) and (f) show that the spread-code modulated response information generated by the spread-code modulator is modulated by the modulation means of the transmitter, and the response signal is generated. FIG. 4(e) shows the carrier wave, which is a sine-wave and used by the modulation means. FIG. 4(f) shows a wave pattern the spread-code modulated response information generated in FIG. 4(d) is PSK modulated using the carrier wave of FIG. 4(e). Therefore, in the spread-code modulated response information generated in FIG. 4(d), when the digital pulse signal indicates ‘0’, the phase of the carrier wave of FIG. 4(e) is 0°, and when it indicates ‘1’, the phase is 180°.

Note that, the modulation method in the modulation means is not limited to PSK modulation, and may be FSK (Frequency Shift Keying) modulation, or ASK (Amplitude Shift Keying) modulation etc. Moreover, as to the spread-code modulated response information, signals indicating synchronous bit, start bit, end bit, or error correction code bit may be added to the response signal.

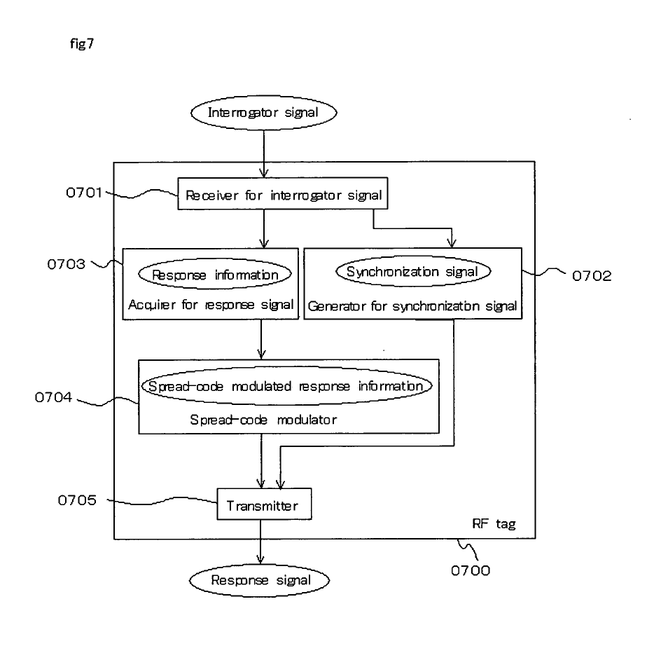

FIG. 7 is a diagram explaining flow of the information and the signal of the RF tag 0700 of the first embodiment. The RF tag of the first embodiment comprises the receiver for interrogator signal 0701, the generator for synchronization signal 0702, the acquirer for response information 0703, the spread-code modulator 0704, and the transmitter 0705. The receiver for interrogator signal receives the interrogator signal from the interrogator. The acquirer for response information acquires the response information. The generator for synchronization signal generates the synchronization signal. The spread-code modulator generates the spread-code modulated response information. The transmitter transmits the response signal.

Hereinbelow, the processing flow of the first embodiment will be described.

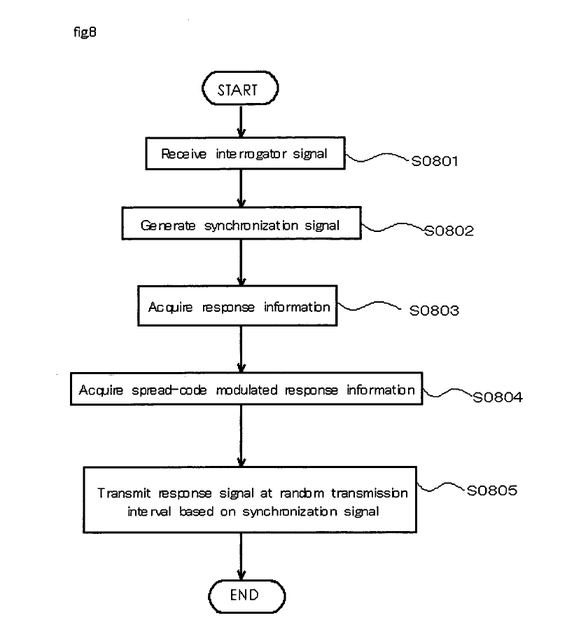

FIG. 8 is a diagram explaining the processing flow of the first embodiment.

The receiver for interrogator signal receives a signal from an interrogator (the step S0801). The generator for synchronization signal generates a synchronization signal based on the interrogator signal received by the receiver for interrogator signal (the step S0802). The acquirer for response information acquires response information based on the interrogator signal received by the receiver for interrogator signal (the step S0803). The spread-code modulator acquires spread-code modulated response information by spread-code modulating the response information acquired by the acquirer for response information (the step S0804). The transmitter transmits a response signal, which includes the spread-code modulated response information as data area acquired by the spread-code modulator, based on the synchronization signal generated by the generator for synchronization signal at random transmission interval (the step S0805).

According to the RF tag of the first embodiment, it becomes possible for the interrogator to receive and to read response signals from a plurality of RF tags.

### Second Embodiment

Hereinbelow, the concept of the second embodiment will be described.

The invention described in the second embodiment relates to the RF tag according to the first embodiment, wherein the transmitter comprises a repeated transmission means, which repeatedly transmits the response signal at random transmission interval.

Hereinbelow, the constituent features of the second embodiment will be indicated.

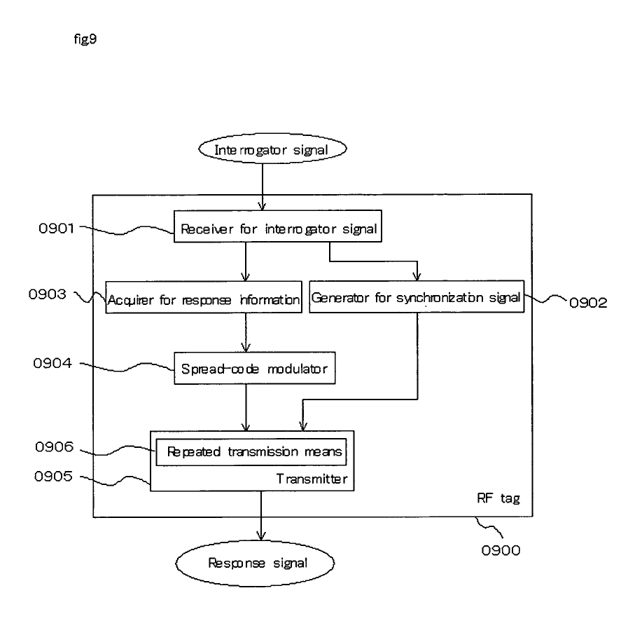

As shown in FIG. 9, the RF tag 0900 of the second embodiment comprises the receiver for interrogator signal 0901, the generator for synchronization signal 0902, the acquirer for response information 0903, the spread-code modulator 0904, and the transmitter 0905. Moreover, the transmitter comprises the repeated transmission means 0906.

Hereinbelow, the constituent features of the second embodiment will be described. The receiver for interrogator signal, the generator for synchronization signal, the acquirer for response information, and the spread-code modulator are the same as those of the first embodiment, so that the descriptions thereof will be omitted.

The transmitter comprises the repeated transmission means, which repeatedly transmits the response signal at random transmission interval. Here, the term ‘repeatedly’ means that the response signal is transmitted repeatedly. Here, the ‘random transmission interval’ is, for example, a interval between the end of the last transmission of response signal and the start of the next transmission of response signal after the random cycle of clock frequency of RF tag. Moreover, it may be absolute time between the start point of the first transmission of the response signal and the start point of any transmission of response signal. The random frequency clock of an RF tag is generated, for example, by a random number generator.

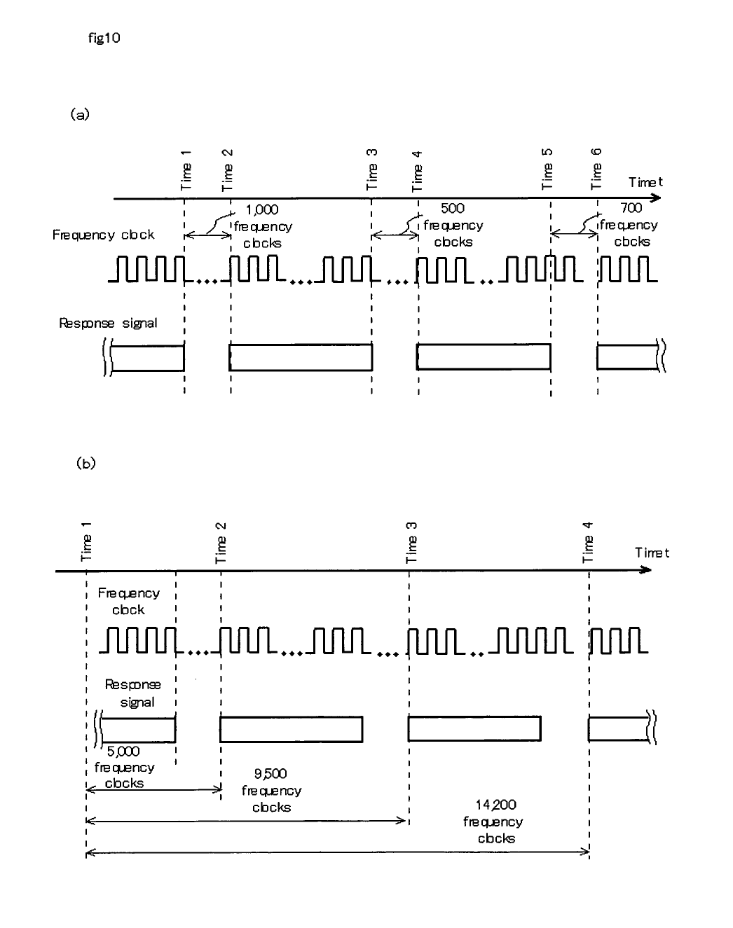

FIG. 10 is a diagram explaining ‘at random transmission interval repeatedly’. In FIG. 10(a), the first transmission of response signal is completed at the time 1. Further, for example, at the time 2, which is after 1,000 clocks from the time 1, the second transmission of response signal is started, and completed at the time 3. Further, for example, at the time 4, which is after 500 clocks from the time 3, the third transmission of response signal is started, and completed at the time 5. Further, for example, at the time 6, which is after 700 clocks from the time 5, the fourth transmission of response signal is started. Hereinbelow, in the same manner, the response signal is transmitted repeatedly. In FIG. 10(b), at the time 1, the first transmission of the response signal is started. The second transmission of the response signal is started, for example, after 5,000 clocks from the time 1 (the time 2). Subsequently, the third transmission of the response signal is started, for example, after 9,500 clocks from the time 1 (the time 3). The fourth transmission of the response signal is started, for example, after 14,200 clocks from the time 1 (the time 4). These numbers 1000, 500, 700, 5,000, 9,500 and 14,200, are random numbers determined by a random number generator etc.

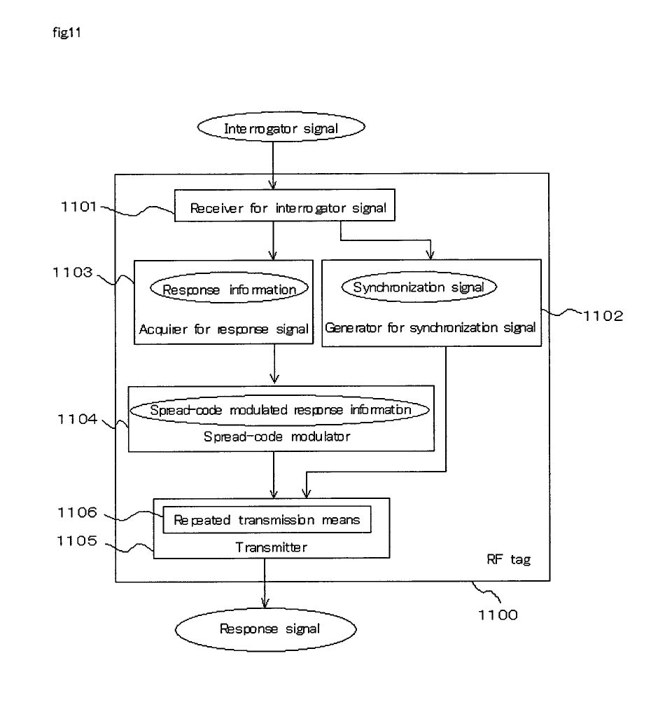

FIG. 11 is a diagram explaining flow of the information and the signal of the RF tag 1100 of the second embodiment. The RF tag of the second embodiment comprises the receiver for interrogator signal 1101, the generator for synchronization signal 1102, the acquirer for response information 1103, the spread-code modulator 1104, and the transmitter 1105. Further, the transmitter comprises the repeated transmission means 1106. The receiver for interrogator signal receives the interrogator signal from the interrogator. The acquirer for response information acquires the response information. The generator for synchronization signal generates the synchronization signal. The spread-code modulator generates the spread-code modulated response information. The transmitter transmits the response signal repeatedly.

Hereinbelow, the processing flow of the second embodiment will be described.

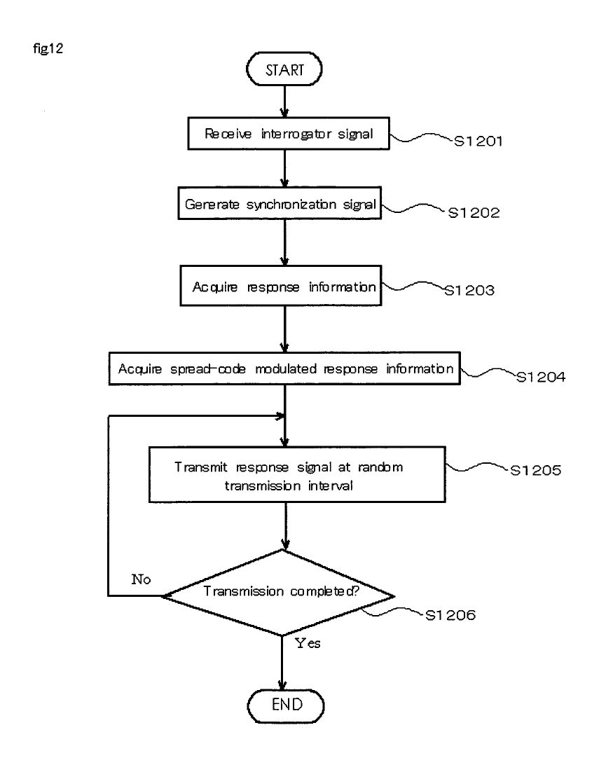

FIG. 12 is a diagram explaining the processing flow of the second embodiment.

The receiver for interrogator signal receives a signal from an interrogator (the step S1201). The generator for synchronization signal generates a synchronization signal based on the interrogator signal received by the receiver for interrogator signal (the step S1202). The acquirer for response information acquires response information based on the interrogator signal received by the receiver for interrogator signal (the step S1203). The spread-code modulator acquires spread-code modulated response information by spread-code modulating the response information acquired by the acquirer for response information (the step S1204). The transmitter transmits a response signal acquired by the spread-code modulator based on the synchronization signal generated by the generator for synchronization signal at random transmission interval (the step S1205). Subsequently, the transmitter determines whether the transmission of the response signal is completed (the step S1206). If the transmission is not completed, the processing is back to the step S1205, and transmission is repeated. if the transmission is completed, the processing is terminated.

According to the RF tag of the second embodiment, it becomes possible to improve accuracy of reading the response signal from the RF tag by the interrogator.

### Third Embodiment

Hereinbelow, the concept of the third embodiment will be described.

The invention described in the third embodiment relates to the RF tag according to the second embodiment, comprising:

a stopper, which stops transmission by the repeated transmission means.

Hereinbelow, the constituent features of the third embodiment will be indicated.

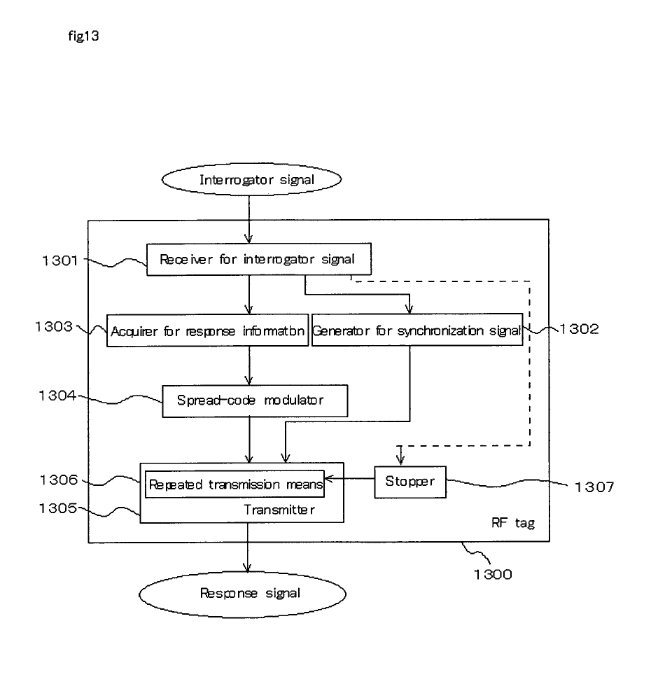

As shown in FIG. 13, the RF tag 1300 of the third embodiment comprises the receiver for interrogator signal 1301, the generator for synchronization signal 1302, the acquirer for response information 1303, the spread-code modulator 1304, the transmitter 1305, and the stopper 1307. Moreover, the transmitter comprises the repeated transmission means 1306.

Hereinbelow, the constituent features of the third embodiment will be described. The receiver for interrogator signal, the generator for synchronization signal, the acquirer for response information, the spread-code modulator, and the transmitter are the same as those of the second embodiment, so that the descriptions thereof will be omitted.

The stopper stops transmission by the repeated transmission means. Here, the term ‘stops transmission’ means stopping transmission of response signal autonomously, or monitoring the interrogator signal and stopping transmission in a predetermined case. The ‘predetermined case’ corresponds to the case where the signal level is lower than a certain level and it is determined that there is no electric wave, and to the case where the clock frequency of the interrogator and the clock frequency of the RF tag are not synchronized. Further, examples of the cases of autonomously stopping include cases of stopping by number of transmissions and by a timer. In addition, in cases where transmission is stopped according to a result of monitoring the interrogator signal, if there is no response signal under transmission, the next transmission of the response signal may be stopped, and if there is response signal under transmission, transmission may be stopped after the transmission is completed, or may be stopped at the middle of the transmission.

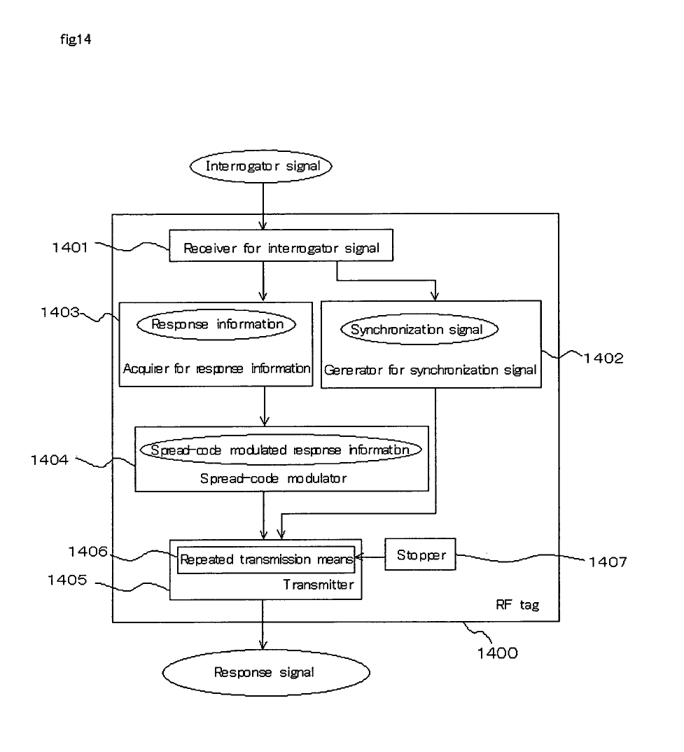

FIG. 14 is a diagram explaining flow of the information and the signal of the RF tag 1400 of the third embodiment. The RF tag of the third embodiment comprises the receiver for interrogator signal 1401, the generator for synchronization signal 1402, the acquirer for response information 1403, the spread-code modulator 1404, the transmitter 1405, and the stopper 1407. Further, the transmitter comprises the repeated transmission means 1406. The receiver for interrogator signal receives the interrogator signal from the interrogator. The acquirer for response information acquires the response information. The generator for synchronization signal generates the synchronization signal. The spread-code modulator generates the spread-code modulated response information. The transmitter transmits the response signal repeatedly unless the stopper carries out stoppage.

Hereinbelow, the processing flow of the third embodiment will be described.

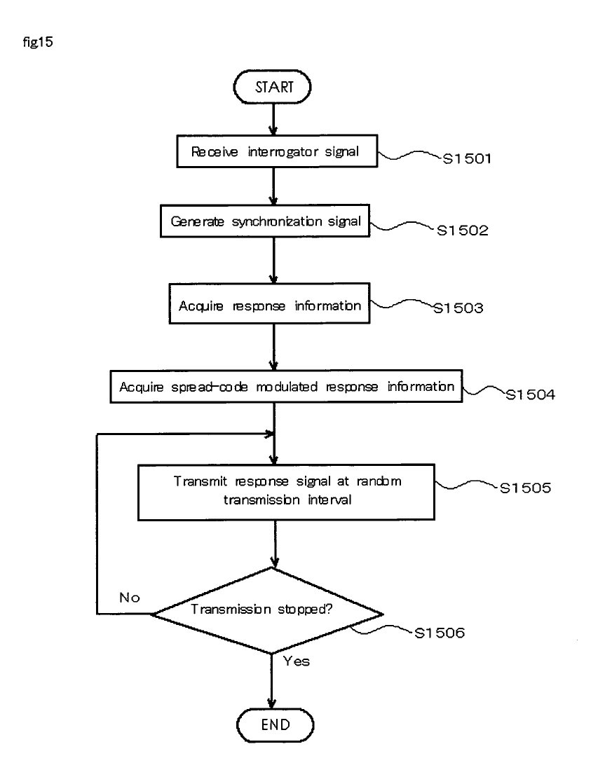

FIG. 15 is a diagram explaining the processing flow of the third embodiment.

The receiver for interrogator signal receives a signal from an interrogator (step S1501). The generator for synchronization signal generates a synchronization signal based on the interrogator signal received by the receiver for interrogator signal (step S1502). The acquirer for response information acquires response information based on the interrogator signal received by the receiver for interrogator signal (step S1503). The spread-code modulator acquires spread-code modulated response information by spread-code modulating the response information acquired by the acquirer for response information (step S1504). The transmitter transmits a response signal acquired by the spread-code modulator based on the synchronization signal generated by the generator for synchronization signal at random transmission interval (step S1505). Subsequently, the transmitter determines whether the stopper stops transmission of the response signal (step S1506). If the transmission is not stopped, the processing is back to the step S1505, and transmission is repeated. If the transmission is stopped, the processing is terminated.

According to the RF tag of the third embodiment, it becomes possible to stop transmission of the response signal.

### Fourth Embodiment

Hereinbelow, the concept of the fourth embodiment will be described.

The invention described in the fourth embodiment relates to the RF tag according to the third embodiment, comprising a receiver for stop instruction, which receives a stop instruction, wherein the stop instruction is transmitted from the interrogator based on the response signal transmitted from the transmitter, and is for stopping transmission by the repeated transmission means, and the stopper comprises, a stopping means according to instruction, which stops transmission by repeated transmission means based on the stop instruction received by the receiver for stop instruction.

Hereinbelow, the constituent features of the fourth embodiment will be indicated.

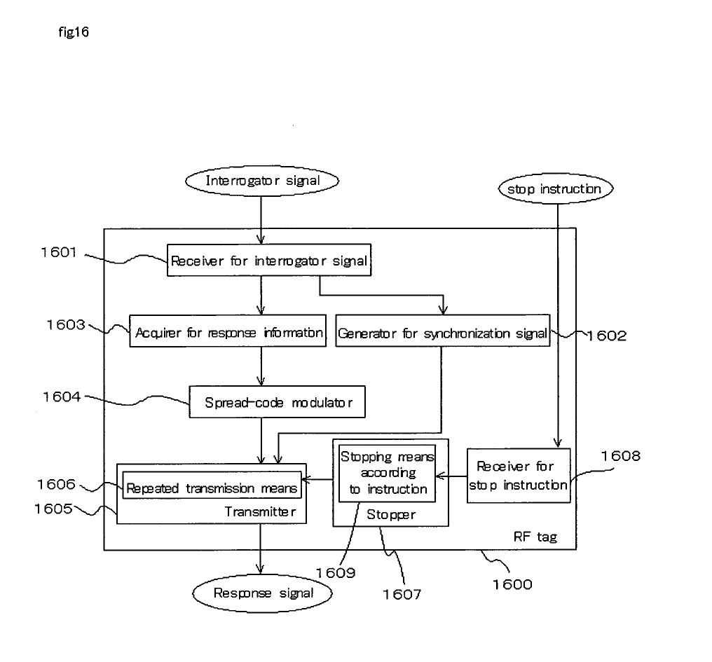

As shown in FIG. 16, the RF tag 1600 of the fourth embodiment comprises the receiver for interrogator signal 1601, the generator for synchronization signal 1602, the acquirer for response information 1603, the spread-code modulator 1604, the transmitter 1605, and the stopper 1607. Moreover, the transmitter comprises the repeated transmission means 1606. Furthermore, the stopper comprises the stopping means according to instruction 1609.

Hereinbelow, the constituent features of the fourth embodiment will be described. The receiver for interrogator signal, the generator for synchronization signal, the acquirer for response information, the spread-code modulator, and the transmitter are the same as those of the third embodiment, so that the descriptions thereof will be omitted.

The receiver for stop instruction, which receives a stop instruction, wherein the stop instruction is transmitted from the interrogator based on the response signal transmitted from the transmitter, and is for stopping transmission by the repeated transmission means. Here, the term ‘based on the response signal’ means ‘based on the content of the response information included in the response signal from the RF tag received by the interrogator’. Further, the ‘stop instruction’ corresponds to instruction from the interrogator to the RF tag for stopping the response signal based on a recognition of normal termination of processing of the received response signal. Example thereof includes an instruction of command format having a certain pattern of ‘0’ and ‘1’. In addition, the stop instruction may be a system reset for resetting the RF tag. Here, examples of the system reset include resetting information stored in a predetermined memory of a RF tag to the initial state, or setting back a sequence of programmed processes carried out by the RF tag to a predetermined step.

The stopper comprises a stopping means according to instruction, which stops transmission by repeated transmission means based on the stop instruction received by the receiver for stop instruction. Here, the terms ‘stopping according to instruction’ means stopping according to the stop instruction received by the receiver for stop instruction. The stoppage of transmission of the response signal is carried out according to the stop instruction transmitted from the interrogator. If there is no response signal under transmission, the next transmission of response signal is stopped, and if there is a response signal under transmission, the transmission is stopped immediately or after the transmission is completed. The condition for stopping transmission is reception of the stop instruction from the interrogator.

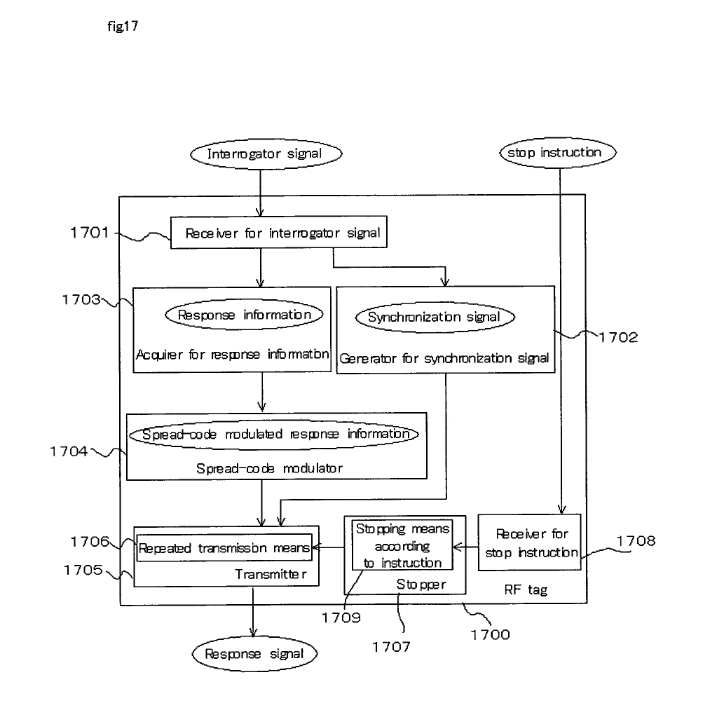

FIG. 17 is a diagram explaining the flow of the information and the signal of the RF tag 1700 of the fourth embodiment. The RF tag of the fourth embodiment comprises the receiver for interrogator signal 1701, the generator for synchronization signal 1702, the acquirer for response information 1703, the spread-code modulator 1704, the transmitter 1705, the stopper 1707, and the receiver for stop instruction 1708. Further, the transmitter comprises the repeated transmission means 1706. Furthermore, the stopper comprises the stopping means according to instruction 1709. The receiver for interrogator signal receives the interrogator signal from the interrogator. The acquirer for response information acquires the response information. The generator for synchronization signal generates the synchronization signal. The spread-code modulator generates the spread-code modulated response information. The receiver for stop instruction receives the stop instruction from the interrogator. The transmitter transmits the response signal repeatedly unless the stopper carries out stoppage.

Hereinbelow, the processing flow of the fourth embodiment will be described.

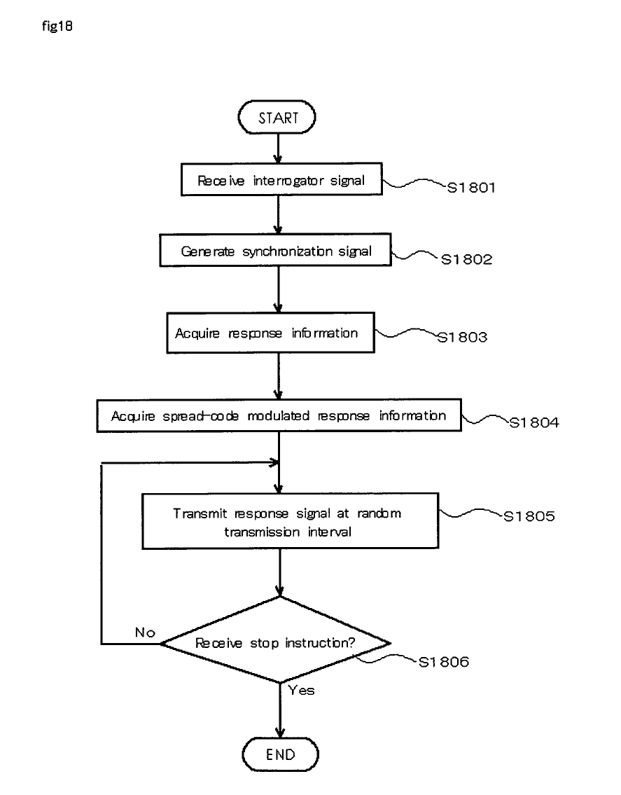

FIG. 18 is a diagram explaining the processing flow of the fourth embodiment.

The receiver for interrogator signal receives a signal from an interrogator (step S1801). The generator for synchronization signal generates a synchronization signal based on the interrogator signal received by the receiver for interrogator signal (step S1802). The acquirer for response information acquires response information based on the interrogator signal received by the receiver for interrogator signal (step S1803). The spread-code modulator acquires spread-code modulated response information by spread-code modulating the response information acquired by the acquirer for response information (step S1804). The transmitter transmits a response signal acquired by the spread-code modulator based on the synchronization signal generated by the generator for synchronization signal at random transmission interval (step S1805). Subsequently, the transmitter determines whether the stopper stops transmission of the response signal based on the stop instruction received from the interrogator by the receiver for stop instruction (step S1806). If the transmission is not stopped, the processing goes back to step S1805, and transmission is repeated. If the transmission is stopped, the processing is terminated.

According to the RF tag of the fourth embodiment, it becomes possible to stop transmission of the response signal, which has been processed by the interrogator.

### Fifth Embodiment

Hereinbelow, the concept of the fifth embodiment will be described.

The invention described in the fifth embodiment relates to the RF tag according to the third or fourth embodiments, wherein the stopper comprises a releasing means for stop instruction, which releases the stopped state.

Hereinbelow, the constituent features of the fifth embodiment will be indicated.

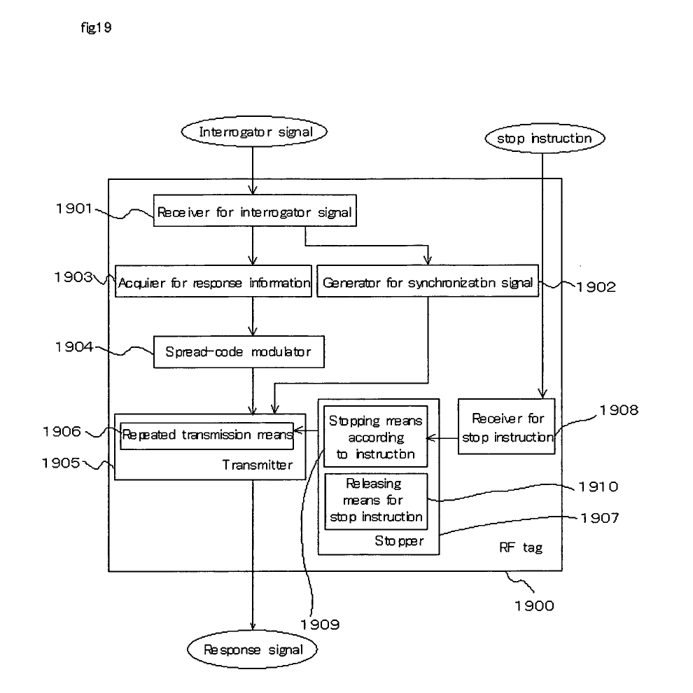

As shown in FIG. 19, the RF tag 1900 of the fifth embodiment comprises the receiver for interrogator signal 1901, the generator for synchronization signal 1902, the acquirer for response information 1903, the spread-code modulator 1904, the transmitter 1905, the stopper 1907, and the receiver for stop instruction 1908. Moreover, the transmitter comprises the repeated transmission means 1906. Furthermore, the stopper comprises the stopping means according to instruction 1909, and the releasing means for stop instruction 1910.

Hereinbelow, the constituent features of the RF tag of the fifth embodiment will be described. The receiver for interrogator signal, the generator for synchronization signal, the acquirer for response information, the spread-code modulator, the transmitter, and the receiver for stop instruction are the same as those of the third or the fourth embodiments, so that the descriptions thereof will be omitted.

The stopper comprises the releasing means for stop instruction, which releases the stopped state. Here, the term ‘releases the stopped state’ means starting transmission of response signal, which has been stopped in accordance with a certain rule. Further, examples of ‘certain rule’ include releasing the stopped state according to a timer after a certain period of time, receiving the releasing stop instruction, or a combination of them. For example, the reception of the releasing stop instruction includes the case that the receiver for stop instruction receives it from the interrogator. The receiver for stop instruction receives the releasing stop instruction in a command format as well as the stop instruction, and the releasing means for stop instruction of the stopper takes over the processing. The means for stop instruction releases the stoppage of transmission of the response signal in accordance with the releasing stop instruction from the receiver for stop instruction. Note that, the releasing stop instruction from the interrogator may be directly received by the releasing means for stop instruction of the stopper.

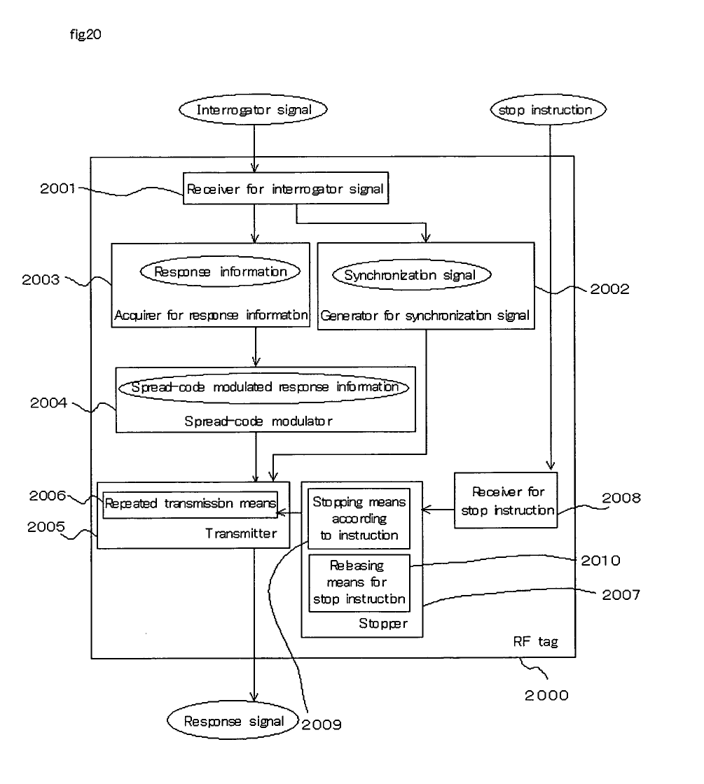

FIG. 20 is a diagram explaining the flow of the information and the signal of the RF tag 2000 of the fifth embodiment. The RF tag of the fifth embodiment comprises the receiver for interrogator signal 2001, the generator for synchronization signal 2002, the acquirer for response information 2003, the spread-code modulator 2004, the transmitter 2005, the stopper 2007, and the receiver for stop instruction 2008. Further, the transmitter comprises the repeated transmission means 2006. Furthermore, the stopper comprises the stopping means according to instruction 2009, and the releasing means for stop instruction 2010. The receiver for interrogator signal receives the interrogator signal from the interrogator. The acquirer for response information acquires the response information. The generator for synchronization signal generates the synchronization signal. The spread-code modulator generates the spread-code modulated response information. The receiver for stop instruction receives the stop instruction from the interrogator. The transmitter releases the stoppage of the transmission of the response signal if there is a request for releasing the stop instruction from the releasing means for stop instruction at the stopped state of transmission.

Hereinbelow, the processing flow of the fifth embodiment will be described.

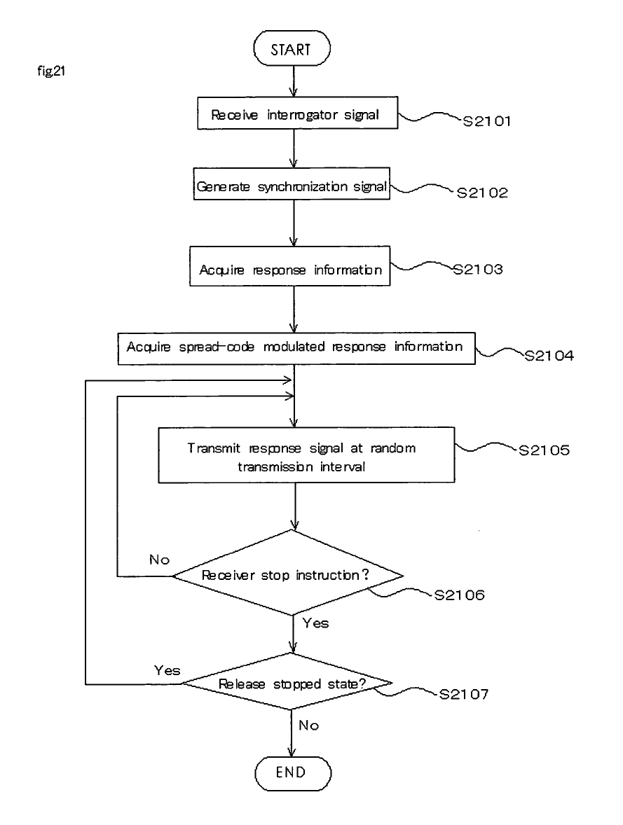

FIG. 21 is a diagram explaining the processing flow of the fifth embodiment.

The receiver for interrogator signal receives a signal from an interrogator (step S2101). The generator for synchronization signal generates a synchronization signal based on the interrogator signal received by the receiver for interrogator signal (step S2102). The acquirer for response information acquires response information based on the interrogator signal received by the receiver for interrogator signal (step S2103). The spread-code modulator acquires spread-code modulated response information by spread-code modulating the response information acquired by the acquirer for response information (step S2104). The transmitter transmits a response signal acquired by the spread-code modulator based on the synchronization signal generated by the generator for synchronization signal at random transmission interval (step S2105). Subsequently, the transmitter determines whether the stopper stops transmission of the response signal based on the stop instruction received from the interrogator by the receiver for stop instruction (step S2106). If the transmission is not stopped, the processing goes back to step S2105, and transmission is repeated. If the transmission is stopped, the processing goes to the subsequent step S2107. The transmitter determines whether the releasing stop instruction from the releasing means for stop instruction is received (step S2107). If it is received, the processing is back to step S2105, and transmission is repeated. If not, the processing is terminated.

According to the RF tag of the fifth embodiment, the stopper comprises the releasing means for stop instruction, which releases the stopped state, so that it becomes possible to release stoppage of transmission in cases where transmission of response signal is stopped.

### Sixth Embodiment

Hereinbelow, the concept of the sixth embodiment will be described.

The invention of the sixth embodiment relates to the RF tag according to any one of the third to fifth embodiments, wherein the stopper comprises the acquisition means for proof information, which acquires proof information corresponding to the response signal transmitted from the transmitter; and the proof-dependent stopping means, which stops transmission only when the proof information acquired by the acquisition means for proof information fulfils a predetermined condition.

Hereinbelow, the constituent features of the sixth embodiment will be indicated.

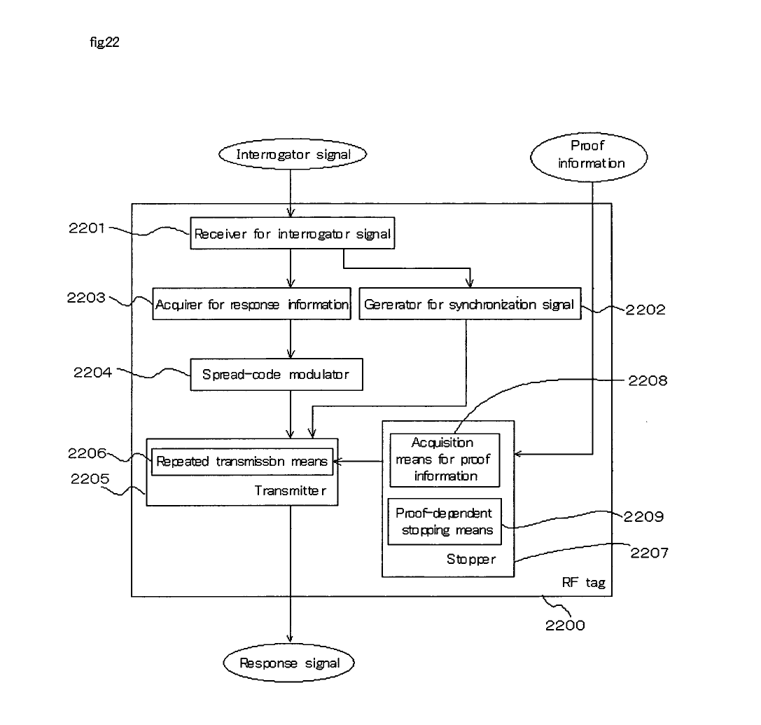

As shown in FIG. 22, the RF tag 2200 of the sixth embodiment comprises the receiver for interrogator signal 2201, the generator for synchronization signal 2202, the acquirer for response information 2203, the spread-code modulator 2204, the transmitter 2205, and the stopper 2207. Moreover, the transmitter comprises the repeated transmission means 2206. Furthermore, the stopper comprises the acquisition means for proof information 2208, and the proof-dependent stopping means 2209.

Hereinbelow, the constituent features of the RF tag of the sixth embodiment will be described. The receiver for interrogator signal, the generator for synchronization signal, the acquirer for response information, the spread-code modulator, and the transmitter are the same as those in any one of the third to fifth embodiments, so that the descriptions thereof will be omitted.

The stopper comprises the acquisition means for proof information, which acquires proof information corresponding to the response signal transmitted from the transmitter, and the proof-dependent stopping means, which stops transmission only when the proof information acquired by the acquisition means for proof information fulfils a predetermined condition. Here, the ‘proof information’ corresponds to information for certificating that the response signal transmitted based on the interrogator signal from the interrogator has been received by the interrogator, and to the content itself transmitted from the RF tag or the digest of it. Examples of the proof information include the identification number of an interrogator, which has issued the proof, RFID identification information of the destination of the issuance, issuance date, response information, digest of the response information, and distinction between normal reception and abnormal reception. Further, an example of the ‘predetermined condition’ includes the condition that the identification number and the RFID information of the interrogator are identical with the information of the RF tag of itself, and the reception is carried out normally etc. For example, the proof information from the interrogator is directly received by the acquisition means for proof information of the stopper. Moreover, the proof information from the interrogator may be received by the receiver for stop instruction from the interrogator. In this case, the receiver for stop instruction acquires the proof information in command format as well as the stop instruction, and the acquisition means for proof information of the stopper takes over the processing.

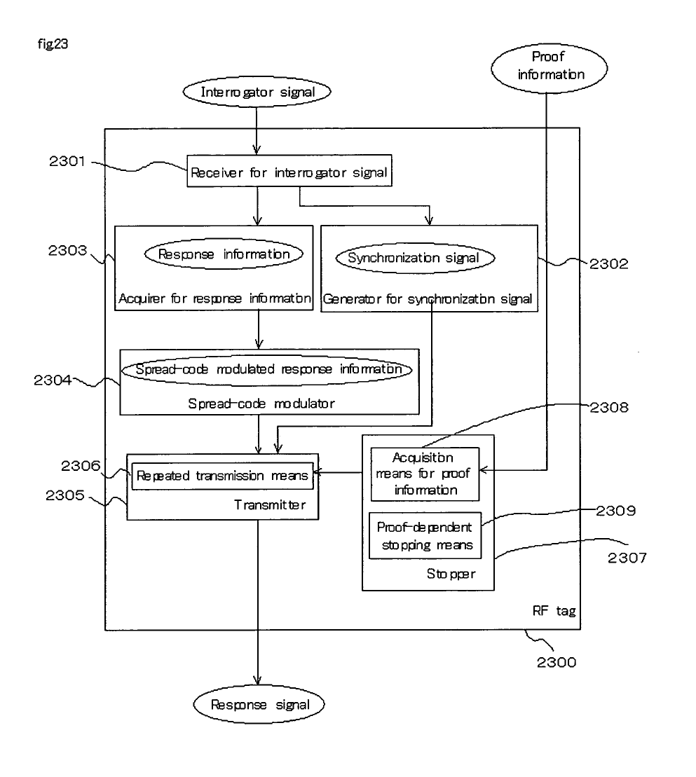

FIG. 23 is a diagram explaining the flow of the information and the signal of the RF tag 2300 of the sixth embodiment. The RF tag of the sixth embodiment comprises the receiver for interrogator signal 2301, the generator for synchronization signal 2302, the acquirer for response information 2303, the spread-code modulator 2304, the transmitter 2305, and the stopper 2307. Further, the transmitter comprises the repeated transmission means 2306. Furthermore, the stopper comprises the acquisition means for proof information 2308, and the proof-dependent stopping means 2309. The receiver for interrogator signal receives the interrogator signal from the interrogator. The acquirer for response information acquires the response information. The generator for synchronization signal generates the synchronization signal. The spread-code modulator generates the spread-code modulated response information. The acquisition means for proof information acquires the proof information from the interrogator.

Hereinbelow, the processing flow of the sixth embodiment will be described.

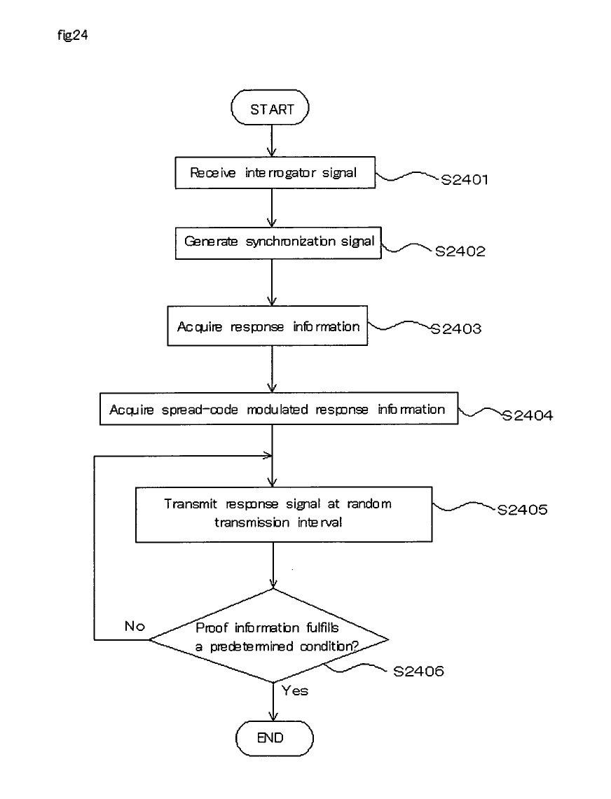

FIG. 24 is a diagram explaining the processing flow of the sixth embodiment.

The receiver for interrogator signal receives a signal from an interrogator (step S2401). The generator for synchronization signal generates a synchronization signal based on the interrogator signal received by the receiver for interrogator signal (step S2402). The acquirer for response information acquires response information based on the interrogator signal received by the receiver for interrogator signal (step S2403). The spread-code modulator acquires spread-code modulated response information by spread-code modulating the response information acquired by the acquirer for response information (step S2404). The transmitter transmits a response signal acquired by the spread-code modulator based on the synchronization signal generated by the generator for synchronization signal at random transmission interval (step S2405). Subsequently, the acquisition means for proof information acquires the proof information from the interrogator, and determines whether the proof information fulfils a predetermined condition (step S2406). If the proof information does not fulfil the predetermined condition, the processing is back to step S2405, and transmission is repeated. If the proof information does not fulfil the predetermined condition, the transmitter receives the stop instruction from the proof-dependent stopping means, and the processing is terminated.

According to the RF tag of the sixth embodiment, the stopper can stop the transmission only when the proof information fulfils the predetermined condition, so that it becomes possible to stop the transmission of the response signal of the RF tag, of which processing has been completed.

### Seventh Embodiment

Hereinbelow, the concept of the seventh embodiment will be described.

The invention of the seventh embodiment relates to the RF tag according to any one of the first to sixth embodiments, wherein the random transmission interval is a random transmission interval based on a predetermined rule.

Hereinbelow, the constituent features of the seventh embodiment will be indicated.

Although not indicated in a drawing, similar to any one of the RF tag according to the first to sixth embodiments, the RF tag of the seventh embodiment comprises the receiver for interrogator signal, the generator for synchronization signal, the acquirer for response information, the spread-code modulator, the transmitter, and the stopper.

Hereinbelow, the constituent features of the RF tag of the seventh embodiment will be described. The receiver for interrogator signal, the generator for synchronization signal, the acquirer for response information, the spread-code modulator, and the stopper are the same as those in any one of the first to sixth embodiment, so that the descriptions thereof will be omitted.

The transmitter carries out transmission at random transmission interval based on the synchronization signal generated by the generator for synchronization signal. The random transmission interval is transmission interval based on a predetermined rule. Here, an example of the ‘predetermined rule’ includes a rule of corresponding relationship between a transmission interval and a response signal. The transmission interval is determined by the random number generator etc. The rule of corresponding relationship between a transmission interval and a response signal may be preliminarily stored in a memory, or may be generated by a random number generator upon transmission of response signal.

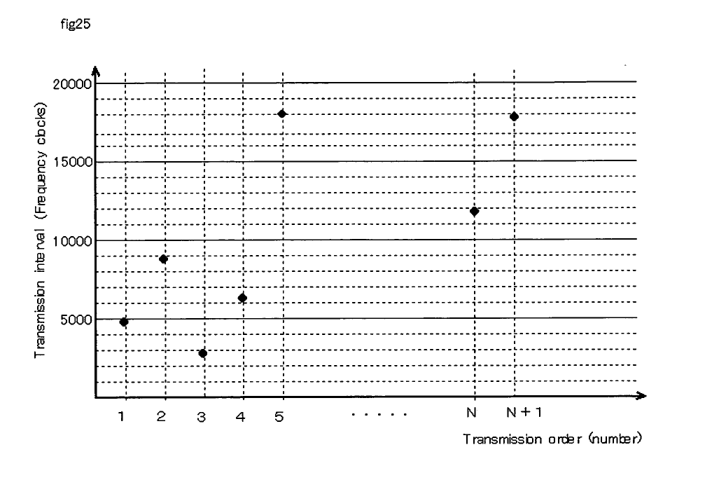

FIG. 25 is a diagram explaining correspondence between a transmission interval and a response signal. The vertical axis indicates transmission interval (converted to clock frequency), and the horizontal axis indicates transmission order of response signal (number). The transmission interval in this drawing is between the end of the last transmission of response signal and the start of this transmission of response signal.

The processing flow of the seventh embodiment is the same as that of any one of the first to sixth embodiments, so that the description thereof will be omitted.

According to the RF tag of the seventh embodiment, it becomes possible to improve accuracy in reading response signal by an interrogator.

### Eighth Embodiment

Hereinbelow, the concept of the eighth embodiment will be described.

The invention of the eighth embodiment relates to the RF tag according to the seventh embodiment, wherein, in the predetermined rule, an average value of transmission interval is a certain period of time.

Hereinbelow, the constituent features of the eighth embodiment will be indicated.

Although not indicated in a drawing, similar to any one of the RF tags according to the seventh embodiment, the RF tag of the eighth embodiment comprises the receiver for interrogator signal, the generator for synchronization signal, the acquirer for response information, the spread-code modulator, the transmitter, and the stopper.

Hereinbelow, the constituent features of the RF tag of the eighth embodiment will be described. The receiver for interrogator signal, the generator for synchronization signal, the acquirer for response information, the spread-code modulator, and the stopper are the same as those of the seventh embodiment, so that the descriptions thereof will be omitted.

The transmitter carries out transmission at random transmission interval based on the synchronization signal generated by the generator for synchronization signal. The random transmission interval is transmission interval based on a predetermined rule. Here, an example of the ‘predetermined rule’ includes a rule for setting the average value of transmission interval to exist in a certain range of time. The transmission interval is determined, so that the average value of transmission interval exists in a certain range of time by random number generator etc.

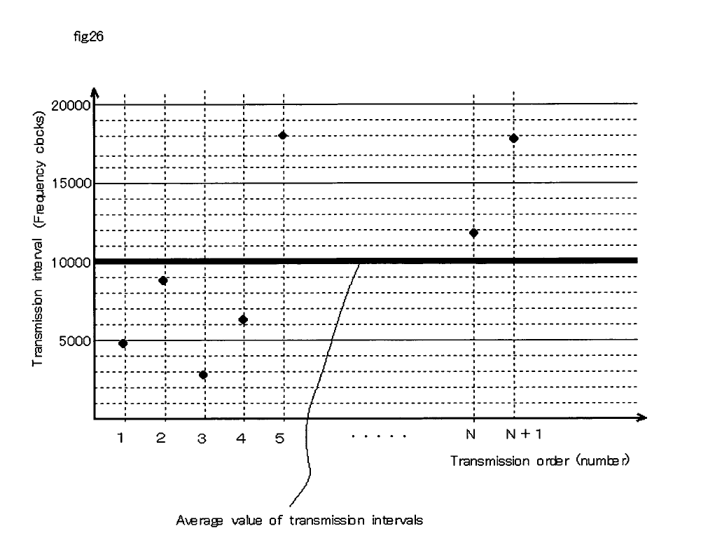

FIG. 26 is a diagram explaining correspondence between a transmission interval and a response signal. The vertical axis indicates transmission interval (converted to clock frequency), and the horizontal axis indicates transmission order of response signal (number). The transmission interval in this drawing is between the end of the last transmission of response signal and the start of this transmission of response signal. The heavy-line of FIG. 26 indicates the average value of transmission interval, and, for example, is set to 10,000 clocks. The rule of corresponding relationship between a transmission interval and a response signal may be preliminarily stored in a memory, or may be generated by a random number generator upon transmission of response signal.

The processing flow of the eighth embodiment is the same as that of the seventh embodiment, so that the description thereof will be omitted.

According to the RF tag of the eighth embodiment, it becomes possible to improve accuracy in reading response signal by an interrogator.

### Ninth Embodiment

Hereinbelow, the concept of the ninth embodiment will be described.

The invention of the ninth embodiment relates to the RF tag according to any one of the first to eighth embodiments, comprising the storage for RFID information, which stores RFID information, which is information for unique identification of itself, wherein the response signal acquired by the acquirer for response information includes the RFID information acquired from the storage for RFID information.

Hereinbelow, the constituent features of the ninth embodiment will be indicated.

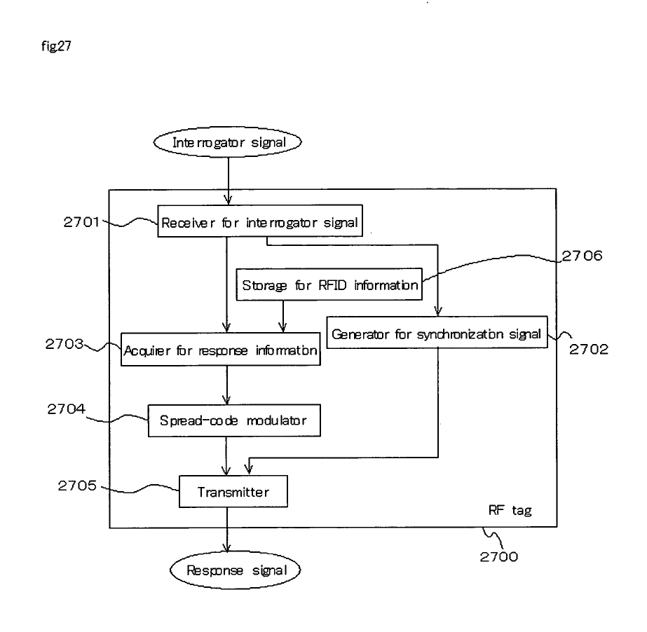

As shown in FIG. 27, the RF tag 2700 of the ninth embodiment comprises the receiver for interrogator signal 2701, the generator for synchronization signal 2702, the acquirer for response information 2703, the spread-code modulator 2704, the transmitter 2705, and the storage for RFID information 2706.

Hereinbelow, the constituent features of the RF tag of the ninth embodiment will be described. The receiver for interrogator signal, the generator for synchronization signal, the acquirer for response information, the spread-code modulator, and the transmitter are the same as those of any one of the first to eighth embodiments, so that the descriptions thereof will be omitted.

The storage for RFID information stores RFID information, which is information for unique identification of itself. Here, examples of the ‘RFID information’ include an address, which is uniquely possessed by respective RF tags, an address, which is common in a group of RF tag, and a wild address, which is common in all tags. The wild address can be used for the case that an interrogator transmits identical information command (e.g. system reset, stop instruction, or releasing stop instruction) to all RF tags.

The response information acquired by the acquirer for response information includes the RFID information acquired from the storage for RFID information.

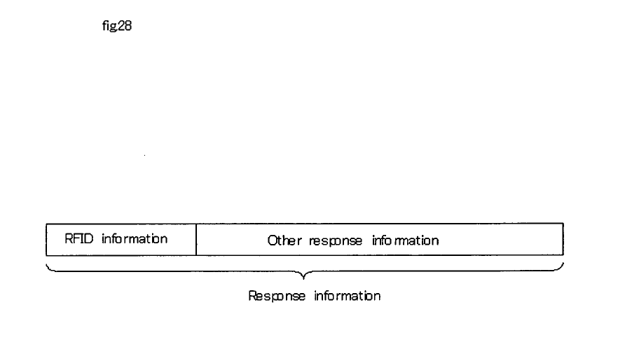

FIG. 28 is a diagram explaining the configuration of response information. The response information comprises the RFID information and the other response information.

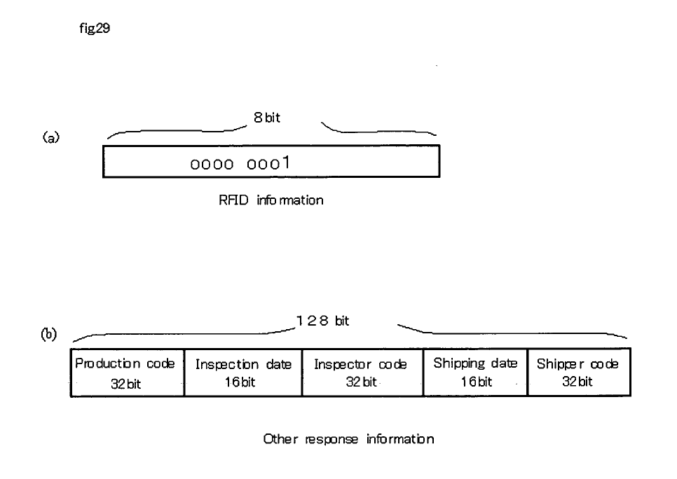

FIG. 29 is a diagram exemplifying the RFID information and the other response information. FIG. 29(a) shows the RFID information, for example, which is indicated in 6 bit as ‘00000001’. FIG. 29(b) shows the other response information, for example, which consists of 32-bit production code, 16-bit inspection date, 32-bit inspector code, 16-bit shipping date, and 32-bit shipper code, making a total of 128-bit.

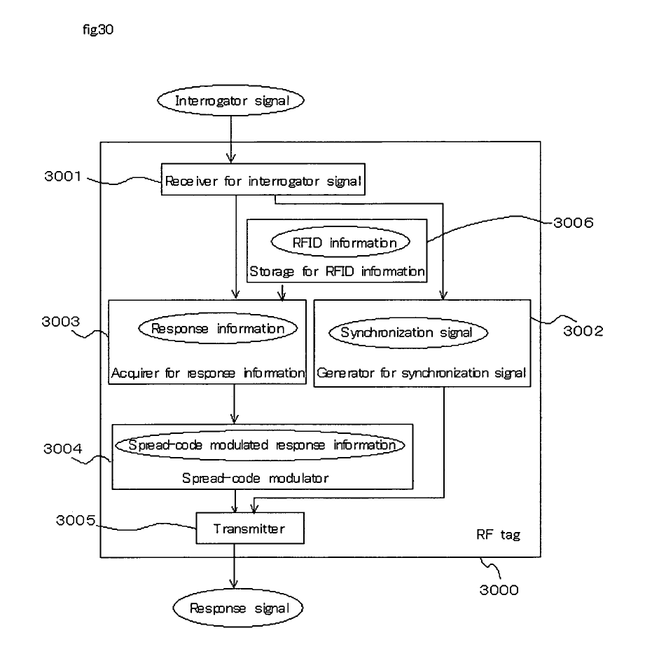

FIG. 30 is a diagram explaining flow of the information and the signal of the RF tag 3000 of the ninth embodiment. The RF tag of the ninth embodiment comprises the receiver for interrogator signal 3001, the generator for synchronization signal 3002, the acquirer for response information 3003, the spread-code modulator 3004, the transmitter 3005, and the storage for RFID information 3006. The receiver for interrogator signal receives the interrogator signal from the interrogator. The acquirer for response information acquires the response information. The generator for synchronization signal generates the synchronization signal. The spread-code modulator generates the spread-code modulated response information. The storage for RFID information stores the RFID information.

Hereinbelow, the processing flow of the ninth embodiment will be described.

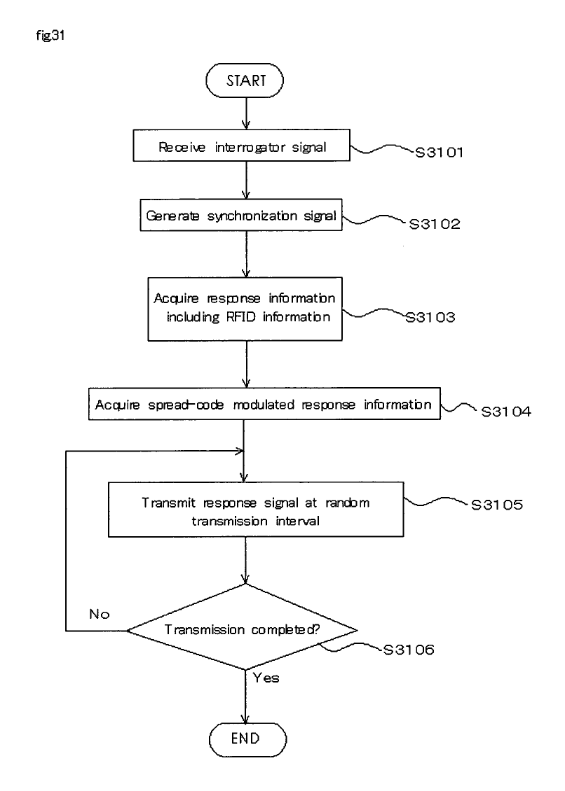

FIG. 31 is a diagram explaining the processing flow of the ninth embodiment.

The receiver for interrogator signal receives a signal from an interrogator (step S3101). The generator for synchronization signal generates a synchronization signal based on the interrogator signal received by the receiver for interrogator signal (step S3102). The acquirer for response information acquires response information (including the RFID information acquired from the storage for RFID information) based on the interrogator signal received by the receiver for interrogator signal (step S3103). The spread-code modulator acquires spread-code modulated response information by spread-code modulating the response information acquired by the acquirer for response information (step S3104). The transmitter transmits a response signal acquired by the spread-code modulator based on the synchronization signal generated by the generator for synchronization signal at random transmission interval (step S3105). Subsequently, it is determined whether the transmission is completed. (step S3106). If the transmission is not completed, the processing is back to the step S3105, and transmission is repeated. If the transmission is completed, the processing is terminated.

According to the RF tag of the ninth embodiment, the response information acquired by the acquirer for response information includes the RFID information acquired from the storage for RFID information, so that it becomes possible to transmit the RFID information of itself to the interrogator.

### Tenth Embodiment

Hereinbelow, the concept of the tenth embodiment will be described.

The invention of the tenth embodiment relates to the RF tag according to any one of the first to ninth embodiments, comprising the storage for identification code, which stores an identification code and a generator for header, which generates a header including the identification code stored in the storage for identification code.

Hereinbelow, the constituent features of the tenth embodiment will be indicated.

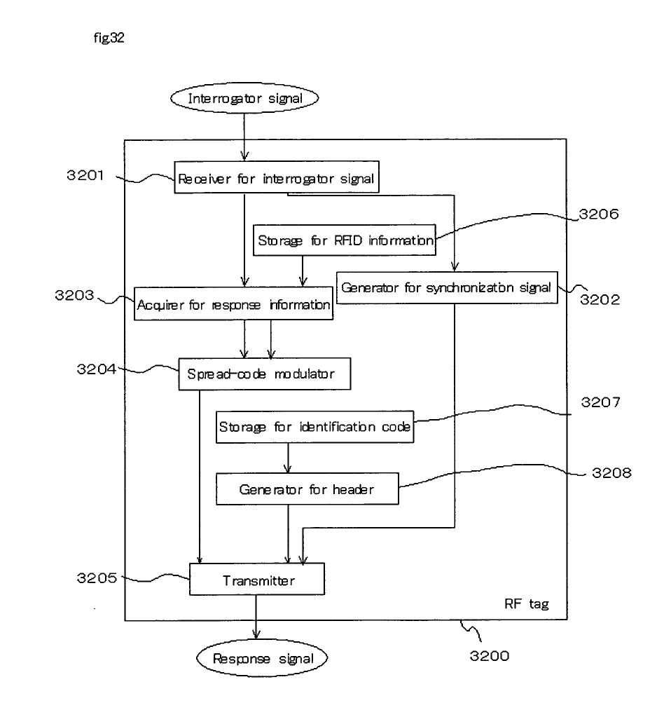

As shown in FIG. 32, the RF tag 3200 of the tenth embodiment comprises the receiver for interrogator signal 3201, the generator for synchronization signal 3202, the acquirer for response information 3203, the spread-code modulator 3204, the transmitter 3205, the storage for RFID information 3206, the storage for identification code 3207, and the generator for header 3208.

Hereinbelow, the constituent features of the RF tag of the tenth embodiment will be described. The receiver for interrogator signal, the generator for synchronization signal, the acquirer for response information, the spread-code modulator, the transmitter and the storage for RFID information are the same as those of any one of the first to ninth embodiments, so that the descriptions thereof will be omitted.

The storage for RFID information stores RFID information, which is information for unique identification of itself.

The storage for identification code stores the identification code. Here, the ‘identification code’ corresponds to a code used for determining signal intensity of a RF tag by an interrogator. As to the code, a common code is given to respective groups of RF tags.

The generator for header generates a header including the identification code stored in the storage for identification code. Examples of the header may include synchronization code, start code, end code, code indicating data length, and preamble code. The header configures the response signal in conjunction with the data area including the spread-code modulated response signal, and is transmitted by the transmitter as a response signal. Note that, although it has been described that the information stored in the storage for identification code and the identification code included in the header are identical, the identity may include not only the case that they are completely identical, but also the case that they become not non-identical through a predetermined conversion. For example, in cases where the code stored in the storage for identification code is 3 digit number, and the 3 digit number is converted to 100 digit number by a predetermined function and is included in the header; they are not identical formally, but may be regarded as identical in the present embodiment.

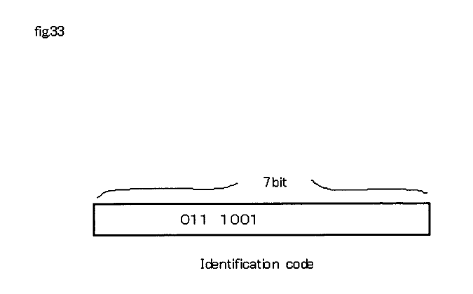

FIG. 33 is a diagram exemplifying an identification code. An example of the identification code includes binary data of 7-bit ‘01110001’.

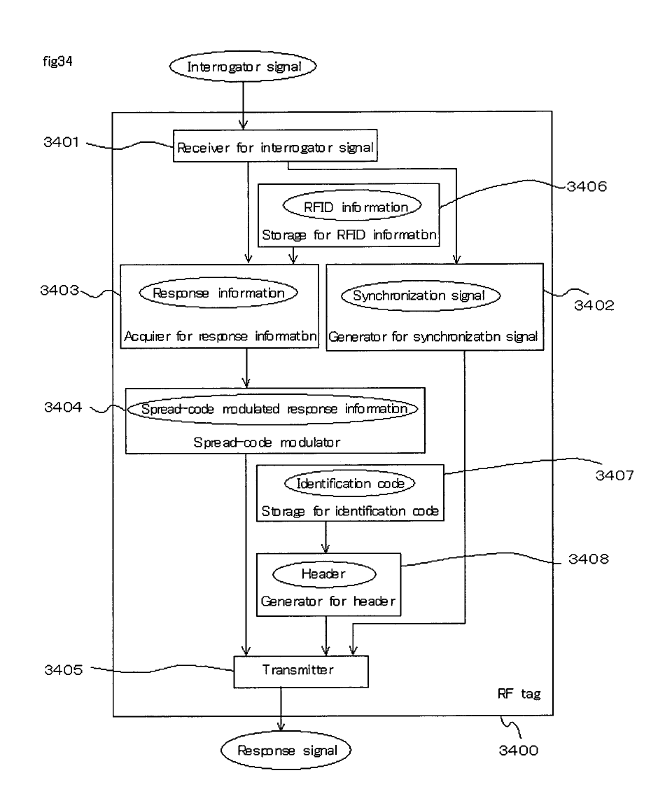

FIG. 34 is a diagram explaining flow of the information and the signal of the RF tag 3400 of the tenth embodiment. The RF tag of the tenth embodiment comprises the receiver for interrogator signal 3401, the generator for synchronization signal 3402, the acquirer for response information 3403, the spread-code modulator 3404, the transmitter 3405, the storage for RFID information 3406, the storage for identification code 3407, and the generator for header 3408. The receiver for interrogator signal receives the interrogator signal from the interrogator. The acquirer for response information acquires the response information. The generator for synchronization signal generates the synchronization signal. The spread-code modulator generates the spread-code modulated response information. The storage for RFID information stores the RFID information. The storage for identification code stores the identification code.

Hereinbelow, the processing flow of the tenth embodiment will be described.

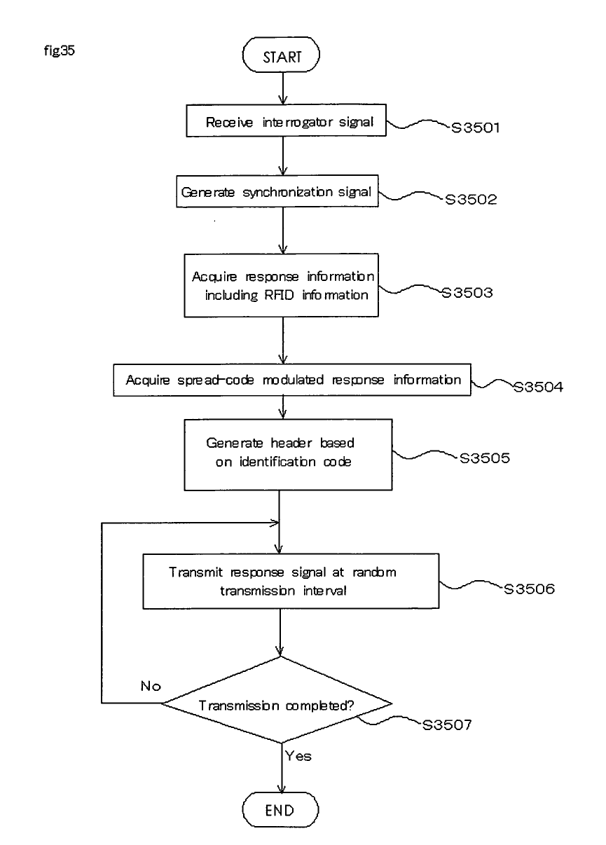

FIG. 35 is a diagram explaining the processing flow of the tenth embodiment.

The receiver for interrogator signal receives a signal from an interrogator (step S3501). The generator for synchronization signal generates a synchronization signal based on the interrogator signal received by the receiver for interrogator signal (step S3502). The acquirer for response information acquires response information (including the RFID information acquired from the storage for RFID information) based on the interrogator signal received by the receiver for interrogator signal (step S3503). The spread-code modulator acquires spread-code modulated response information by spread-code modulating the response information acquired by the acquirer for response information (step S3504). The generator for header generates the header based on the identification code (step S3505). The transmitter transmits a response signal (including the header generated by the generator for header) acquired by the spread-code modulator based on the synchronization signal generated by the generator for synchronization signal at random transmission interval (step S3506). Subsequently, it is determined whether the transmission has been completed (step S3507). If the transmission has not been completed, the processing goes back to the step S3506, and transmission is repeated. If the transmission is complete, the processing is terminated.

According to the RF tag of the tenth embodiment, the response information transmitted by the transmitter includes attribute of RF tag, so that it becomes possible to transmit the attribute of RF tag to the interrogator.

### Eleventh Embodiment

Hereinbelow, the concept of the eleventh embodiment will be described.

The invention of the eleventh embodiment relates to the RF tag according to the tenth embodiment, wherein a signal configuring the header is a non-interferential signal upon decoding of the spread-code by the interrogator even if it is overlapped with a signal configuring a data area of other RF tag having the same configuration as that of itself.

Hereinbelow, the constituent features of the eleventh embodiment will be indicated.

Although not indicated in a drawing, similar to the tenth embodiment, the RF tag of the eleventh embodiment comprises the receiver for interrogator signal, the generator for synchronization signal, the acquirer for response information, the spread-code modulator, the transmitter, the storage for RFID information, the storage for identification code, and the generator for header.

Hereinbelow, the constituent features of the RF tag of the eleventh embodiment will be described. The receiver for interrogator signal, the generator for synchronization signal, the acquirer for response information, the spread-code modulator, the storage for RFID information, and the storage for identification code are the same as those of the tenth embodiment, so that the descriptions thereof will be omitted.

The generator for header generates based on the identification code stored by the storage for identification code. The signal configuring the header is a non-interferential signal upon decoding of the spread-code by the interrogator even if it is overlapped with a signal configuring a data area of other RF tag having the same configuration as that of itself. Here, the term ‘non-interferential’ means that the header of itself is distinguishable from the data area of the other RF tag upon decoding of the spread-code by the interrogator even if it is overlapped with the signal configuring a data area of the other RF tag having the same configuration as that of itself.

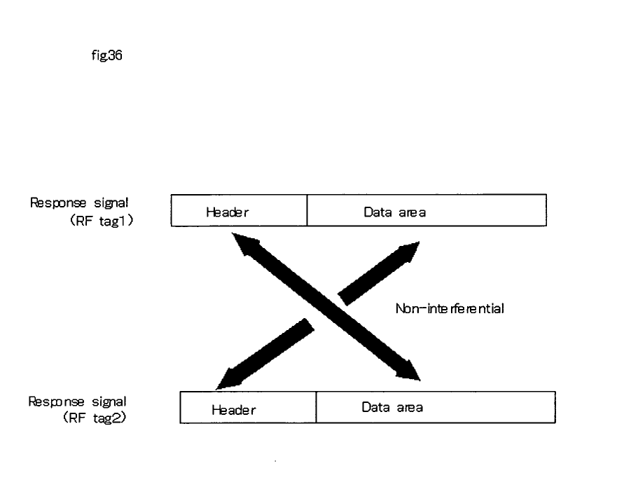

FIG. 36 is a schematic diagram explaining that the header and the data area of the RF tag 1 and those of the RF tag 2 are non-interferential with each other. For example, the header of the RF tag 1 and the data area of the RF tag 2, and the data area of The RF tag 1 and the header of the RF tag 2 are non-interferential with each other, respectively.

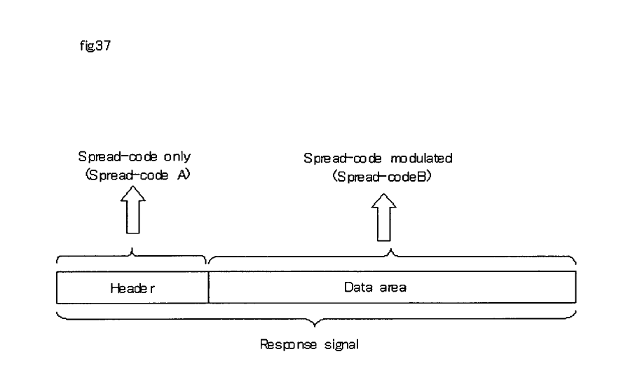

FIG. 37 is a diagram exemplifying a modulation method of the header and the data area, which are non-interferential and configure the response signal. FIG. 37 shows a pattern that the header indicates only the spread-code A, and the data area is spread-code modulated (the spread-code B). In this case, if the spread-code A and the spread-code B are different spread-code, it is useful. For example, in cases where the spread-code modulation is carried out by using an exclusive disjunction between the data and the spread-code, the spread-code itself is a result of spread-code modulation on the data, which is consisted of only 0, by spread-code. Therefore, the data configuring the spread-code A, which is the spread-code itself, is also a result of spread-code modulation, so that it is non-interferential with the data, which is spread-code modulated by the spread-code B, different from the spread-code A. Consequently, if the header is the spread-code A and the data spread-code modulated by the different spread-code from that is stored in the data area, the header and the data area are non-interferential with each other.

Although it is described that the spread-code A and the spread-code B are different spread-code, it is not necessary that the spread-code A is used for spread-code modulation of any data. Therefore, it is enough that the value included in the header is different from the value of the spread-code used for spread-code modulation of information of the data area.

According to the above configuration, even if the interrogator receives a plurality of RF tags, it becomes possible to use one set (for header and for data area) of spread-code, so that the header and the data area are non-interferential, thereby decoding effectively.

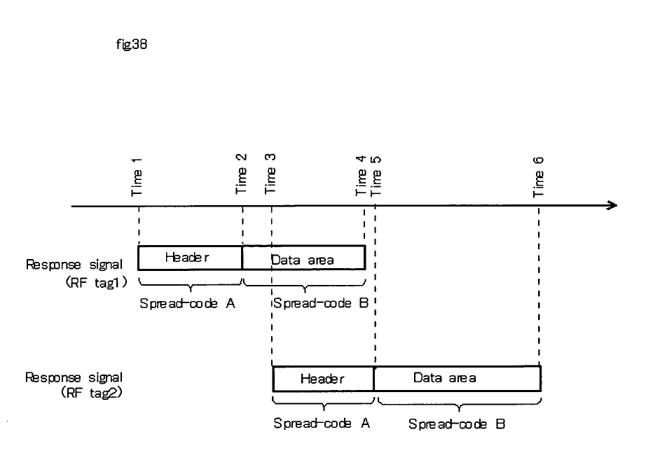

FIGS. 38 to 40 are diagrams exemplifying that it is possible to decode with non-interference between the header and the data area in the case of FIG. 37(b), in which the header and the data area are both spread-code modulated.

FIG. 38 shows the case that transmission of the header (RF tag 1) is started at time 1, transmission of the data area (RF tag 1) is started at time 2, transmission of the header (RF tag 2) is started at time 3, transmission of the data area (RF tag 1) is completed at time 4, transmission of the data area (RF tag 2) is started at time 5, and transmission of the data area (RF tag 2) is completed at time 6. In this case, the header of RF tag 1 and of RF tag 2 are both spread-code modulated by spread-code A, and the data area of RF tag 1 and of RF tag 2 are both spread-code modulated by spread-code B. In this case, the response signal of RF tag 1 and the response signal of RF tag 2 are overlapped with each other during the time between time 3 and time 4, and the data area of RF tag 1 and the header of RF tag 2 are overlapped with each other.

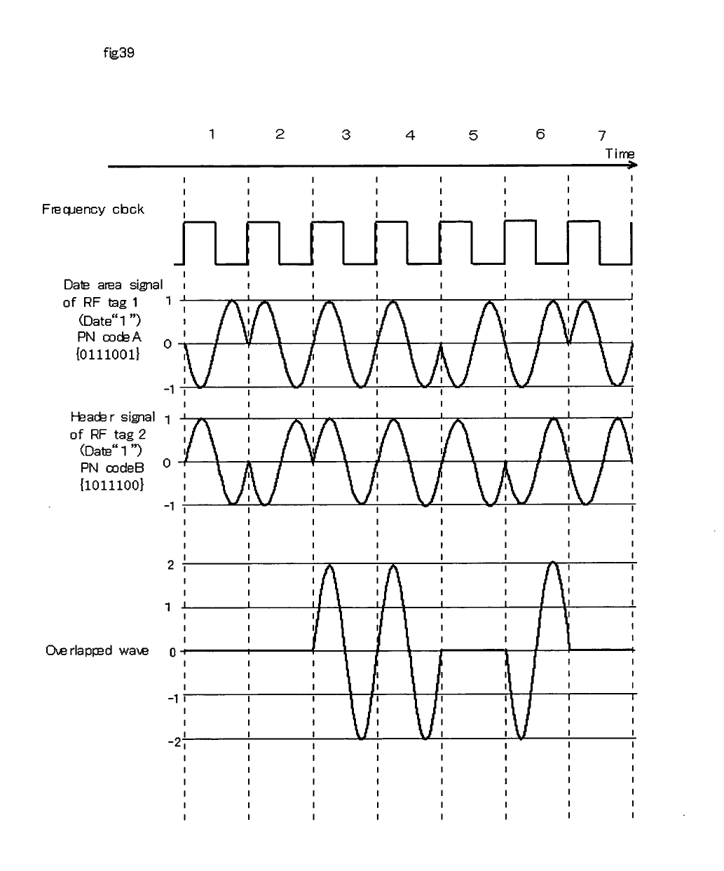

FIG. 39 is a diagram showing a wave pattern when data ‘1’ of the data area of RF tag 1 and data ‘1’ of the header of RF tag 2 are overlapped and transmitted. Here, for the header, the PN code A ‘0111001’ is used, and for the data area, the PN code B ‘1110010’ is used.

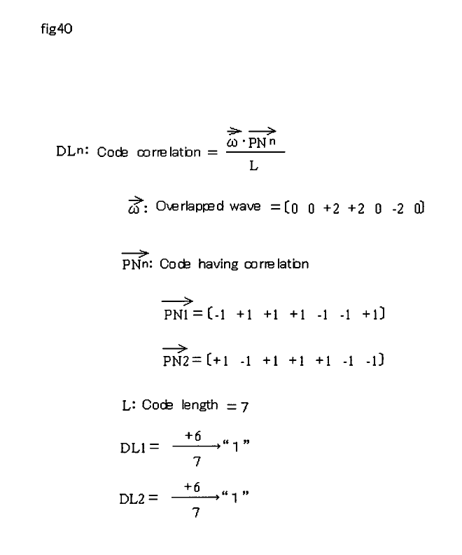

FIG. 40 shows a computational expression for decoding data ‘1’ of the data area of RF tag 1 and data ‘1’ of the header of RF tag 2 by the interrogator from the overlapped wave generated in FIG. 39. In both cases, code correlation are DL1=+6/7 and DL2=+6/7, and data ‘1’ is decoded. Here, if the ‘code correlation’ is ‘+’, the data is ‘1’, and if ‘code correlation’ is ‘−’, the data is ‘0’.

The processing flow of the eleventh embodiment is the same as that of the tenth embodiment, so that the description thereof will be omitted.

According to the RF tag of the eleventh embodiment, the signal configuring the header is a non-interferential signal upon decoding of the spread-code by the interrogator even if it is overlapped with the signal configuring the data area of the other RF tag having the same configuration as that of itself, so that the interrogator can decode the response signal.

### Twelfth Embodiment

Hereinbelow, the concept of the twelfth embodiment will be described.

The invention of the twelfth embodiment relates to the RF tag according to the tenth embodiment, wherein the signal configuring the data area is a non-interferential signal upon decoding of the spread-code by the interrogator even if it is overlapped with a signal configuring a header of other RF tag having the same configuration as that of itself.

Hereinbelow, the constituent features of the twelfth embodiment will be indicated.

Although not indicated in a drawing, similar to the tenth embodiment, the RF tag of the twelfth embodiment comprises the receiver for interrogator signal, the generator for synchronization signal, the acquirer for response information, the spread-code modulator, the transmitter, the storage for RFID information, the storage for identification code, and the generator for header.

The constituent features of the RF tag of the twelfth embodiment can be regarded the same as those of the eleventh embodiment, so that the descriptions thereof will be omitted.

The processing flow of the twelfth embodiment is the same as that of the tenth embodiment, so that the description thereof will be omitted.

According to the RF tag of the twelfth embodiment, the signal configuring the data area is a non-interferential signal upon decoding of the spread-code by the interrogator even if it is overlapped with a signal configuring a header of other RF tag having the same configuration as that of itself, so that the interrogator can decode the response signal.

### Thirteenth Embodiment

Hereinbelow, the concept of the thirteenth embodiment will be described.

The invention of the thirteenth embodiment relates to an RF tag set, comprising an aggregation of a plurality of the RF tag according to any one of the first to ninth embodiments.

The constituent features of the RF tag set of the thirteenth embodiment are the same as those of any one of the first to ninth embodiments, so that the description thereof will be omitted.

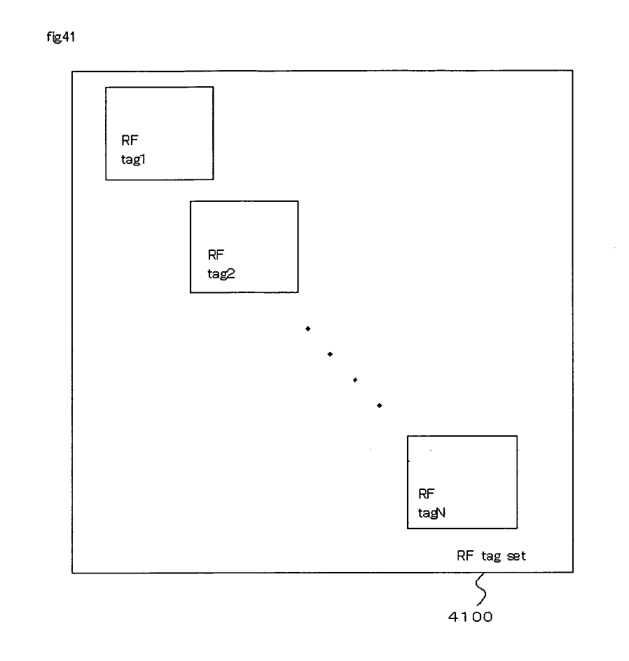

FIG. 41 shows the RF tag set 4100 of the thirteenth embodiment. The RF tag set is configured with the RF tag 1, the RF tag 2, . . . , the RF tag N. Further, an identical spread-code is used as a spread-code of respective RF tags.

Hereinbelow, the RF tag of the thirteenth embodiment will be described. When the response signals of a plurality of RF tag sets are transmitted at completely the same transmission interval, the response signals of respective RF tags are spread-code modulated by an identical spread-code, so that it is impossible to decode them. However, as described in the first embodiment, respective RF tags transmit the response signal at random transmission interval, so that potential for collision between the transmissions of the response signals of respective RF tags is low.

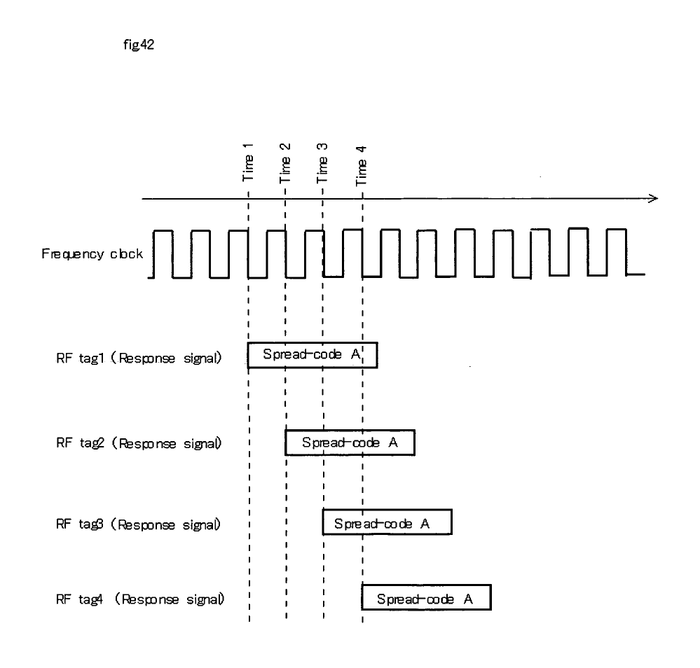

FIG. 42 shows that the spread-code modulated response information of the RF tag 1, the RF tag 2, the RF tag 3, and the RF tag 4, which are modulated by the spread-code A, are respectively transmitted with shift of 1 clock pulse at time 1, time 2, time 3, and time 4.

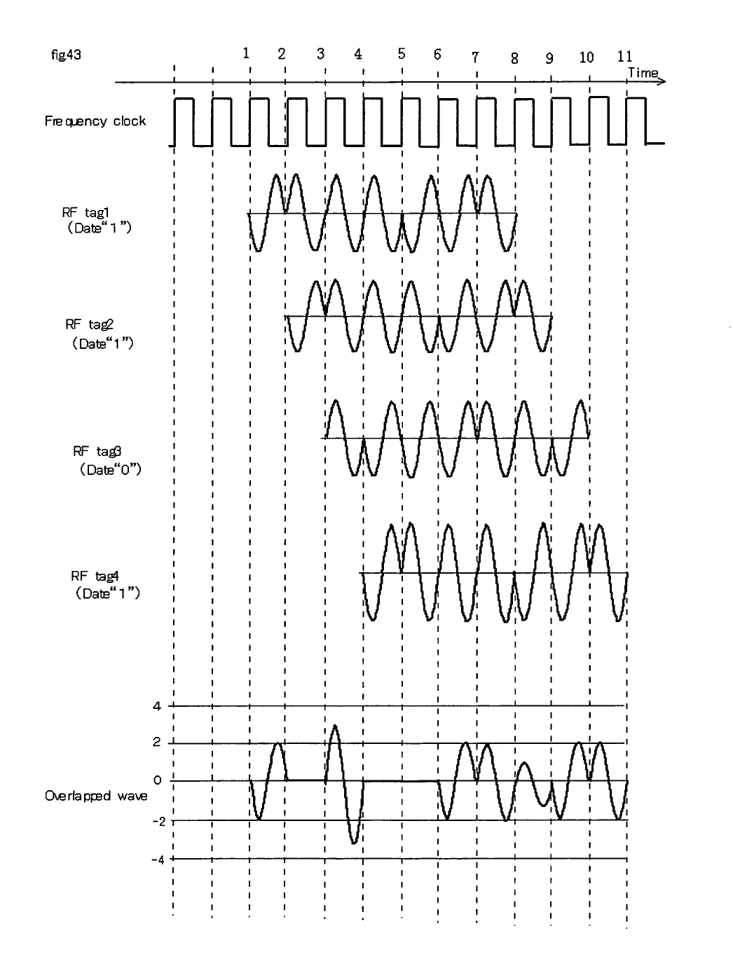

FIG. 43 shows that the data ‘1’, ‘1’, ‘0’, and ‘1’ of respective response signals of the RF tag 1, the RF tag 2, the RF tag 3, and the RF tag 4 are spread-code modulated, thus generating an overlapping wave. By the shift of the transmission interval of the response signals of the RF tag 1, the RF tag 2, the RF tag 3, and the RF tag 4, the interrogator of the reception side can decode them as different spread-codes, ostensibly. Thus, it is possible to decode the data ‘1’, ‘1’, ‘0’, and ‘1’ of respective response signals of the RF tag 1, the RF tag 2, the RF tag 3, and the RF tag 4.

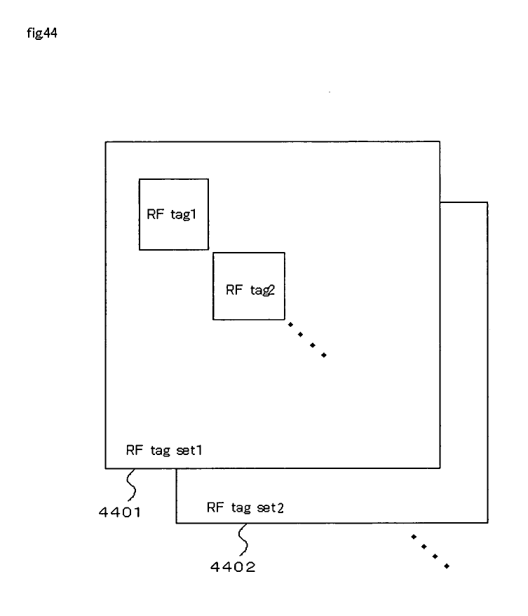

FIG. 44 shows an aggregation of a plurality of RF tag sets, consisted of the RF tag set 1 (4401), the RF tag set 2 (4402), and so on. The spread-codes used among respective RF tag sets are configured to be different, thereby enabling identification of RF tag set.

According to the RF tag set of the thirteenth embodiment, even if an identical spread-code is used among a plurality of RF tags, the interrogator can carry out decoding, it becomes possible to simplify the configuration of the decoder.

### Fourteenth Embodiment

Hereinbelow, the concept of the fourteenth embodiment will be described.

The invention of the fifteenth embodiment relates to an RF tag set, comprising an aggregation of a plurality of the RF tags according to any one of the tenth to twelfth embodiments.

The constituent features of the RF tag set of the fourteenth embodiment are the same as those of any one of the tenth to twelfth embodiments, so that the description thereof will be omitted.

Although not indicated in the drawing, the RF tag set of the fourteenth embodiment is configured with the RF tag 1, the RF tag 2, . . . , and the RF tag N.

In the RF tag set of the fourteenth embodiment, as with the spread-codes of respective RF tags, different spread-codes are used for header and data areas, or a spread-code is used only for the data area, and an identical spread-code is used among headers or data areas of respective RF tags. The other features except the above are the same as those of any one of the tenth to twelfth embodiments, so that the description thereof will be omitted.

According to the RF tag set of the fourteenth embodiment, even if an identical spread-code set (for header and for data area) is used among a plurality of RF tags, the interrogator can carry out decoding, it becomes possible to simplify the configuration of the decoder.

### Fifteenth Embodiment

Hereinbelow, the concept of the fifteenth embodiment will be described.

The invention of the fifteenth embodiment relates to an RF tag set according to the fourteenth embodiment, wherein the identification code of the header is common among the aggregation of a plurality of RF tags.

The constituent features of the RF tag set of the fifteenth embodiment are the same as those of the fourteenth embodiment, so that the description thereof will be omitted.

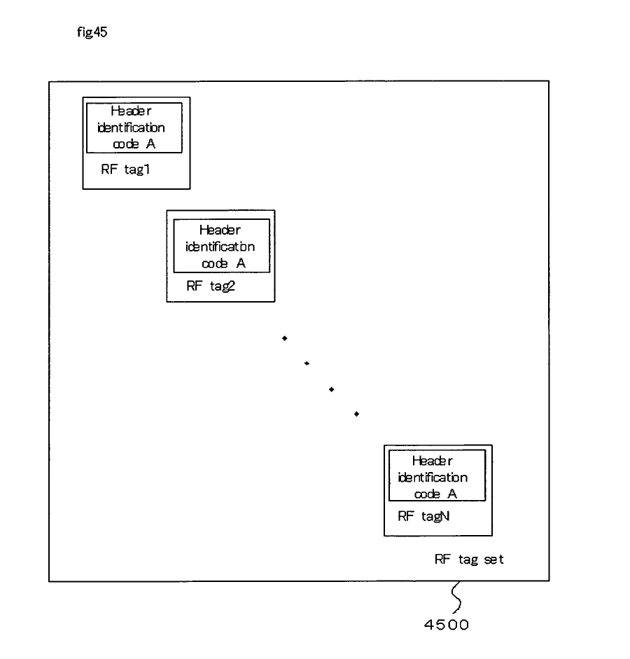

FIG. 45 shows the RF tag set 4500 of the fifteenth embodiment. The RF tag set is configured with the RF tag 1, the RF tag 2, . . . , and the RF tag N.

As to the RF tag set of the fifteenth embodiment, the identical identification code of the header is used among a plurality of RF tags, and the other features except the above are the same, so that the description thereof will be omitted. The advantage of having a common identification code of the header, which is used among a plurality of RF tags, is that the RF tag set can be used as the RF tag of the same group, and the configuration of the interrogator for decoding the header can be simplified.

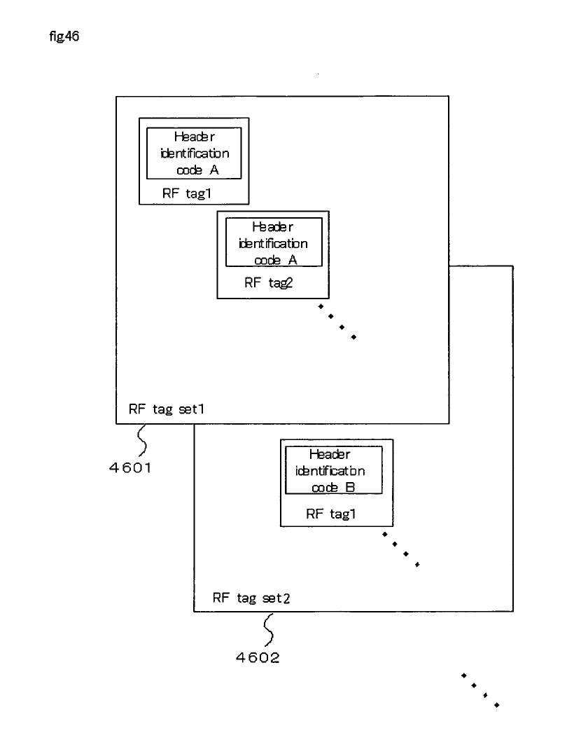

FIG. 46 shows an aggregation of a plurality of RF tag sets, consisted of the RF tag set 1 (4601), the RF tag set 2 (4602), and so on. The spread-codes used among respective RF tag sets are configured to be different, thereby enabling identification for respective groups of RF tag set.

According to the RF tag set of the fifteenth embodiment, the identification code of the header is common among a plurality of RF tags, so that the RF tag set can be used as the RF tag of the same group, and the configuration of the interrogator for decoding the header can be simplified.

### Sixteenth Embodiment

Hereinbelow, the concept of the sixteenth embodiment will be described.

The invention of the sixteenth embodiment relates to the RF tag set according to any one of the thirteenth to fifteenth embodiments, wherein the spread-codes used in the different tag are different from each other, in which the spread-code is used in the spread-code modulator of respective RF tags in the aggregation of a plurality of RF tags.

The constituent features of respective RF tag set of the sixteenth embodiment are the same as those of any one of the thirteenth to fifteenth embodiments, so that the description thereof will be omitted.

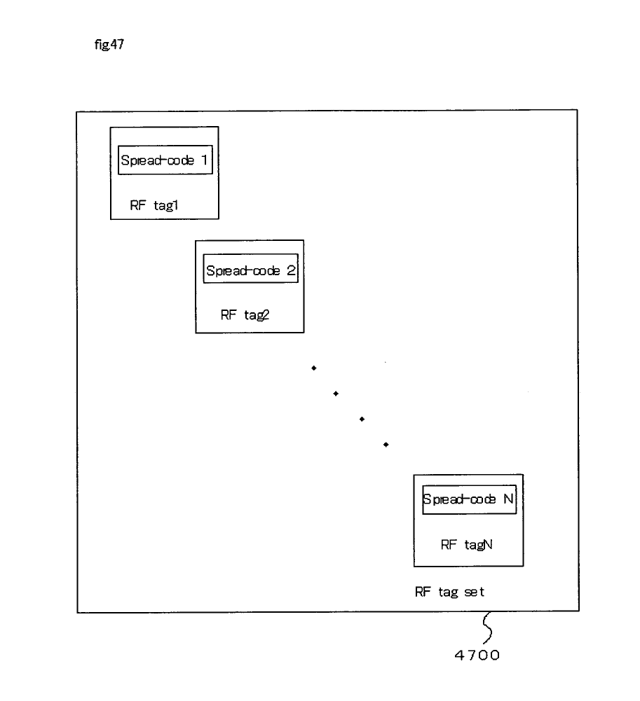

FIG. 47 shows the RF tag set 4700 of the sixteenth embodiment. The RF tag set is configured with the RF tag 1, the RF tag 2, . . . , and the RF tag N. Further, the spread-code 1, the spread-code 2, . . . , the spread-code N are used as the spread-code of each RF tag, respectively.

Hereinbelow, the RF tag of the sixteenth embodiment will be described. Even if the spread-code modulated response information of a plurality of RF tag sets are transmitted at the same transmission interval, the response signal of each RF tag is spread-code modulated by different spread-codes respectively, so that they can be decoded.

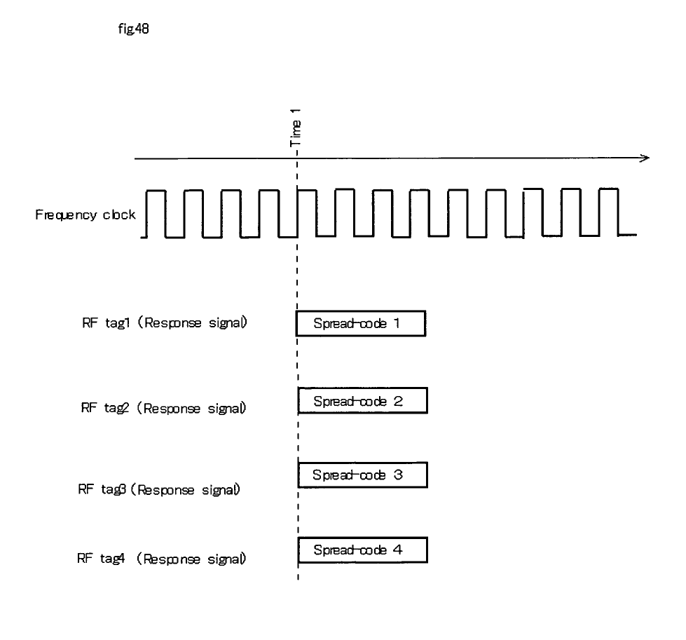

FIG. 48 shows that the response signals of the RF tag 1, the RF tag 2, the RF tag 3, and the RF tag 4 are respectively spread-codes modulated by the spread-code 1, the spread-code 2, the spread-code 3, and the spread-code 4, and are transmitted at the same transmission interval, the time 1.

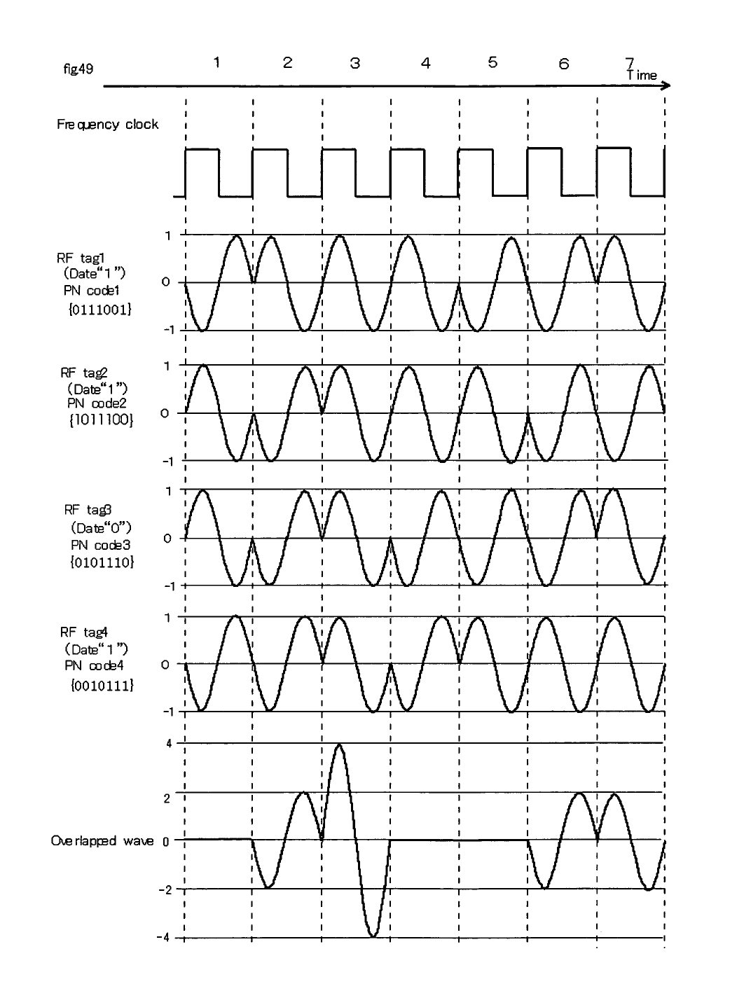

FIG. 49 shows that the data ‘1’, ‘1’, ‘0’, and ‘1’ of respective the response signals of the RF tag 1, the RF tag 2, the RF tag 3, and the RF tag 4 are respectively spread-codes modulated by the PN code ‘0111001’, ‘1011100’, ‘0101110’, and ‘0010111’, and the overlapped wave is generated.

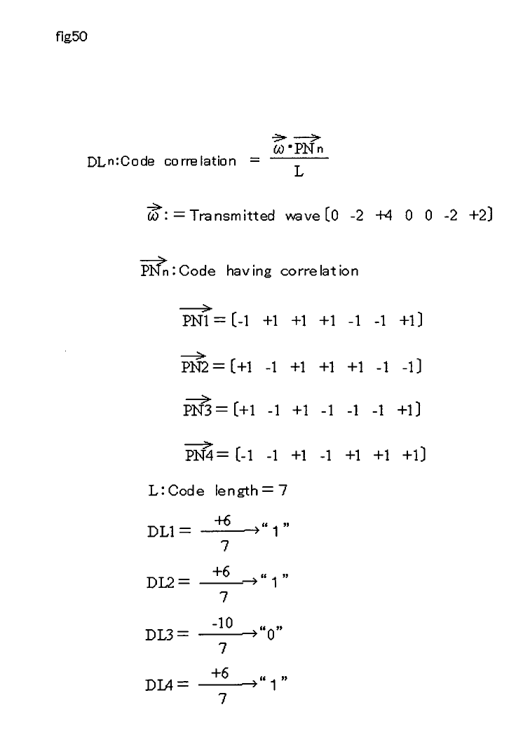

FIG. 50 shows a computational expression for decoding the data ‘1’, ‘1’, ‘0’, and ‘1’ of respective the response signals of the RF tag 1, the RF tag 2, the RF tag 3, and the RF tag 4 from the overlapped wave generated in FIG. 49.

The code correlation are DL1=+6/7, DL2=+6/7, DL3=−10, and DL4=+6/7, and the data ‘1’, ‘1’, ‘0’, and ‘1’ of respective the response signals of the RF tag 1, the RF tag 2, the RF tag 3, and the RF tag 4 are decoded. Here, if the ‘code correlation’ is ‘+’, the data is ‘1’, and if ‘code correlation’ is ‘−’, the data is ‘0’.

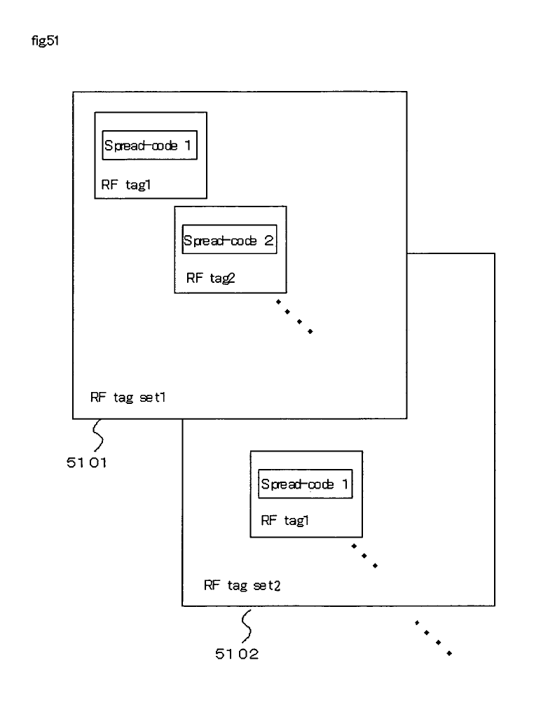

FIG. 51 shows an aggregation of a plurality of RF tag sets, consisted of the RF tag set 1 (5101), the RF tag set 2 (5102), and so on. The spread-codes used among respective RF tag sets are configured to be different, thereby enabling identification for respective groups of RF tag set.

According to the RF tag set of the sixteenth embodiment, the different spread-codes are used for a plurality of RF tag sets, so that even if the response signal is transmitted at the same transmission interval, the interrogator can carry out decoding.

### Seventeenth Embodiment

Hereinbelow, the concept of the seventeenth embodiment will be described.

The invention of the seventeenth embodiment relates to the RF tag set according to any one of the thirteenth to fifteenth embodiments, wherein the plurality of spread-codes are used, in which the spread-code is used in the spread-code modulator of respective RF tags in the aggregation of a plurality of RF tags.

The constituent features of respective RF tag set of the seventeenth embodiment are the same as those of any one of the thirteenth to fifteenth embodiments, so that the description thereof will be omitted.

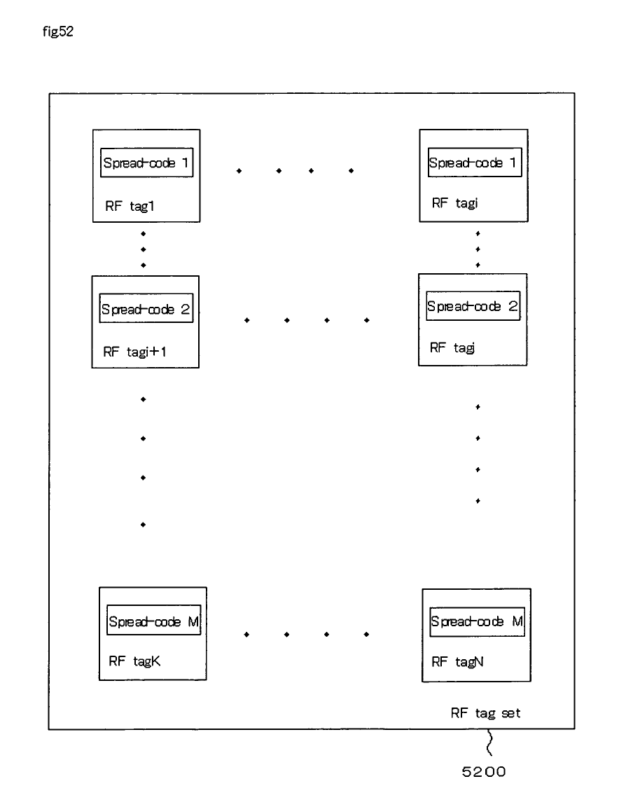

FIG. 52 shows the RF tag set 5200 of the seventeenth embodiment. The RF tag set is configured with the RF tag 1, . . . , the RF tag i, the RF tag i+1, . . . , the RF tag j, . . . , the RF tag K, . . . , and the RF N. Further, the spread-codes of respective RF tag is different from each spread-code group (the same spread-code is used in the same spread-code group). The spread-code 1 is used for the spread-code group of the RF tag 1, . . . , and the RF tag i; the spread-code 2 is used for the spread-code group of the RF tag i+1, . . . , and the RF tag j; and the spread-code M is used for the spread-code group of the RF tag K, . . . , and the RF N. The RF tag of the different spread-code group can be regarded the same as that of the sixteenth embodiment, and the RF tag of the same spread-code group can be regarded the same as that of any one of the thirteenth to fifteenth embodiments, so that the description thereof will be omitted.

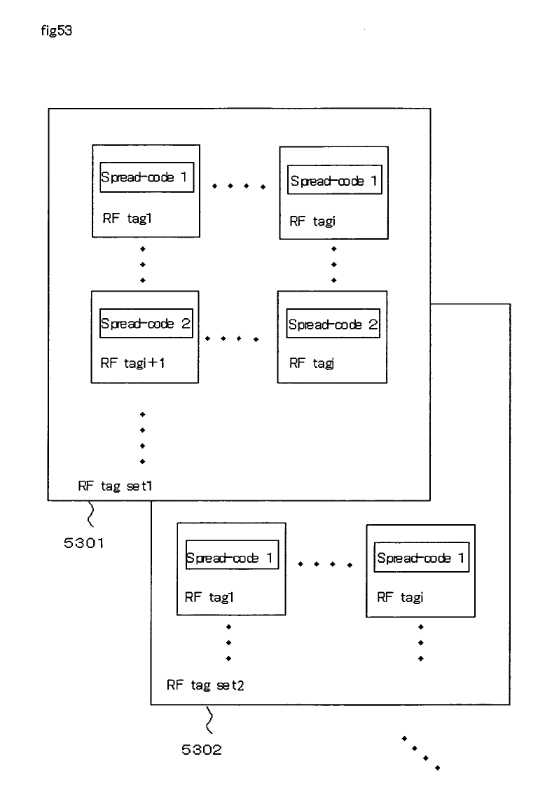

FIG. 53 shows an aggregation of a plurality of RF tag sets, consisted of the RF tag set 1 (5301), the RF tag set 2 (5302), and so on. The spread-codes used among respective RF tag sets are configured to be different, thereby enabling identification for respective groups of RF tag set.

According to the RF tag set of the seventeenth embodiment, the different spread-codes are used for a plurality of RF tag sets, so that it becomes possible to reduce the usage of the spread-code.

### Eighteenth Embodiment

Hereinbelow, the concept of the eighteenth embodiment will be described. The invention of the eighteenth embodiment relates to the interrogator, which acquires and transmits the interrogator signal, acquires the synchronization signal correlated with the interrogator signal, and receives the response signal from RF tag to the interrogator signal transmitted on the basis of the synchronization signal acquired by the acquirer for synchronization signal.

The constituent features of the eighteenth embodiment will be described.

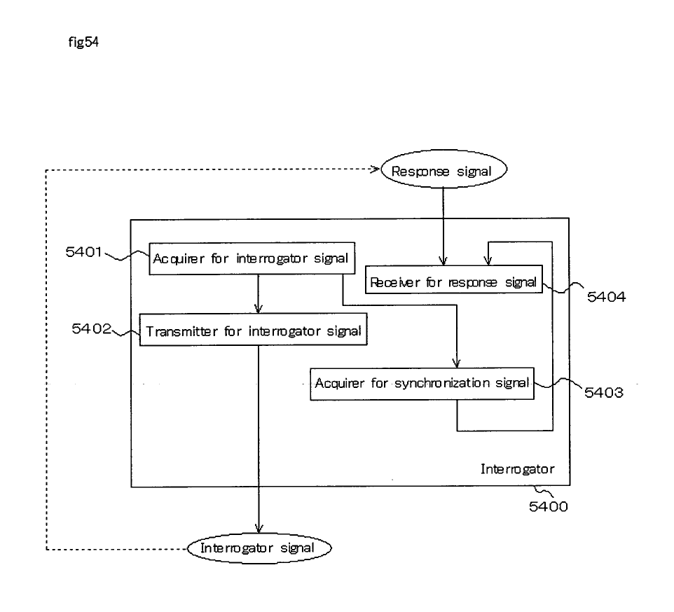

As shown in FIG. 54, the interrogator 5400 of the eighteenth embodiment comprises the acquirer for interrogator signal 5401, the transmitter for interrogator signal 5402, the acquirer for synchronization signal 5403, and the receiver for response signal 5404.

Hereinbelow, the constituent features of the interrogator of the eighteenth embodiment will be described.

The acquirer for interrogator signal acquires the interrogator signal. Here, the ‘interrogator signal’ is the same as that of the receiver for interrogator signal of the first embodiment, so that the description is omitted. Further, the term ‘acquires the interrogator signal’ means that the interrogator signal is generated and the generated interrogator signal is acquired. Further, as the description of the spread-code modulator of the first embodiment, as to the interrogator signal, the spread-code modulated interrogator signal by using spread-code modulation can be acquired.

The transmitter for interrogator signal transmits the interrogator signal acquired by the acquirer for interrogator signal. Here, the interrogator signal is transmitted to the RF tag. Note that the interrogator signal is modulated by modulation means using carrier wave, and is transmitted by the transmitter. AM (Amplitude Modulation) is preferable as a modulation method carried out by the modulation means. The reason for this is that the RF tag easily receives a signal, and more power can be supplied to the RF tag. In addition, not limited to AM, FM (Frequency Modulation), PM (Phase Modulation), PSK modulation, FSK modulation, or ASK modulation etc. may be used. Moreover, signal indicating synchronization bit, start bit, end bit, or error correction bit may be added to the interrogator signal.

The acquirer for synchronization signal acquires a synchronization signal correlated with the interrogator signal. Here, the ‘synchronization signal’ corresponds to a signal for synchronizing clock frequencies between an interrogator and a RF tag. FIG. 2 is a diagram showing a relationship between the clock frequency of the interrogator and the clock frequency of the RF tag. Further, the terms ‘acquires a synchronization signal’ means that the synchronization signal is generated and acquired. For example, for generation of the synchronization signal, a crystal unit, a crystal oscillator, clock pulse generator, or a clock driver is used. The term ‘correlated’ means that a specific relationship with the interrogator signal is determined. Specifically, the synchronization information, which is used by the RF tag receiving the interrogator signal upon transmission of the response signal, is determined. An example of the synchronization signal correlated with the interrogator signal includes a signal generated by a carrier wave carrying an interrogator signal, or a signal used for generating a carrier wave.

The receiver for response signal receives a response signal from RF tag to the interrogator signal transmitted from the transmitter for interrogator signal on the basis of the synchronization signal acquired by the acquirer for synchronization signal. The configuration of the response signal is the same as that of FIG. 5, so that the description will be omitted.

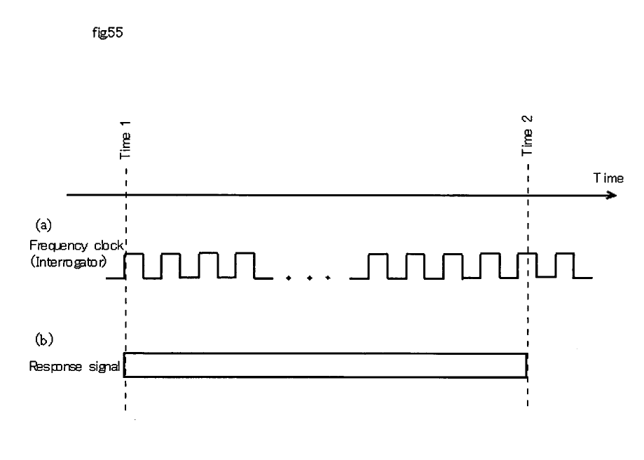

FIG. 55 is a diagram exemplifying a concept of reception of the response signal based on the synchronization signal. FIG. 55(a) shows the clock frequency of the interrogator and the synchronization signal. FIG. 55(b) shows the response signal, of which reception is stared at time 1, and is completed at time 2. Note that the reception of the response signal is started, for example, by recognizing a start bit of a start signal, or by recognizing an end bit of an end signal.

In addition, in the case of recognizing a plurality of RF tags, viewing from the points of detection accuracy and time, it is beneficial that the response signal with different response signal intensity from respective RF tags arrives. In order to attain this, ‘one mixer’ is used. In reception by the ‘one mixer’, depending on the phase relationship between response signals of RF tags, a significant difference is caused between the detected response signals. By utilizing this property, the configuration of the one mixer is beneficial in simplifying hardware. Here, example s of the ‘mixer’ include single mixer and double balance mixer. The single mixer is a circuit type mixer using only one diode. The double balance mixer is a circuit type mixer using a plurality of diodes. Here, the ‘one mixer’ means a mixer such as a quadrature mixer, not using a plurality of mixers.

Moreover, by gradually sweeping frequency of CW (Continuous Wave) transmitted from the interrogator and changing fading environment, it becomes easy to receive the response signal of the RF tag, of which response signal intensity is low.

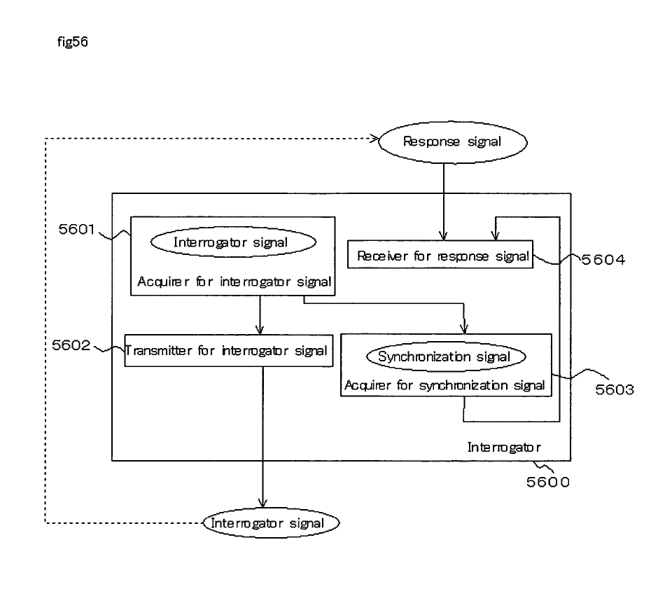

FIG. 56 is a diagram explaining flow of the information and the signal of the interrogator 5600 of the eighteenth embodiment. The interrogator of the eighteenth embodiment comprises the acquirer for interrogator signal 5601, the transmitter for interrogator signal 5602, the acquirer for synchronization signal 5603, and the receiver for response signal 5604. The acquirer for interrogator signal acquires the interrogator signal. The transmitter for interrogator signal transmits the interrogator signal. The receiver for response signal receives the interrogator signal. The acquirer for synchronization signal acquires the synchronization signal.

Hereinbelow, the processing flow of the eighteenth embodiment will be described.

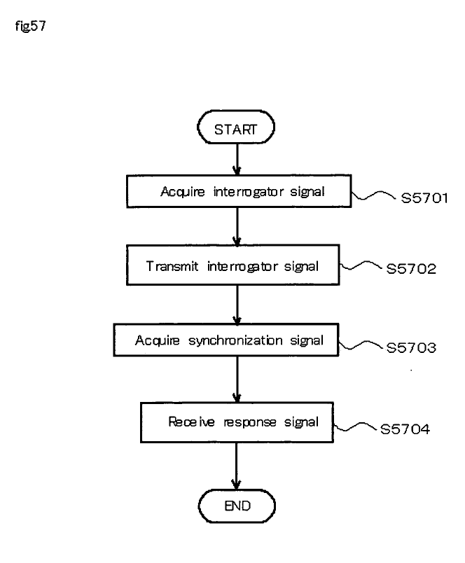

FIG. 57 is a diagram explaining the processing flow of the eighteenth embodiment.

The acquirer for interrogator signal acquires the interrogator signal (step S5701). The transmitter for interrogator signal transmits the interrogator signal acquired by the acquirer for interrogator signal (step S5702). The acquirer for synchronization signal acquires the synchronization signal correlated with the interrogator signal (step S5703). The receiver for response signal receives the response signal from RF tag to the interrogator signal transmitted from the transmitter for interrogator signal on the basis of the synchronization signal acquired by the acquirer for synchronization signal (step S5704).

According to the interrogator of the eighteenth embodiment, by receiving the spread-code modulated response signal, it becomes possible to increase confidentiality of information, and to improve tolerance of external noise.

### Nineteenth Embodiment

Hereinbelow, the concept of the nineteenth embodiment will be described.

The invention described in the nineteenth embodiment relates to the interrogator according to eighteenth embodiment, comprising the measurer for response signal intensity, which measures intensity of the response signal received by the receiver for response signal, the selector, which selects the response signal having a predetermined response signal intensity measured by the measurer for response signal intensity, and the first decoder, which decodes the response signal selected by the selector.

Hereinbelow, the constituent features of the nineteenth embodiment will be indicated.

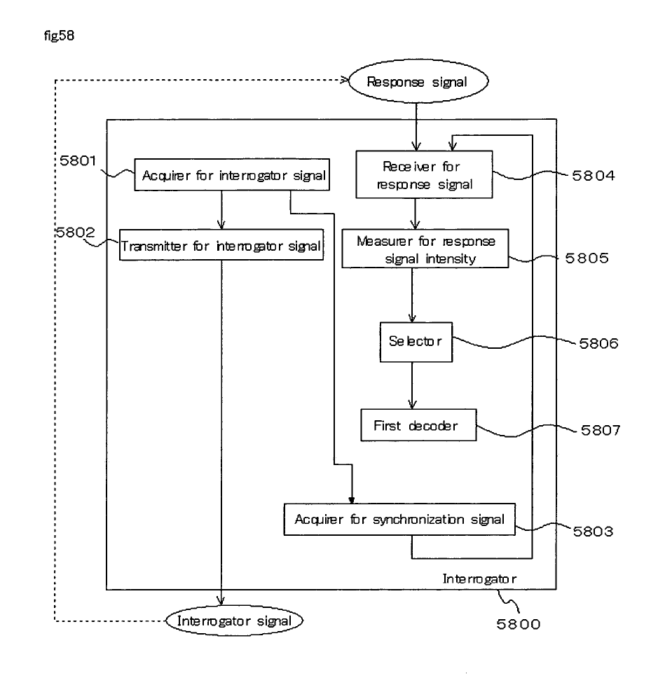

As shown in FIG. 58, the interrogator of the nineteenth embodiment comprises the acquirer for interrogator signal 5801, the transmitter for interrogator signal 5802, the acquirer for synchronization signal 5803, and the receiver for response signal 5804, the measurer for response signal intensity 5805, the selector 5806, and the first decoder 5807.

Hereinbelow, the constituent features of the interrogator of the nineteenth embodiment will be described. The acquirer for interrogator signal, the transmitter for interrogator signal, the acquirer for synchronization signal, and the receiver for response signal are the same as those of the eighteenth embodiment, so that the descriptions thereof will be omitted.

The measurer for response signal intensity measures intensity of the response signal received by the receiver for response signal. Here, examples of the ‘response signal intensity’ include power of the response signal, voltage intensity of the response signal, current intensity of the response signal, and electromagnetic energy intensity, which are indicated by decibel value.

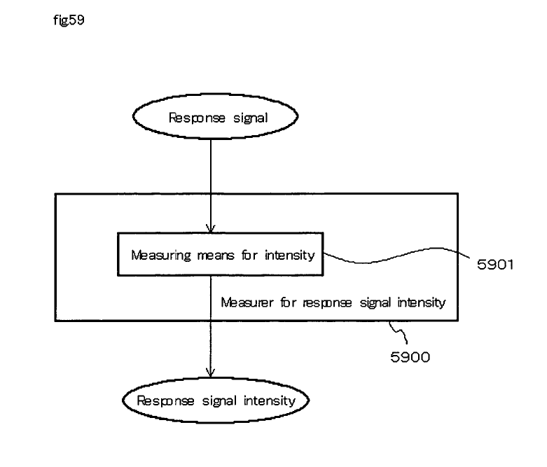

FIG. 59 is a diagram showing the configuration of the measurer for response signal intensity. The measurer for response signal intensity comprises the measuring means for intensity 5901. An example of a measuring device for intensity includes a correlator.

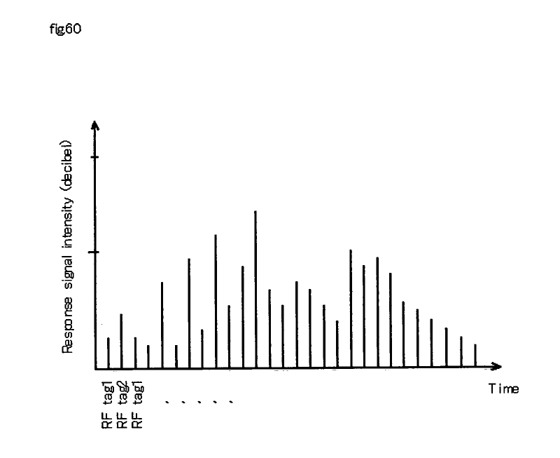

FIG. 60 is a diagram showing a decibel value of the response signal intensity of the response signal from the RF tag, which is received according to time lapse.

The selector selects the response signal having a predetermined response signal intensity measured by the measurer for response signal intensity. Here, the ‘response signal having the predetermined response signal intensity’ means the maximum response signal intensity among the measured response signal intensities, or the response signal intensity in the top three etc.

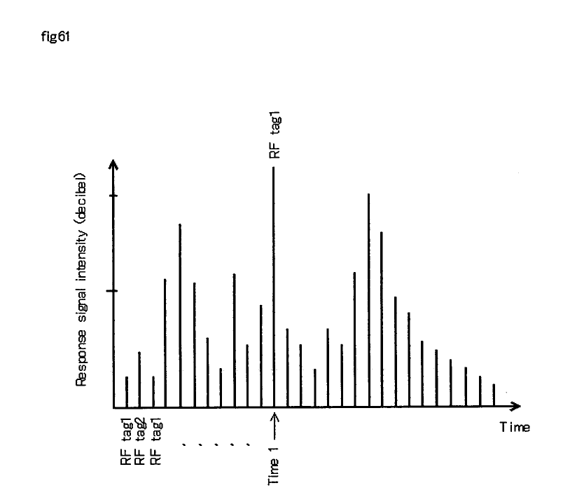

FIG. 61 is a diagram exemplifying a decibel value of the response signal intensity of the response signal from the RF tag, which is received according to time lapse, in cases where the predetermined response signal intensity is the ‘maximum response signal intensity among the measured response signal intensities’. The selector selects, for example, the response signal of the RF tag 1 at the time 1, which has the maximum response signal intensity among the measured response signal intensities.

The first decoder decodes the response signal selected by the selector. Here, the term ‘decoding’ means that the response signal is decoded from the selected response signal, and RFID information or the other response information are read, stored, or updated.

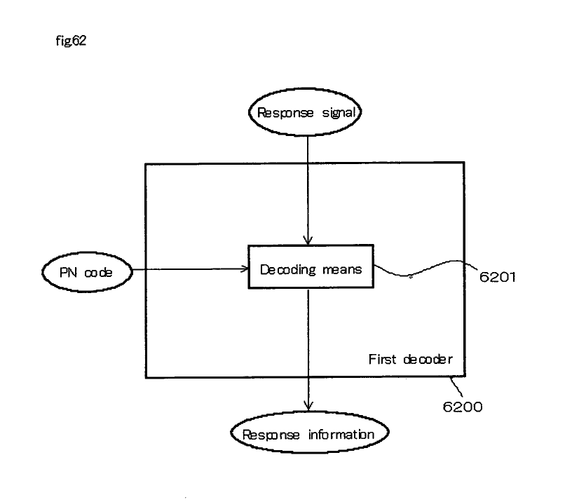

FIG. 62 is a diagram showing the configuration of the first decoder 6200. The first decoder comprises the decoding means 6201. Here, the ‘decoding means’ corresponds to a means for inverse spread-code modulation on the response signal and for generating the response information etc. by using the same spread-code (PN code) as the spread-code used for generating the response signal by the RF tag. Moreover, the ‘inverse spread-code modulation’ may be carried out by inverse operation of the spread-code modulation.

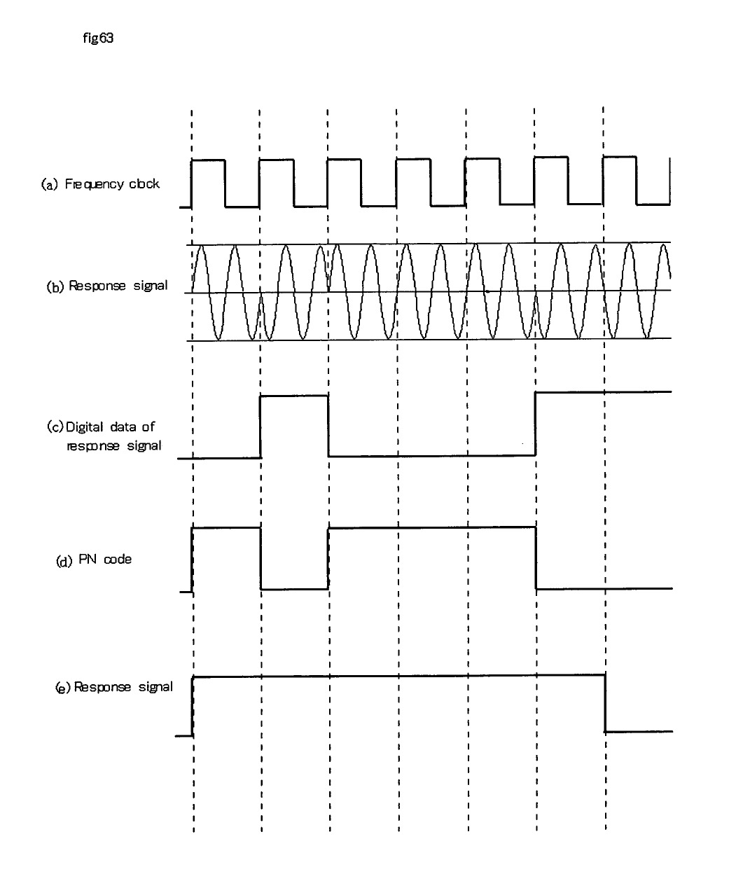

FIG. 63 is a diagram showing that the inverse spread-code modulation is carried out by the decoding means, and the response signal is generated. FIG. 63(a) shows the frequency clock of the interrogator, and the synchronization signal synchronizing with the RF tag. FIG. 63(b) shows the response signal received from the RF tag, which is the 1-bit digital pulse signal ‘1’ configuring the response information, which has been spread-code modulated the 7-bit PN code digital pulse signal ‘1011100’. FIG. 63(c) shows that in cases where the phase of sine-wave is 0°, the signal of FIG. 63(b) is indicated as the digital pulse signal ‘0’, and in cases where the phase of sine-wave is 180°, the signal of FIG. 63(b) is indicated as the digital pulse signal ‘1’; so that it indicates the exclusive disjunction ‘0100011’. FIG. 63(d) shows the same PN code as the PN code used by the RF tag, which indicates the digital pulse signal ‘1011100’. FIG. 63(e) shows the response information computed from FIG. 63(c) and(d), which indicates ‘1’. Thus, by using the same spread-code as the spread-code, which has been used for spread-code modulation in the RF tag, in the interrogator, it becomes possible to decode the response signal received from the RF tag and to generate the response information.

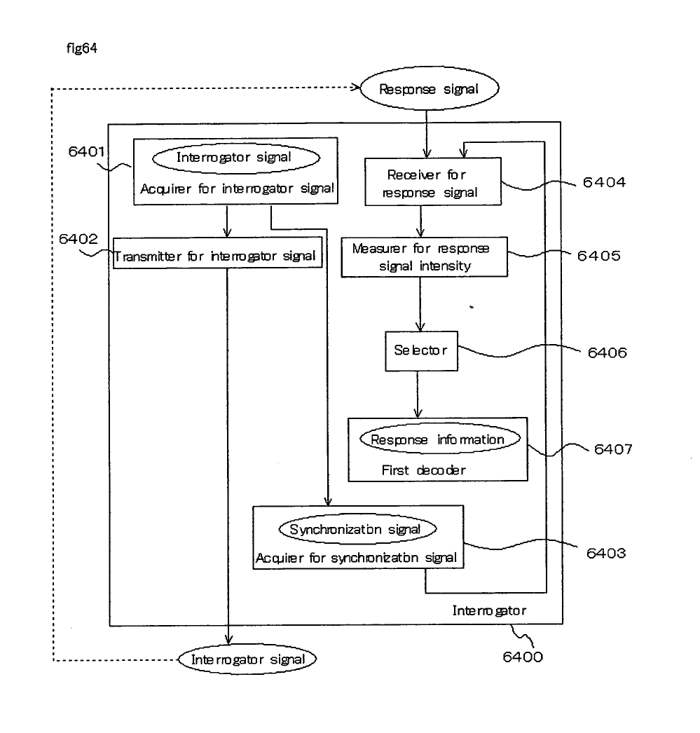

FIG. 64 is a diagram explaining flow of the information and the signal of the interrogator 6400 of the nineteenth embodiment. The interrogator of the nineteenth embodiment comprises the acquirer for interrogator signal 6401, the transmitter for interrogator signal 6402, the acquirer for synchronization signal 6403, the receiver for response signal 6404, the measurer for response signal intensity 6405, the selector 6406, and the first decoder 6407. The acquirer for interrogator signal acquires the interrogator signal. The transmitter for interrogator signal transmits the interrogator signal. The receiver for response signal receives the interrogator signal. The acquirer for synchronization signal acquires the synchronization signal. The first decoder decodes the response information from the response signal.

Hereinbelow, the processing flow of the nineteenth embodiment will be described.

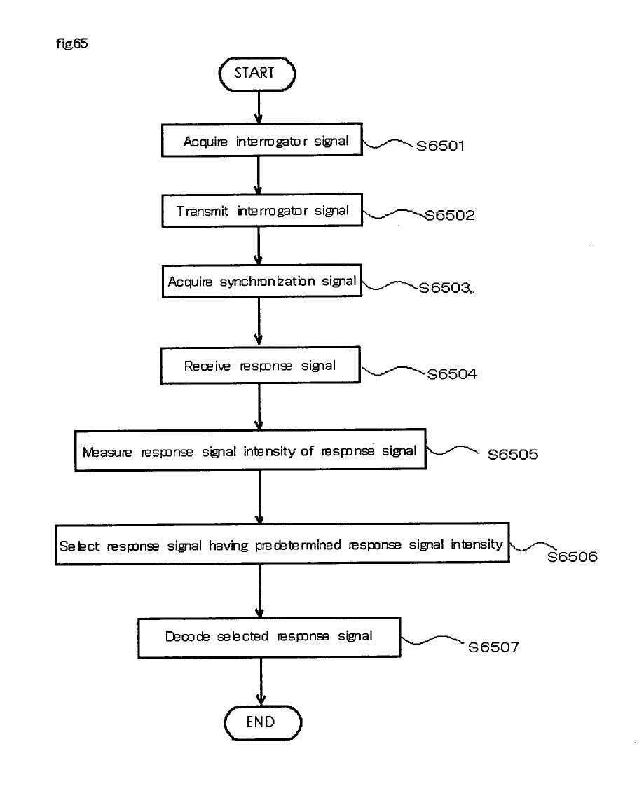

FIG. 65 is a diagram explaining the processing flow of the nineteenth embodiment. The acquirer for interrogator signal acquires the interrogator signal (step S6501). The transmitter for interrogator signal transmits the interrogator signal acquired by the acquirer for interrogator signal (step S6502). The acquirer for synchronization signal acquires the synchronization signal correlated with the interrogator signal (step S6503). The receiver for response signal receives the response signal from RF tag to the interrogator signal transmitted from the transmitter for interrogator signal on the basis of the synchronization signal acquired by the acquirer for synchronization signal (step S6504). The measurer for response signal intensity measures intensity of the response signal received by the receiver for response signal (step S6505). The selector selects the response signal having a predetermined response signal intensity measured by the measurer for response signal intensity (step S6506). The first decoder decodes the response signal selected by the selector (step S6507)

According to the interrogator of the nineteenth embodiment, it becomes possible for the interrogator to receive and read the response signals from a plurality of RF tags. In addition, by receiving the spread-code modulated response signal, it becomes possible to increase confidentiality of information, and to improve tolerance of external noise. In addition, by selecting the response signal having predetermined response signal intensity, it becomes possible to decode only the selected RF tag.

### Twentieth Embodiment

Hereinbelow, the concept of the twentieth embodiment will be described.

The invention described in the twentieth embodiment relates to the interrogator according to the nineteenth embodiment, wherein the first decoder comprises the acquisition means for RFID information, which acquires RFID information for unique identification of the RF tag according to the ninth embodiment by decoding spread-code modulated response information, comprising the transmitter for stop instruction, which transmits a stop instruction for stopping transmission of a signal to the RF tag according to the ninth embodiment, which is identified by the RFID information acquired by the acquisition means for RFID information.

Hereinbelow, the constituent features of the twentieth embodiment will be indicated.

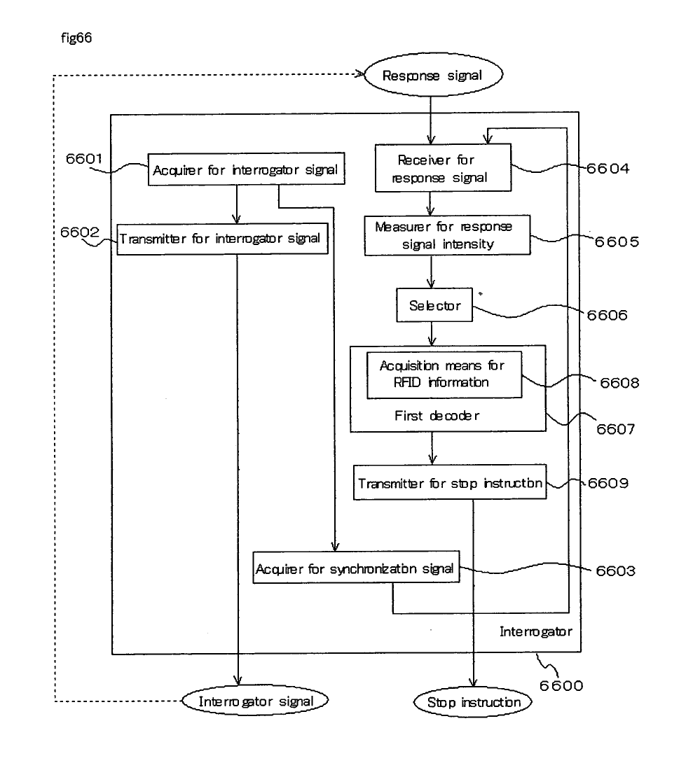

As shown in FIG. 66, the interrogator of the twentieth embodiment comprises the acquirer for interrogator signal 6601, the transmitter for interrogator signal 6602, the acquirer for synchronization signal 6603, and the receiver for response signal 6604, the measurer for response signal intensity 6605, the selector 6606, and the first decoder 6607, and the transmitter for stop instruction 6609. The first decoder comprises the acquisition means for RFID information 6608.

Hereinbelow, the constituent features of the interrogator of the twentieth embodiment will be described. The acquirer for interrogator signal, the transmitter for interrogator signal, the acquirer for synchronization signal, the receiver for response signal, the measurer for response signal intensity, and the selector are the same as those of the first decoder of the nineteenth embodiment, so that the descriptions thereof will be omitted.

The first decoder comprises the acquisition means for RFID information, which acquires RFID information for unique identification of the RF tag according to the fifth embodiment by decoding spread-code modulated response information included in the data area of the response signal.

The transmitter for stop instruction transmits the stop instruction for stopping transmission of a signal to the RF tag according to the fifth embodiment, which is identified by the RFID information acquired by the acquisition means for RFID information. Here, the ‘stop instruction’ corresponds to a command format stop instruction, which is coded by the pattern of ‘0’ or ‘1’, etc.

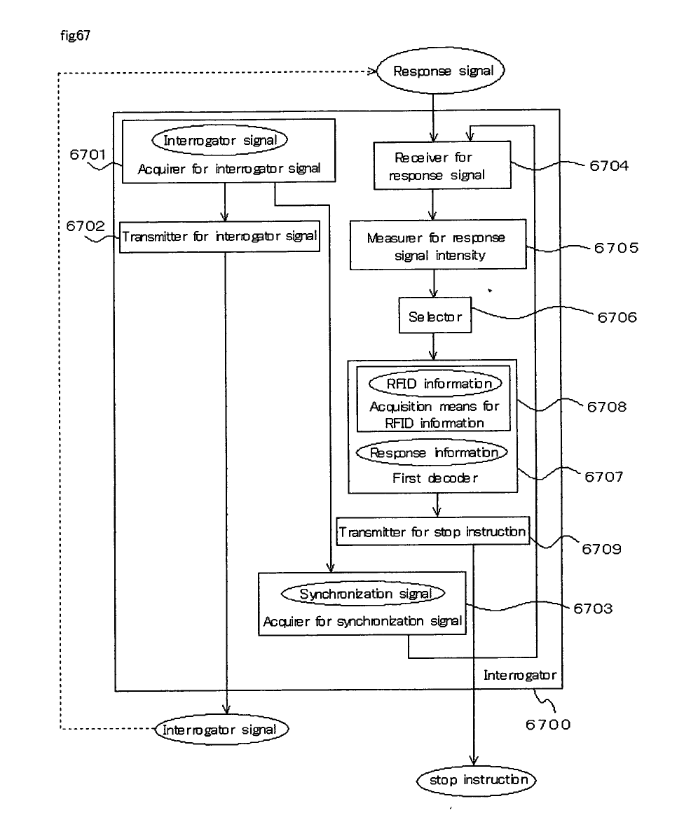

FIG. 67 is a diagram explaining the flow of the information and the signal of the interrogator 6700 of the twentieth embodiment. The interrogator of the twentieth embodiment comprises the acquirer for interrogator signal 6701, the transmitter for interrogator signal 6702, the acquirer for synchronization signal 6703, the receiver for response signal 6704, the measurer for response signal intensity 6705, the selector 6706, and the first decoder 6707, and the transmitter for stop instruction 6709. The first decoder comprises the acquisition means for RFID information 6708. The acquirer for interrogator signal acquires the interrogator signal. The transmitter for interrogator signal transmits the interrogator signal. The receiver for response signal receives the interrogator signal. The acquirer for synchronization signal acquires the synchronization signal. The first decoder decodes the response information from the response signal. The acquisition means for RFID information acquires the RFID information. The transmitter for stop instruction transmits the stop instruction.

Hereinbelow, the processing flow of the twentieth embodiment will be described.

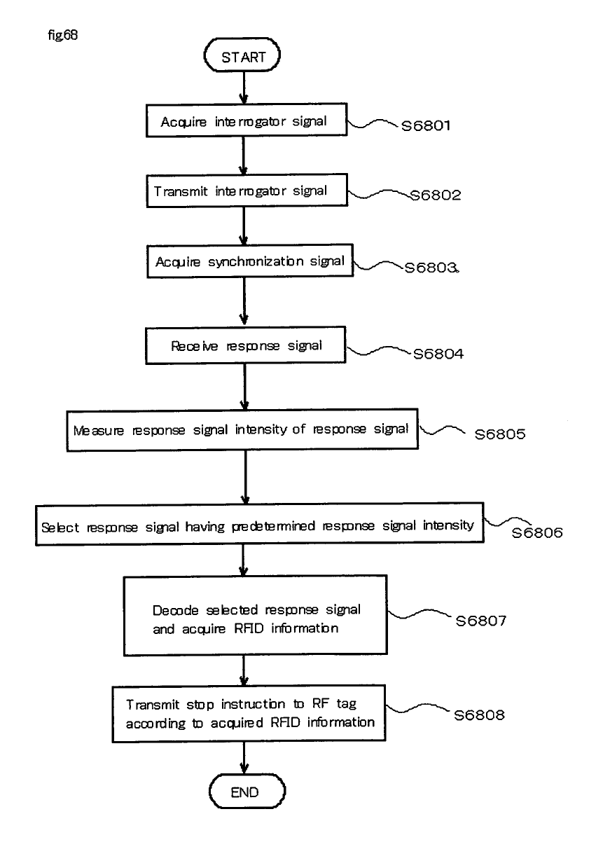

FIG. 68 is a diagram explaining the processing flow of the twentieth embodiment. The acquirer for interrogator signal acquires the interrogator signal (step S6801). The transmitter for interrogator signal transmits the interrogator signal acquired by the acquirer for interrogator signal (step S6802). The acquirer for synchronization signal acquires the synchronization signal correlated with the interrogator signal (step S6803). The receiver for response signal receives the response signal from RF tag to the interrogator signal transmitted from the transmitter for interrogator signal on the basis of the synchronization signal acquired by the acquirer for synchronization signal (step S6804). The measurer for response signal intensity measures intensity of the response signal received by the receiver for response signal (step S6805). The selector selects the response signal having a predetermined response signal intensity measured by the measurer for response signal intensity (step S6806). The first decoder decodes the response signal selected by the selector (step S6807). The transmitter for stop instruction transmits the stop instruction to the RF tag according to the acquired RFID information (step S6808).

According to the interrogator of the twentieth embodiment, it becomes possible to transmit the stop instruction for stopping transmission of the signal to the RF tag identified by the acquired RFID information.

### Twenty-First Embodiment

Hereinbelow, the concept of the twenty-first embodiment will be described.

The invention described in the twenty-first embodiment relates to the interrogator according to the eighteenth embodiment, comprising the measurer for response signal intensity, which measures intensity of the response signal received by the receiver for response signal, and the second decoder, which decodes a response signal, of which intensity fulfils a predetermined condition, if the response signal intensity measured by the measurer for response signal intensity fulfils a predetermined condition.

Hereinbelow, the constituent features of the twenty-first embodiment will be indicated.

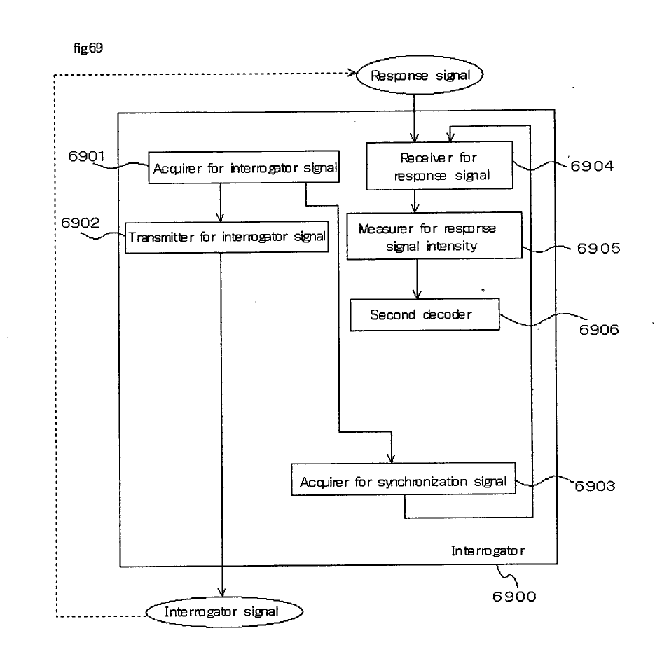

As shown in FIG. 69, the interrogator 6900 of the twenty-first embodiment comprises the acquirer for interrogator signal 6901, the transmitter for interrogator signal 6902, the acquirer for synchronization signal 6903, and the receiver for response signal 6904, the measurer for response signal intensity 6905, and the second decoder 6906.

Hereinbelow, the constituent features of the interrogator of the twenty-first embodiment will be described. The acquirer for interrogator signal, the transmitter for interrogator signal, the acquirer for synchronization signal, and the receiver for response signal are the same as those of the eighteenth embodiment, and the measurer for response signal intensity is the same as that of the nineteenth embodiment, so that the descriptions thereof will be omitted.

The second decoder decodes a response signal, of which intensity fulfils a predetermined condition, if the response signal intensity measured by the measurer for response signal intensity fulfils a predetermined condition. Here, the ‘predetermined condition’ means that the response signal intensity is ‘more than x decibel’, ‘more than x decibel and less than y decibel’, or ‘less than y decibel’ etc.

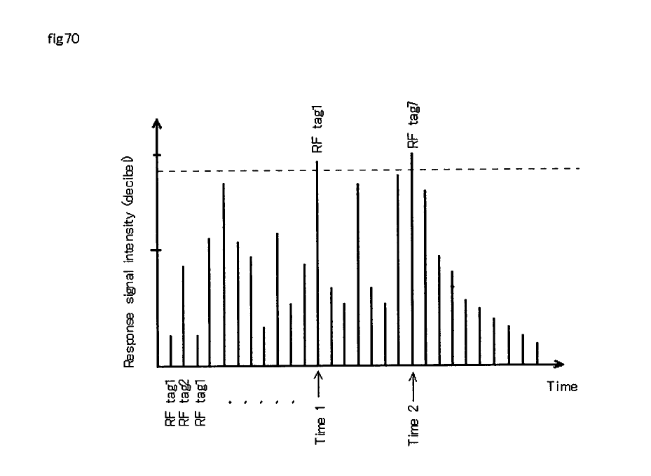

FIG. 70 is a diagram exemplifying a decibel value of the response signal intensity of the response signal from the RF tag, which is received according to time lapse, in cases where the predetermined condition is that the response signal intensity is ‘more than x decibel’. The second decoder decodes, for example, the RF tag 1 at time 1, which has the response signal intensity of ‘more than x decibel’, and the response signal of the RF tag 7 at time 2. The decoding manner is the same as that of the first decoder of the nineteenth embodiment, so that the description will be omitted. Note that there is the difference from that of the nineteenth embodiment. In the nineteenth embodiment, the selector selects the response signal from the response signals of various response signal intensities, whereas in the twentieth embodiment, the selector is not comprised, and the response signal having the response signal intensity fulfilling the condition of the interrogator is sequentially decoded.

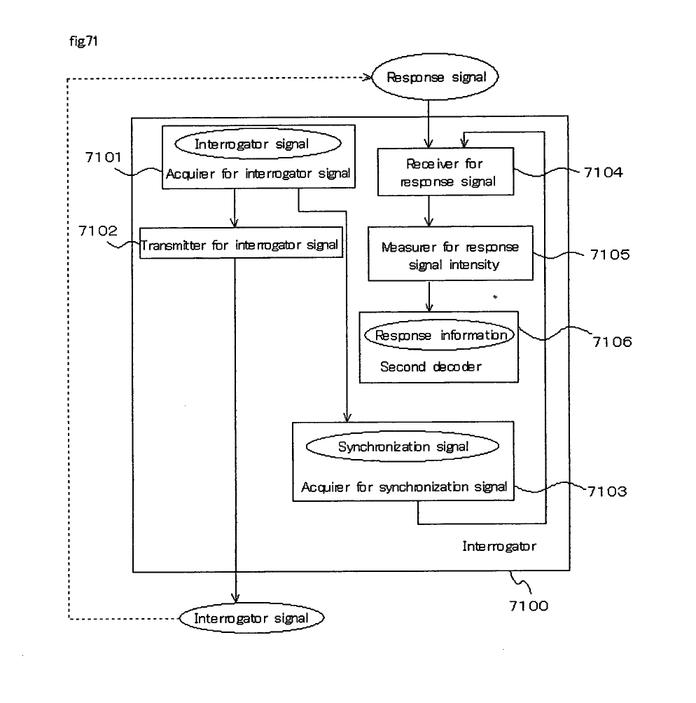

FIG. 71 is a diagram explaining flow of the information and the signal of the interrogator 7100 of the twenty-first embodiment. The interrogator of the twenty-first embodiment comprises the acquirer for interrogator signal 7101, the transmitter for interrogator signal 7102, the acquirer for synchronization signal 7103, the receiver for response signal 7104, the measurer for response signal intensity 7105, and the second decoder 7106. The acquirer for interrogator signal acquires the interrogator signal. The transmitter for interrogator signal transmits the interrogator signal. The receiver for response signal receives the interrogator signal. The acquirer for synchronization signal acquires the synchronization signal. The second decoder decodes the response information from the response signal.

Hereinbelow, the processing flow of the twenty-first embodiment will be described.

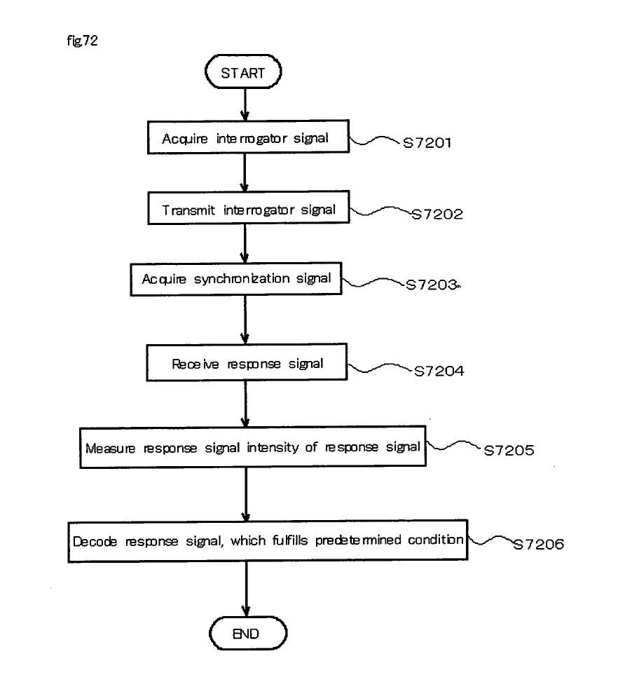

FIG. 72 is a diagram explaining the processing flow of the twentieth embodiment. The acquirer for interrogator signal acquires the interrogator signal (step S7201). The transmitter for interrogator signal transmits the interrogator signal acquired by the acquirer for interrogator signal (step S7202). The acquirer for synchronization signal acquires the synchronization signal correlated with the interrogator signal (step S7203). The receiver for response signal receives the response signal from RF tag to the interrogator signal transmitted from the transmitter for interrogator signal on the basis of the synchronization signal acquired by the acquirer for synchronization signal (step S7204). The measurer for response signal intensity measures intensity of the response signal received by the receiver for response signal (step S7205). The second decoder decodes the response signal, of which intensity fulfils a predetermined condition, if the response signal intensity measured by the measurer for response signal intensity fulfils the predetermined condition (step S7206).

According to the interrogator of the twenty-first embodiment, it becomes possible for the interrogator to receive and read the response signals from a plurality of RF tags. In addition, by receiving the spread-code modulated response signal, it becomes possible to increase confidentiality of information, and to improve tolerance of external noise. In addition, it becomes possible to decode only the RF tag, which fulfils the predetermined condition.

### Twenty-Second Embodiment

Hereinbelow, the concept of the twenty-second embodiment will be described.

The invention described in the twenty-second embodiment relates to the interrogator according to the twenty-first embodiment, wherein the second decoder comprises the acquisition means for RFID information, which acquires the RFID information, which is information for unique identification of the RF tag according to the ninth embodiment, by decoding the spread-code modulated response information; comprising the transmitter for stop instruction, which transmits a stop instruction for stopping transmission of a signal to the RF tag according to the ninth embodiment, which is identified by the RFID information acquired by the acquisition means for RFID information.

Hereinbelow, the constituent features of the twenty-second embodiment will be indicated.

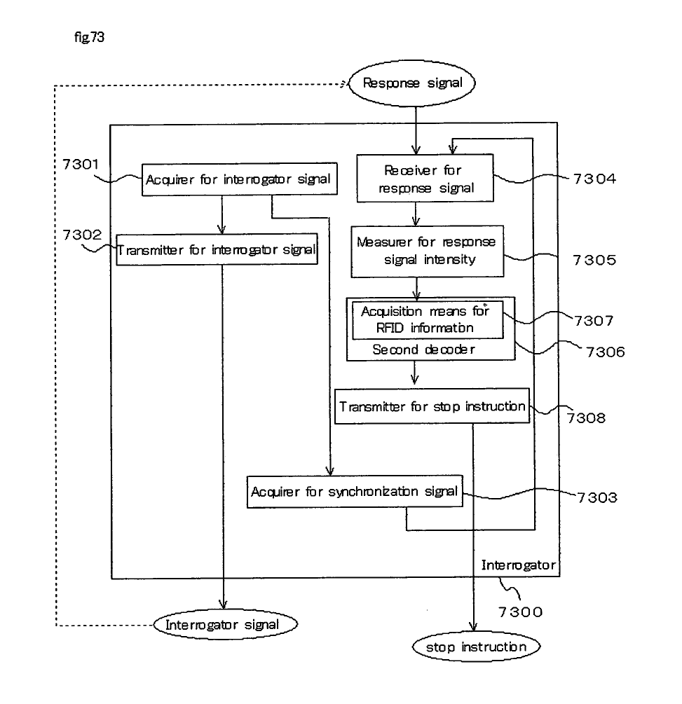

As shown in FIG. 73, the interrogator 7300 of the twenty-second embodiment comprises the acquirer for interrogator signal 7301, the transmitter for interrogator signal 7302, the acquirer for synchronization signal 7303, and the receiver for response signal 7304, the measurer for response signal intensity 7305, the second decoder 7306, and the transmitter for stop instruction 7308. The second decoder comprises the acquisition means for RFID information 7307.

Hereinbelow, the constituent features of the interrogator of the twenty-second embodiment will be described. The acquirer for interrogator signal, the transmitter for interrogator signal, the acquirer for synchronization signal, the receiver for response signal, and the measurer for response signal intensity are the same as those of the twenty-first embodiment, and the transmitter for stop instruction is the same as that of the twentieth embodiment, so that the descriptions thereof will be omitted.

The second decoder comprises the acquisition means for RFID information, which acquires the RFID information, which is information for unique identification of the RF tag according to the fifth embodiment, by decoding the spread-code modulated response information. The other features thereof are the same as those of the second decoder of the twenty-first embodiment, so that the description thereof will be omitted.

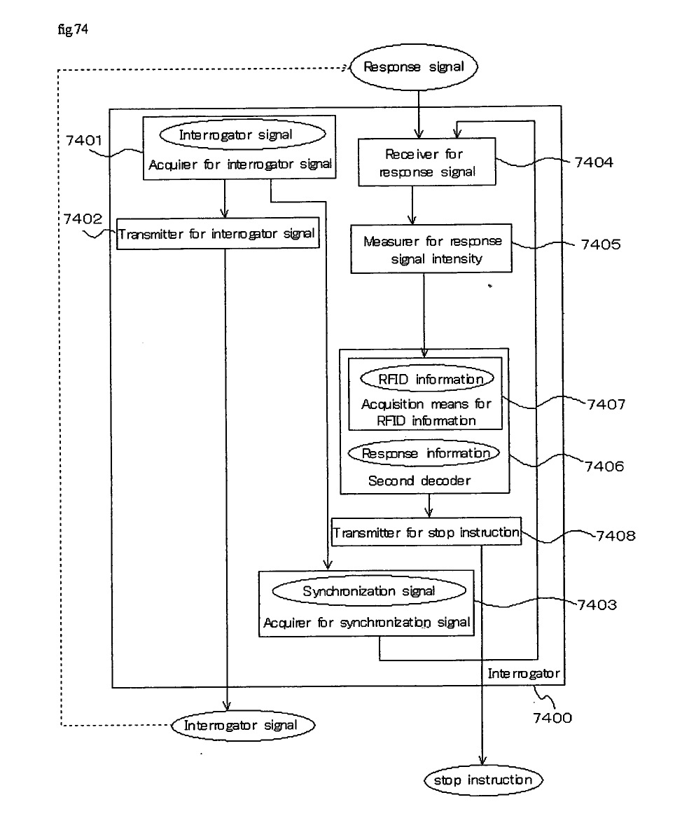

FIG. 74 is a diagram explaining flow of the information and the signal of the interrogator 7400 of the twenty-second embodiment. The interrogator of the twenty-second embodiment comprises the acquirer for interrogator signal 7401, the transmitter for interrogator signal 7402, the acquirer for synchronization signal 7403, the receiver for response signal 7404, the measurer for response signal intensity 7405, the second decoder 7406, and the transmitter for stop instruction 7408. The second decoder comprises the acquisition means for RFID information 7407.The acquirer for interrogator signal acquires the interrogator signal. The transmitter for interrogator signal transmits the interrogator signal. The receiver for response signal receives the interrogator signal. The acquirer for synchronization signal acquires the synchronization signal. The second decoder decodes the response information from the response signal. The acquisition means for RFID information acquires the RFID information. The transmitter for stop instruction transmits the stop instruction.

Hereinbelow, the processing flow of the twenty-second embodiment will be described.

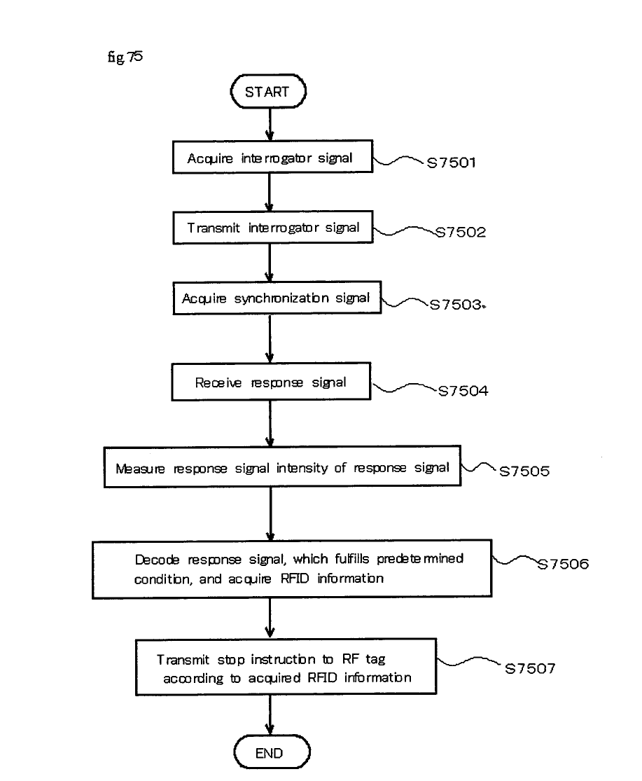

FIG. 75 is a diagram explaining the processing flow of the twentieth embodiment. The acquirer for interrogator signal acquires the interrogator signal (step S7501). The transmitter for interrogator signal transmits the interrogator signal acquired by the acquirer for interrogator signal (step S7502). The acquirer for synchronization signal acquires the synchronization signal correlated with the interrogator signal (step S7503). The receiver for response signal receives the response signal from RF tag to the interrogator signal transmitted from the transmitter for interrogator signal on the basis of the synchronization signal acquired by the acquirer for synchronization signal (step S7504). The measurer for response signal intensity measures intensity of the response signal received by the receiver for response signal (step S7505). The second decoder decodes the response signal, of which intensity fulfils a predetermined condition, if the response signal intensity measured by the measurer for response signal intensity fulfils the predetermined condition (step S7506). The transmitter for stop instruction transmits the stop instruction to the RF tag according to the acquired RFID information (step S7507).

According to the interrogator of the twenty-second embodiment, it becomes possible to transmit the stop instruction for stopping transmission of the signal to the RF tag identified by the acquired RFID information.

### Twenty-Third Embodiment

Hereinbelow, the concept of the twenty-third embodiment will be described.

The invention described in the twenty-third embodiment relates to the interrogator according to any one of the nineteenth to the twenty-second embodiments, wherein the response signal comprises, the header including an identification code for measuring the response signal intensity, and the measurer for response signal intensity comprises, the correlator, which measures the response signal intensity based on a correlation between an identification code included in the header and a predetermined reference code.

Hereinbelow, the constituent features of the twenty-third embodiment are the same as that of the interrogator of any one of the nineteenth to the twenty-second embodiments, so that the description will be omitted.

Hereinbelow, the constituent features of the interrogator of the twenty-third embodiment will be described. Except that the measurer for response signal intensity comprises the correlator, the constituent features are the same as those of any one of the nineteenth to the twenty-second embodiments, so that the descriptions thereof will be omitted.

The measurer for response signal intensity comprises the correlator, which measures the response signal intensity based on the correlation between the identification code included in the header and the predetermined reference code. The response signal measured by the measurer for response signal intensity comprises the header including the identification code for measuring the response signal intensity. Further, the ‘reference code’ is a code used for measuring the response signal intensity of the RF tag, and configured so that the peak indicating response signal intensity from the response signal of the RF tag based on the predetermined corresponding relationship between the identification code and the reference code. The reference code is basically comprised by the interrogator. Note that the configuration for performing acquisition from outside and updating according to reading of RF tag may be used. For example, in the cases where identification of the identification codes of a plurality of groups with respect to each group is carried out, the reference code corresponding to the group, which is going to be read, is newly acquired every time. Moreover, after all readings of RF tags of the group are completed, it is discarded or is set to be an updateable state.

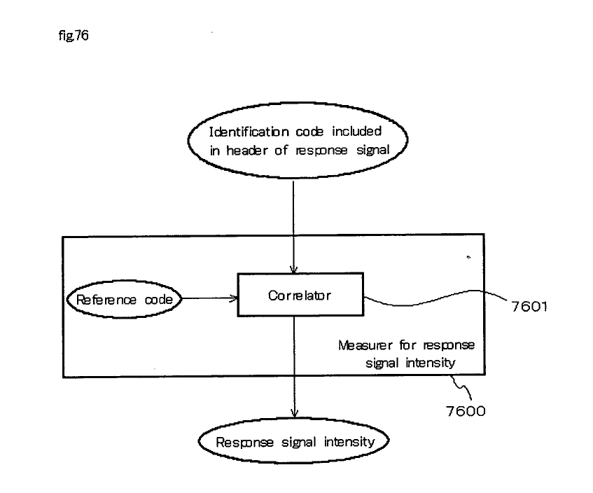

FIG. 76 is a diagram exemplifying the configuration of the measurer for response signal intensity 7600. The measurer for response signal intensity comprises the correlator 7601. The correlator measures the response signal intensity based on a correlation between the identification code included in the header and the predetermined reference code.

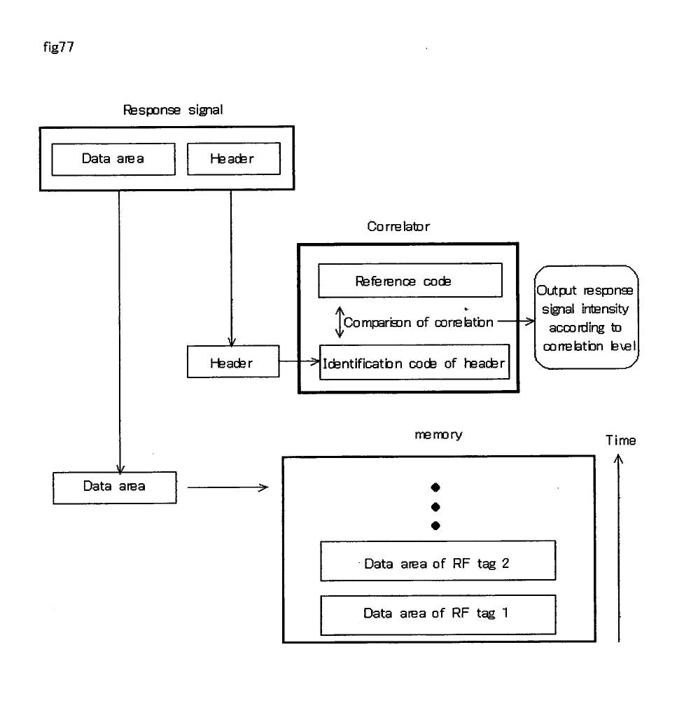

FIG. 77 is a diagram showing that the correlator measures the response signal intensity based on a correlation between the identification code included in the header and the predetermined reference code. The response signal comprises the header including identification code and the data area. The correlator measures and outputs the response signal intensity based on a correlation between the identification code included in the header and the predetermined reference code. For example, the correlator is configured so that the response signal intensity of the RF tag indicates a peak value at the point of accordance between the identification code and the reference code. Further, the peak values of the response signal intensities of a plurality of RF tags are compared, or determined whether the peak value fulfils the predetermined condition. Further, the data area is stored with the reception time in a memory. In cases where the response signal intensity is more than a certain level, it is determined that the identification code included in the header and the preset reference code match, so that the data area of the RF tag corresponding to the header of the RF tag is read from the memory with reference to the reception time, and is decoded.

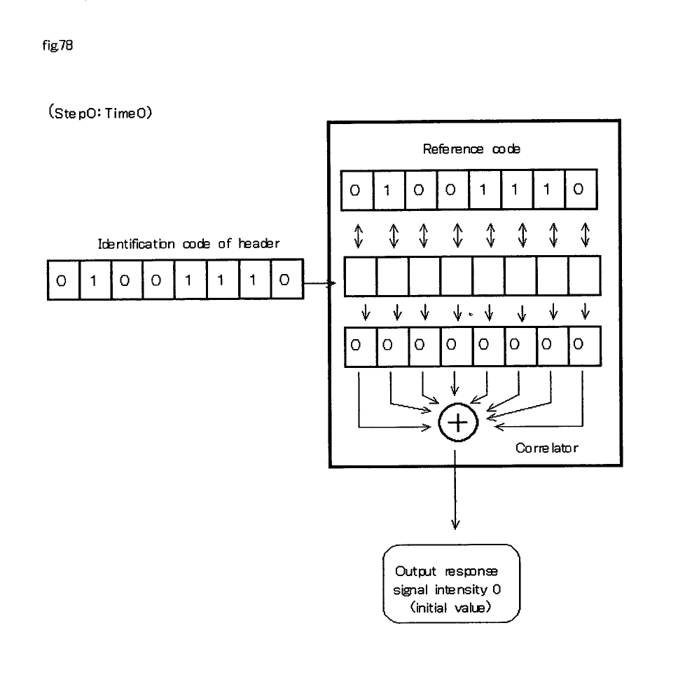

FIG. 78 to 82 show the steps of outputting the response signal intensity by the correlator based on the identification code included in the header and the preset reference code. Here, for example, the identification code of the header and the preset reference code are both binary data ‘01001110’. The upper line indicates the reference code, the middle line indicates the identification code of the header to be stored, and the bottom line indicates the comparative result of the reference code and the stored identification code of the header. If the upper line and the middle line, which correspond with each other, are compared with respect to each bit and the data thereof match, +1 is stored to the bottom line; and if not, −1 is stored to the bottom line. Further, in the case of comparing with blank data, ‘0’ is stored in the bottom line. The sum of the bits stored in the bottom line is computed and outputted as the response signal intensity.

FIG. 78 shows step 0 (time 0). Initially, the identification code of the header stored in the middle line is blank. The correlator outputs the response signal intensity ‘0’ (initial value).

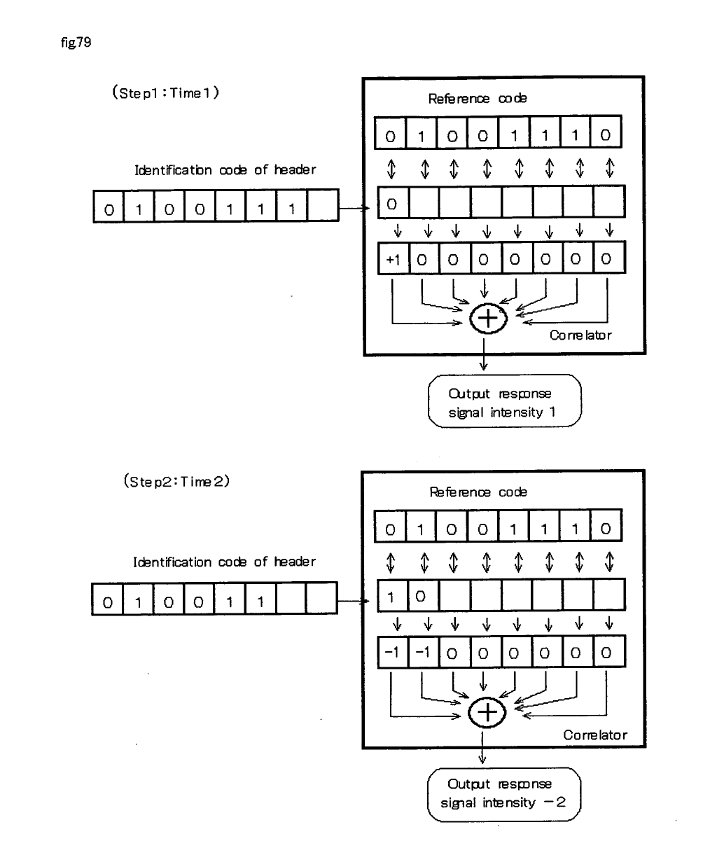

FIG. 79 shows step 1 (time 1) and step 2 (time 2). In step 1, data ‘0’ (right edge data) of the identification code of the header is stored in the middle line (left edge bit storage space) of the correlator. Data ‘0’ stored in the middle line and the data ‘0’ of the reference code stored in the upper line are compared and they match each other, so that +1 is stored in the bottom line. The correlator computes the sum of the bottom line, and outputs the response signal intensity ‘1’. Similarly, in step 2, the response signal intensity ‘−2’ is outputted.

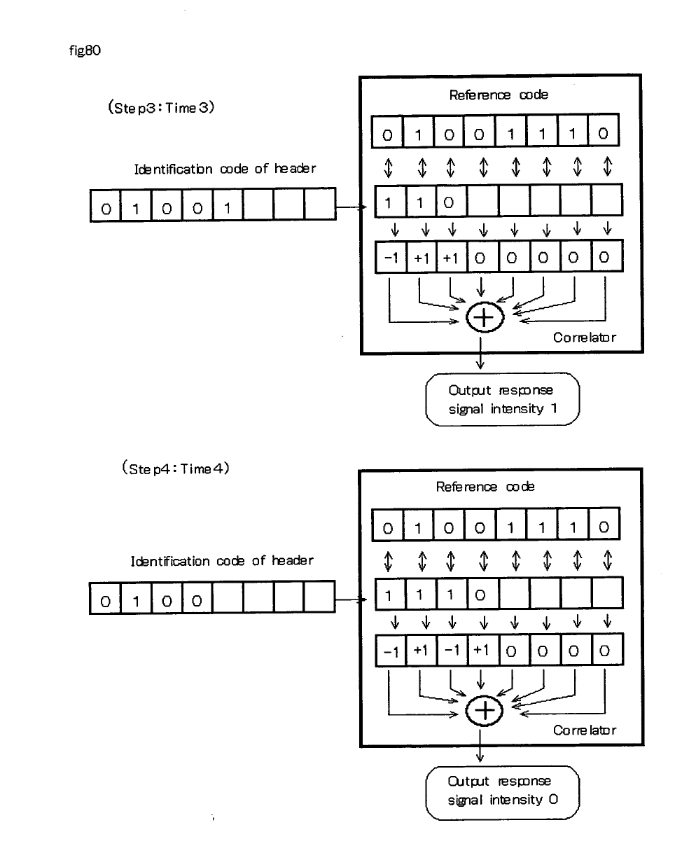

FIG. 80 shows step 3 (time 3) and step 4 (time 4). Similarly, in step 3, the response signal intensity ‘1’ is outputted. Similarly, in step 4, the response signal intensity ‘0’ is outputted.

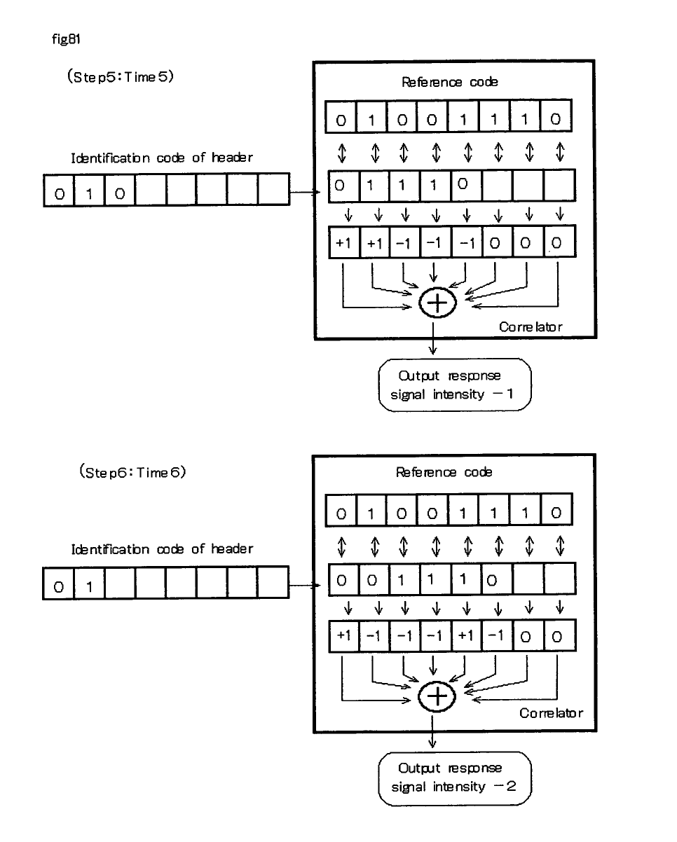

FIG. 81 shows step 5 (time 5) and step 6 (time 6). Similarly, in step 5, the response signal intensity ‘−1’ is outputted. Similarly, in step 6, the response signal intensity ‘−2’ is outputted.

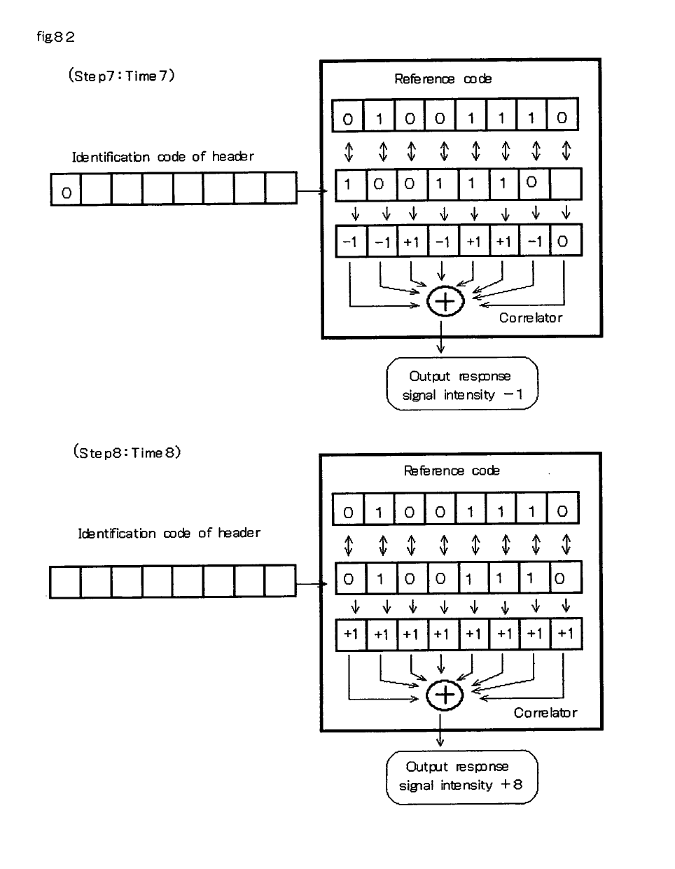

FIG. 82 shows step 7 (time 7) and step 8 (time 8). Similarly, in step 7, the response signal intensity ‘−1’ is outputted. Similarly, in step 8, the response signal intensity ‘+8’ is outputted. In this case, the identification code included in the header and the preset reference code match each other, so that the data area corresponding to the header is read from the memory, and is decoded.

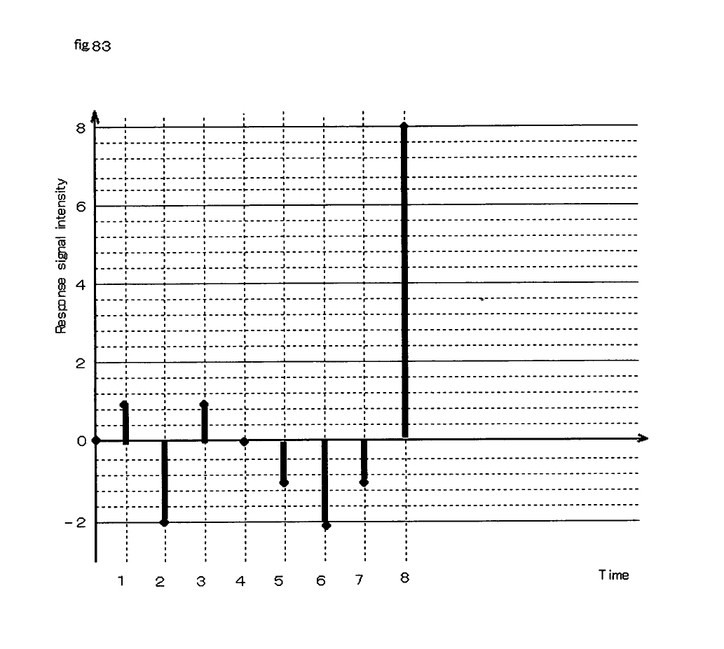

FIG. 83 is a graph showing the relationship between time 0 to 8 and the output of the response signal intensities. At time 8, the response signal intensity is the maximum value 8, the identification code of the header and the reference code match with each other. Note that even if the response signal intensity is minus, in cases where the absolute value is the maximum, it is possible to determine that the identification code of the header and the reference code match each other. This is beneficial when all bits of the header are inverse bits. This bit-inverse is caused by the error in the transmission side or by the data corruption on communication path etc.

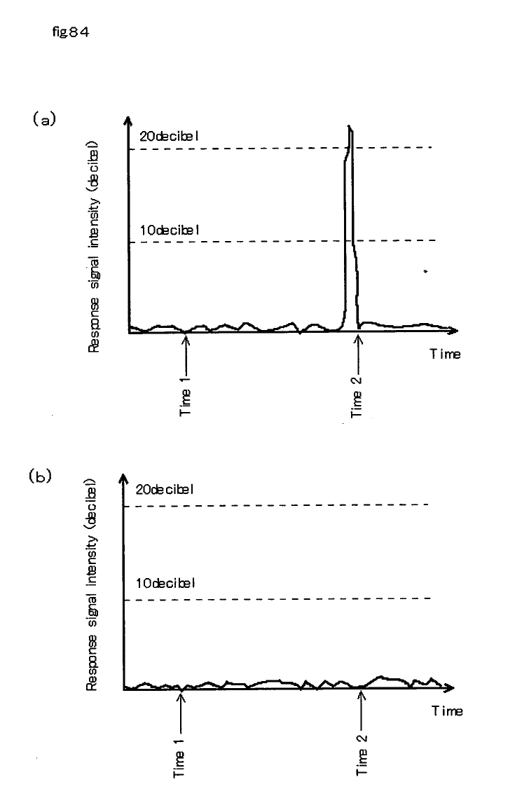

FIG. 84 is a graph showing the model of the actual measured response signal intensity. The time 1 corresponds to step 0, and time 2 corresponds to step 8. FIG. 84(a) shows the case that the identification code of the header and the preset reference code match with each other, and FIG. 84 (b) shows the case that the identification code of the header and the preset reference code do not match each other

Note that the correlator is not limited to one, and may be multiple. If a plurality of correlators exist, by setting the different reference code to the respective RF tags, it becomes possible to decode the response signals of the RF tags, each of them has different attribute, by one interrogator.

The processing flow of the twenty-third embodiment is the same as that of any one of the nineteenth to twenty-second embodiments, so that the description thereof will be omitted.

According to the interrogator of the twenty-third embodiment, it becomes possible to measure the response signal intensity based on the correlation between an identification code included in the header and the predetermined reference code.

### Twenty-Fourth Embodiment

Hereinbelow, the concept of the twenty-fourth embodiment will be described.

The invention described in the twenty-fourth embodiment relates to the interrogator according to any one of the nineteenth to twenty-third embodiments, wherein the measurer for response signal intensity comprises, the storage means for measurement time constant, which stores the measurement time constant for setting a measurement time for measuring the response signal intensity.

Hereinbelow, the constituent features of the twenty-fourth embodiment will be indicated.

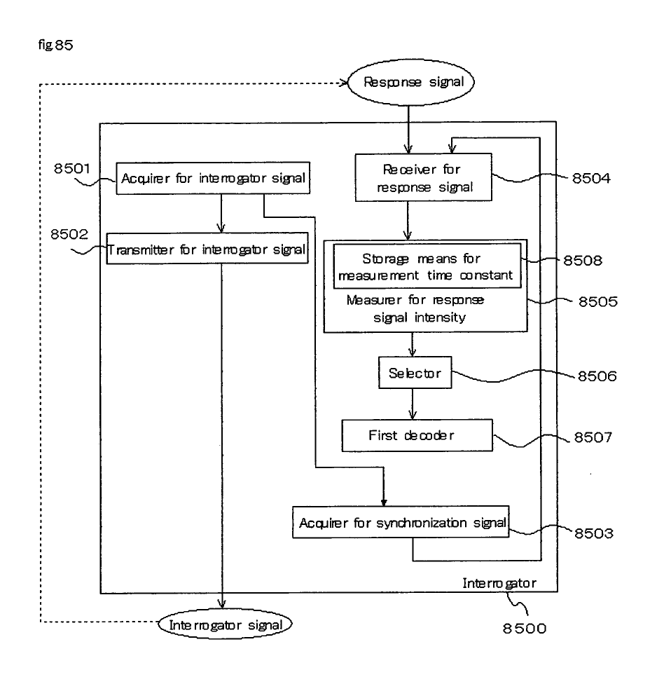

As shown in FIG. 85, the interrogator 8500 of the twenty-fourth embodiment comprises the acquirer for interrogator signal 8501, the transmitter for interrogator signal 8502, the acquirer for synchronization signal 8503, and the receiver for response signal 8504, the measurer for response signal intensity 8505, the selector 8506, and the first decoder 8507. The measurer for response signal intensity comprises the storage means for measurement time constant 8508.

Hereinbelow, the constituent features of the interrogator of the twenty-second embodiment will be described. The other features except the measurer for response signal intensity are the same as that of any one of the nineteenth to twenty-third embodiment, so that the description thereof will be omitted.

The measurer for response signal intensity comprises the storage means for measurement time constant, which stores the measurement time constant for setting a measurement time for measuring the response signal intensity. Here, the ‘storage means for measurement time constant’ corresponds to a timer etc.

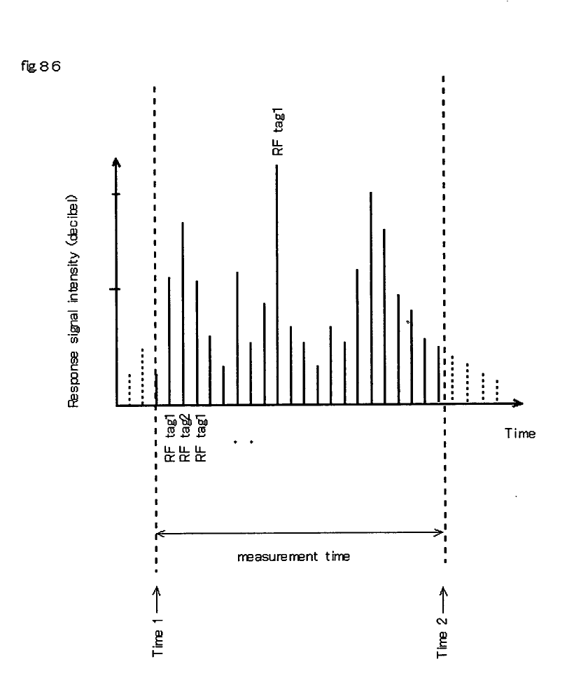

FIG. 86 is a diagram showing a concept of the measurement time. The measurement is started at time 1, and is completed at time 2. Only the response signal intensity in the measurement time is stored in the memory. The other features except the above are the same as that of the interrogator of any one of the nineteenth to the twenty-second embodiments, so that the description will be omitted.

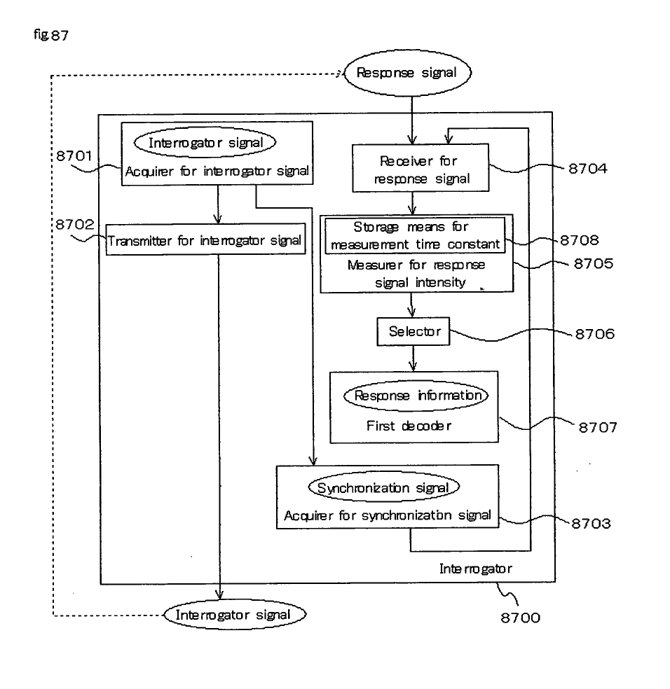

FIG. 87 is a diagram explaining flow of the information and the signal of the interrogator 8700 of the twenty-second embodiment. The interrogator of the twenty-second embodiment comprises the acquirer for interrogator signal 8701, the transmitter for interrogator signal 8702, the acquirer for synchronization signal 8703, the receiver for response signal 8704, the measurer for response signal intensity 8705, the selector 8706, and the first decoder 8707. The measurer for response signal intensity comprises the storage means for measurement time constant 8708. The acquirer for interrogator signal acquires the interrogator signal. The transmitter for interrogator signal transmits the interrogator signal. The receiver for response signal receives the interrogator signal. The acquirer for synchronization signal acquires the synchronization signal. The first decoder decodes the response information from the response signal.

Hereinbelow, the processing flow of the twenty-fourth embodiment will be described.

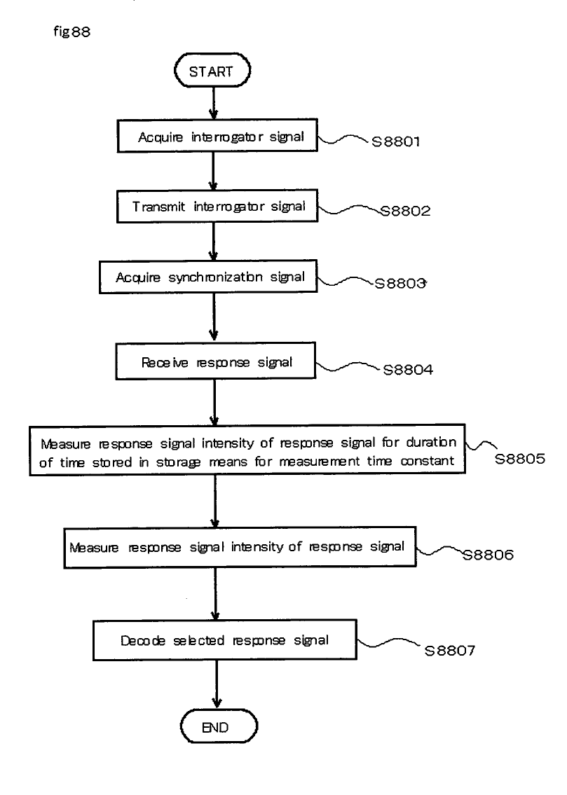

FIG. 88 is a diagram explaining the processing flow of the twenty-fourth embodiment. The acquirer for interrogator signal acquires the interrogator signal (step S8801). The transmitter for interrogator signal transmits the interrogator signal acquired by the acquirer for interrogator signal (step S8802). The acquirer for synchronization signal acquires the synchronization signal correlated with the interrogator signal (step S8803). The receiver for response signal receives the response signal from RF tag to the interrogator signal transmitted from the transmitter for interrogator signal on the basis of the synchronization signal acquired by the acquirer for synchronization signal (step S8804). The measurer for response signal intensity measures intensity of the response signal received by the receiver for response signal for duration of the time stored by the storage means for measurement time constant (step S8805). Subsequently, the selector selects the response signal having a predetermined response signal intensity measured by the measurer for response signal intensity (step S8806). The first decoder decodes the response signal selected by the selector (step S8807).

According to the interrogator of the twenty-fourth embodiment, by measuring the response signal intensity of the response signal received from the RF tag for duration of the time stored by the storage means for measurement time constant, it becomes possible to use the memory area effectively, and to carry out processes effectively.

### Twenty-Fifth Embodiment

Hereinbelow, the concept of the twenty-fifth embodiment will be described.

The invention described in the twenty-fifth embodiment relates to the interrogator according to the twenty-fourth embodiment, wherein the measurement time constant stored by the storage means for measurement time constant is a maximum value of response signal length.

The constituent features of the twenty-fifth embodiment are the same as those of the nineteenth to twenty-fourth embodiments, so that the description thereof will be omitted.

Hereinbelow, the constituent features of the interrogator of the twenty-fifth embodiment will be described. The features except the measurement time constant are the same as that of the twenty-fourth embodiment, so that the description thereof will be omitted.

The measurement time constant stored by the storage means for measurement time constant is a maximum value of response signal length. This is beneficial in the case that the RF tag continuously transmits the response signal. The reason is that if the measurement time constant is a maximum value of response signal length, therefore, is the time from the start of transmission of the response signal by the RF tag to the completion of the transmission; the RF tag carries out one transmission of the response signal within the measurement time of the measurement time constant. Therefore, if the measurement time constant is a maximum value of response signal length, it is possible to receive the response signal of the RF tag once in the measurement time. Generally, the response signal length is determined by the data amount of the data area configuring the response signal. As the measurement time constant is set to be larger, it becomes possible to measure more response signal intensities of RF tags, whereas required memory amount increases.

Note that if the RF tag does not continuously transmit the response signal, the measurement time constant stored by the storage means for measurement time constant is the constant from one to three times of the average value of the transmission interval. Here, the ‘average value of the transmission interval’ corresponds to an average value of the interval between the repeated transmissions. In addition, it may be an average value of a plurality of the average values of the transmission intervals between the transmissions of the RF tags. From a probabilistic view point, if the measurement time constant is one time of the average value of transmission interval, the RF tag carries out one transmission of the response signal within the measurement time of the measurement time constant. Therefore, if the measurement time constant is the constant from one to three times of the average value of the transmission interval, it is possible to receive one to three response signals of the RF tag.

In addition, as the measurement time constant is set to be smaller, it becomes possible to carry out processes more RF tags in a short time. For the configuration of the interrogator, which processes 10 to 100 RF tags at one time, the practical value as the measurement time constant stored by the storage means for measurement time constant is, for example, 1.3 to 1.7 times of the average value of the transmission interval. Of course, the value of the measurement time constant of the interrogator is not limited to this value.

The processing flow of the twenty-fifth embodiment is the same as that of the twenty-fourth embodiment, so that the description thereof will be omitted.

According to the interrogator of the twenty-fifth embodiment, by measuring the response signal intensity of the response signal received from the RF tag for the duration of measurement time, in which the response signal length is maximum value, it becomes possible to use the memory area effectively, and to carry out processes effectively.

### Twenty-Sixth Embodiment

Hereinbelow, the concept of the twenty-sixth embodiment will be described.

The invention described in the twenty-sixth embodiment relates to the interrogator according to the twenty-fourth to twenty-fifth embodiment, wherein the measurer for response signal intensity comprises the changing means for measurement time constant, which changes the measurement time constant.

Hereinbelow, the constituent features of the twenty-sixth embodiment will be indicated.

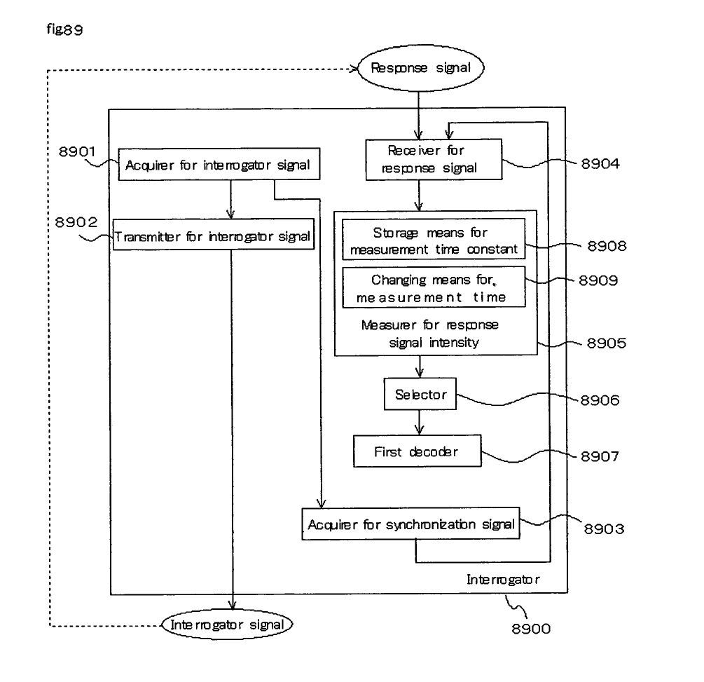

As shown in FIG. 89, the interrogator 8900 of the twenty-sixth embodiment comprises the acquirer for interrogator signal 8901, the transmitter for interrogator signal 8902, the acquirer for synchronization signal 8903, and the receiver for response signal 8904, the measurer for response signal intensity 8905, the selector 8906, and the first decoder 8907. The measurer for response signal intensity comprises the storage means for measurement time constant 8908, and the changing means for measurement time constant 8909.

Hereinbelow, the constituent features of the interrogator of the twenty-second embodiment will be described. The other features except the changing means for measurement time constant are the same as that of the twenty-fourth or twenty-fifth embodiment, so that the description thereof will be omitted.

The measurer for response signal intensity comprises the changing means for measurement time constant, which changes the measurement time constant. Here, the ‘changing means for measurement time constant’ changes the measurement time constant stored by the storage means for measurement time constant. The change of the measurement time constant may be carried out according to the reception frequency of the response signal from the RF tag. For example, if the reception is frequent, the measurement time constant may be changed to be smaller, and if the reception is infrequent, the measurement time constant may be changed to be larger. The other features except the above are the same as that of the twenty-fourth or twenty-fifth embodiment, so that the description thereof will be omitted.

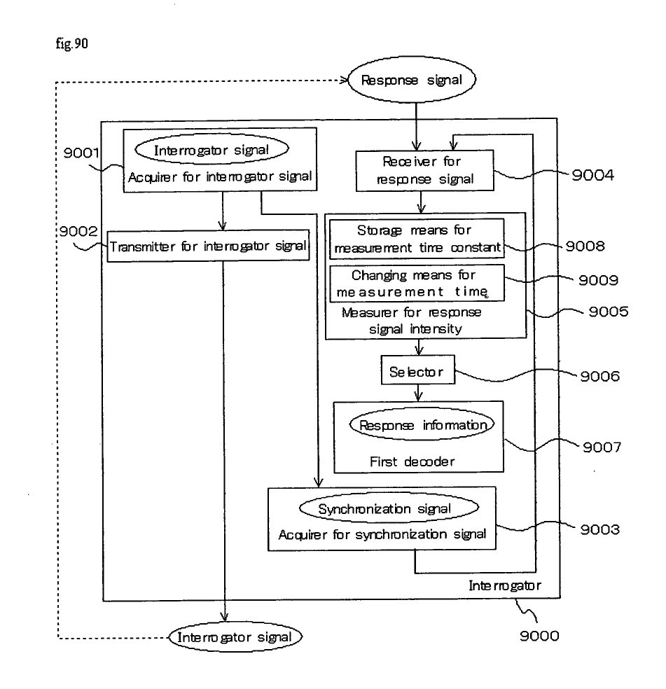

FIG. 90 is a diagram explaining the flow of the information and the signal of the interrogator 9000 of the twenty-second embodiment. The interrogator of the twenty-second embodiment comprises the acquirer for interrogator signal 9001, the transmitter for interrogator signal 9002, the acquirer for synchronization signal 9003, the receiver for response signal 9004, the measurer for response signal intensity 9005, the selector 9006, and the first decoder 9007. The measurer for response signal intensity comprises the storage means for measurement time constant 9008, and the changing means for measurement time constant 9009. The acquirer for interrogator signal acquires the interrogator signal. The transmitter for interrogator signal transmits the interrogator signal. The receiver for response signal receives the interrogator signal. The acquirer for synchronization signal acquires the synchronization signal. The first decoder decodes the response information from the response signal.

Hereinbelow, the processing flow of the twenty-sixth embodiment will be described.

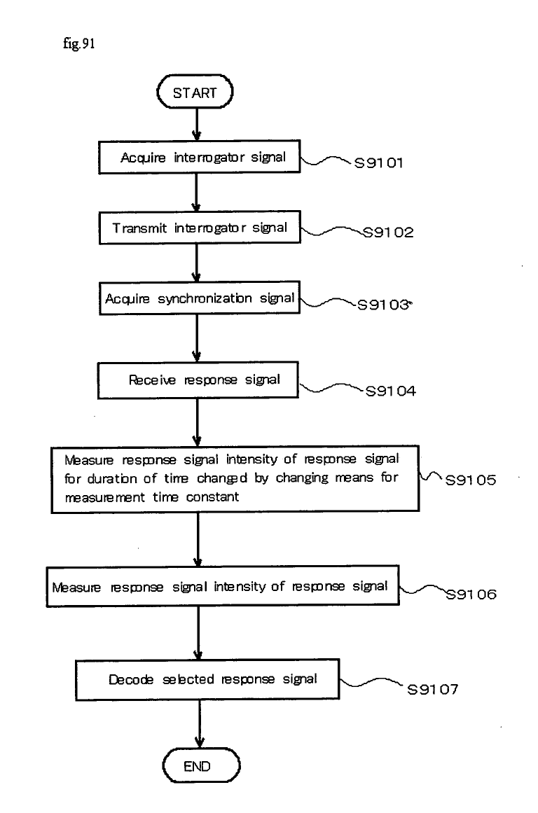

FIG. 91 is a diagram explaining the processing flow of the twenty-sixth embodiment. The acquirer for interrogator signal acquires the interrogator signal (step S9101). The transmitter for interrogator signal transmits the interrogator signal acquired by the acquirer for interrogator signal (step S9102). The acquirer for synchronization signal acquires the synchronization signal correlated with the interrogator signal (step S9103). The receiver for response signal receives the response signal from RF tag to the interrogator signal transmitted from the transmitter for interrogator signal on the basis of the synchronization signal acquired by the acquirer for synchronization signal (step S9104). The measurer for response signal intensity measures intensity of the response signal received by the receiver for response signal for the duration of the time changed by the changing means for measurement time constant, which is stored by the storage means for measurement time constant (step S9105). Subsequently, the selector selects the response signal having a predetermined response signal intensity measured by the measurer for response signal intensity (step S9106). The first decoder decodes the response signal selected by the selector (step S9107).

According to the interrogator of the twenty-sixth embodiment, by measuring the response signal intensity of the response signal received from the RF tag for the duration of measurement time changed by the changing means for measurement time constant, which is stored by the storage means for measurement time constant, it becomes possible to use the memory area effectively, and to carry out processes effectively.

### Twenty-Seventh Embodiment

Hereinbelow, the concept of the twenty-seventh embodiment will be described.

The invention described in the twenty-seventh embodiment relates to the interrogator according to the twenty-fourth embodiment, wherein the measurement time constant stored by the storage means for measurement time constant is a maximum value of header length.

Hereinbelow, the constituent features of the twenty-seventh embodiment are the same as that of the twenty-fourth embodiment, so that the description will be omitted.

Hereinbelow, the constituent features of the interrogator of the twenty-seventh embodiment will be described. Except that the measurement time constant, the constituent features are the same as those of the twenty-fourth embodiment, so that the descriptions thereof will be omitted.

The measurement time constant stored by the storage means for measurement time constant is a maximum value of header length. Here, the ‘maximum value of header length’ means the maximum value of the time required for transmission for header length upon transmission of the response signal to the interrogator by the RF tag. The measurer for response signal intensity may be configured to automatically stop measuring by lapse of time indicated by the measurement time constant, or may be configured that if the response signal fulfilling the condition is received within the time indicated by the measurement time constant, the measurement is paused, and is restarted after decoding the response signal. Moreover, the measurer for response signal intensity may be configured to start the subsequent measurement continuously after lapse of time indicated by the measurement time constant, if the response signal fulfilling the condition is not received within the time indicated by the measurement time constant.

The processing flow of the twenty-seventh embodiment is the same as that of the twenty-fourth embodiment, so that the description will be omitted.

According to the interrogator of the twenty-seventh embodiment, by measuring the response signal intensity of the response signal received from the RF tag for the duration of measurement time, which is the maximum value of header length, it becomes possible to use the memory area effectively, and to carry out processes effectively

### INDUSTRIAL APPLICABILITY

The present invention is available to the non-contact RF tag system comprising an interrogator and a plurality of RF tags.

1. An RF tag, comprising:
a receiver for interrogator signal, which receives a signal from an interrogator;
a generator for synchronization signal, which generates a synchronization signal based on the interrogator signal received by said receiver for interrogator signal;
an acquirer for response information, which acquires response information based on the interrogator signal received by said receiver for interrogator signal;
a spread-code modulator, which acquires spread-code modulated response information by spread-code modulating the response information acquired by said acquirer for response information; and
a transmitter, which transmits a response signal, which includes the spread-code modulated response information as data area acquired by said spread-code modulator, based on the synchronization signal generated by said generator for synchronization signal at random transmission interval.

2. The RF tag according to claim 1, wherein
said transmitter comprises,
a repeated transmission means, which repeatedly transmits said response signal at random transmission interval.

3. The RF tag according to claim 2, comprising:
a stopper, which stops transmission by said repeated transmission means.

4. The RF tag according to claim 3, comprising:
a receiver for stop instruction, which receives a stop instruction, wherein
the stop instruction is transmitted from the interrogator based on the response signal transmitted from said transmitter, and is for stopping transmission by said repeated transmission means, and
said stopper comprises,
a stopping means according to instruction, which stops transmission by repeated transmission means based on the stop instruction received by said receiver for stop instruction.

5. The RF tag according to claim 3 or 4, wherein
said stopper comprises,
a releasing means for stop instruction, which releases said stopped state.

6. The RF tag according to claim 3 or 4, wherein
said stopper comprises:
an acquisition means for proof information, which acquires proof information corresponding to the response signal transmitted from said transmitter; and
a proof-dependent stopping means, which stops transmission only when the proof information acquired by said acquisition means for proof information fulfils a predetermined condition.

7. The RF tag according to any one of claims 1 to 4, wherein
said random transmission interval is a random transmission interval based on a predetermined rule.

8. The RF tag according to claim 7, wherein
in said predetermined rule, an average value of transmission interval is a certain period of time.

9. The RF tag according to any one of claims 1 to 4, comprising:
a storage for RFID information, which stores RFID information, which is information for unique identification of itself, wherein
the response signal acquired by said acquirer for response information includes the RFID information acquired from said Storage for RFID information.

10. The RF tag according to any one of claims 1 to 4, comprising:
a storage for identification code, which stores an identification code; and
a generator for header, which generates a header including the identification code stored in said storage for identification code.

11. The RF tag according to claim 10, wherein
a signal configuring said header is an non-interferential signal even if it is overlapped with a signal configuring a data area of another RF tag having the same configuration as that of itself upon decoding of the spread-code by the interrogator.

12. The RF tag according to claim 10, wherein
a signal configuring said data area is an non-interferential signal even if it is overlapped with a signal configuring a header of another RF tag having the same configuration as that of itself upon decoding of the spread-code by the interrogator.

13. A RF tag set, comprising an aggregation of a plurality of the RF tag according to any one of claims 1 to 4.

14. An RF tag set, comprising an aggregation of a plurality of the RF tags according to claim 11.

15. The RF tag set according to claim 14, wherein
an identification code of said header is common among said aggregation of a plurality of RF tags.

16. The RF tag set according to claim 15, wherein
the spread-codes used in the different tags are different from each other, in which the spread-code is used in the spread-code modulator of respective RF tags in said aggregation of a plurality of RF tags.

17. The RF tag set according to claim 15, wherein
a plurality of spread-codes are used in the spread-code modulator of respective RF tags in said aggregation of a plurality of RF tags.

18. An interrogator, comprising:
an acquirer for interrogator signal, which acquires a interrogator signal;
a transmitter for interrogator signal, which transmits the interrogator signal acquired by the acquirer for interrogator signal;
an acquirer for synchronization signal, which acquires a synchronization signal correlated with said interrogator signal; and
a receiver for response signal, which receives a response signal from RF tag to the interrogator signal transmitted from said transmitter for interrogator signal on the basis of the synchronization signal acquired by said acquirer for synchronization signal.

19. The interrogator according to claim 18, comprising:
a measurer for response signal intensity, which measures intensity of the response signal received by said receiver for response signal;
a selector, which selects the response signal having a predetermined response signal intensity measured by said measurer for response signal intensity; and
a first decoder, which decodes the response signal selected by said selector.

20. The interrogator according to claim 19, wherein
the first decoder comprises,
an acquisition means for RFID information, which acquires RFID information for unique identification of the RF tag according to claim 9 by decoding spread-code modulated response information,
comprising:
a transmitter for stop instruction, which transmits a stop instruction for stopping transmission of a signal to the RF tag according to claim 9, which is identified by the RFID information acquired by said acquisition means for RFID information.

21. The interrogator according to claim 18, comprising:
a measurer for response signal intensity, which measures intensity of the response signal received by said receiver for response signal; and
a second decoder, which decodes a response signal, of which intensity fulfils a predetermined condition, if the response signal intensity measured by said measurer for response signal intensity fulfils a predetermined condition.

22. The interrogator according to claim 21, wherein
said second decoder comprises,
an acquisition means for RFID information, which acquires the RFID information, which is information for unique identification of the RF tag according to claim 9, by decoding the spread-code modulated response information,
comprising:
a transmitter for stop instruction, which transmits a stop instruction for stopping transmission of a signal to the RF tag according to claim 9, which is identified by the RFID information acquired by said acquisition means for RFID information.

23. The interrogator according to claim 19 or 21, wherein
said response signal comprises,
a header including an identification code for measuring the response signal intensity, and
said measurer for response signal intensity comprises,
a correlator, which measures said response signal intensity based on a correlation between an identification code included in said header and a predetermined reference code.

24. The interrogator according to claim 19, wherein
said measurer for response signal intensity comprises,
a storage means for measurement time constant, which stores said measurement time constant for setting a measurement time for measuring said response signal intensity.

25. The interrogator according to claim 24, wherein
the measurement time constant stored by said storage means for measurement time constant is a maximum value of response signal length.

26. The interrogator according to claim 24 or 25, wherein
said measurer for response signal intensity comprises,
a changing means for measurement time constant, which changes said measurement time constant.

27. The interrogator according to claim 24, wherein
the measurement time constant stored by said storage means for measurement time constant is a maximum value of header length.

28. An RF tag set, comprising an aggregation of a plurality of the RF tags according to claim 12.
